(19) United States
(12) Patent Application Publication
(10) Pub. No.: US 2026/0367762 A1
(43) Pub. Date: Nov. 19, 2026

(54) DEVICES, METHODS, AND GRAPHICAL USER INTERFACES FOR AUTOMATICALLY GROUPING TABS IN A BROWSER APPLICATION

(71) Applicant: Apple Inc., Cupertino, CA (US)

(72) Inventor: Jonathan R. DASCOLA, San Francisco, CA (US)

(21) Appl. No.: 19/679,354

(22) Filed: May 15, 2026

Related U.S. Application Data
(60) Provisional application No. 63/807,370, filed on May 16, 2025.
(60) Provisional application No. 64/064,991, filed on May 13, 2026.

(51) Int. Cl. G06F 3/0483; G06F 3/0482; G06F 3/0484

(52) U.S. Cl. CPC G06F 3/0483; G06F 3/0482; G06F 3/0484

(57) ABSTRACT

A method is performed at a computer system that is in communication with a display generation component and one or more input devices. A browser application user interface that includes a tab bar with a plurality of tabs is displayed. The plurality of tabs are displayed in a first arrangement. An occurrence of a tab-usage event associated with the plurality of tabs is detected. In response to detecting the occurrence of the tab-usage event associated with the plurality of tabs, and in accordance with a determination that grouping criteria are met, the computer system displays an indication of a system-generated grouping, in one or more system-generated tab groups, of a subset of the plurality of tabs. Some techniques are for organizing tabs in accordance with some embodiments.

### CROSS-REFERENCE TO RELATED APPLICATIONS

The present application claims priority to U.S. Provisional Patent Application Serial No. 63/807,370, entitled “Devices, Methods, and Graphical User Interfaces for Automatically Grouping Tabs in a Browser Application” filed May 16, 2025, and U.S. Provisional Patent Application Serial No. 64/064,991, entitled “Devices, Methods, and Graphical User Interfaces for Automatically Grouping Tabs in a Browser Application” filed May 13, 2026, which are hereby incorporated by reference in their entirety for all purposes.

### TECHNICAL FIELD

This relates generally to interacting with a browser application on an electronic device that is in communication with a touch-sensitive surface.

### BACKGROUND

Tabbed browsing allows users to open and navigate multiple web pages at the same time. Some users, however, overfill a browser’s tab bar with many open tabs. A tab bar that is cluttered with many open tabs becomes inefficient to navigate. For example, it can be difficult to recall the location, content, and/or order of open tabs, thereby increasing the number of inputs and the amount of time that is necessary to switch between tabs and/or navigate to a particular tab. In addition, it can be even more difficult to open and interact with multiple open tabs when browsing on electronic devices with small touch-sensitive surfaces.

### SUMMARY

Accordingly, there is a need for electronic devices with faster, more efficient methods and interfaces for organizing tabs in a web browser. Such methods and interfaces optionally complement or replace conventional methods for tab organization. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In some embodiments, a method is performed at a computer system that is in communication with a display generation component and one or more input devices. The method includes, displaying, via the display generation component, a browser application user interface that includes a tab bar with a plurality of tabs. The plurality of tabs are displayed in a first arrangement. The method includes detecting an occurrence of a tab-usage event associated with the plurality of tabs. In response to detecting the occurrence of the tab-usage event associated with the plurality of tabs, and in accordance with a determination that grouping criteria are met, automatically displaying, via the display generation component, an indication of a system-generated grouping, in one or more system-generated tab groups, of a subset of the plurality of tabs.

In some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

In some embodiments, a method that is performed at a computer system that is in communication with one or more display generation components and one or more input devices is described. In some embodiments, the method comprises: while displaying, via the one or more display generation components, a browser application user interface that includes a tab bar with a plurality of tabs, detecting, via the one or more input devices, a set of one or more inputs including an input corresponding to a tab of the plurality of tabs and an input corresponding to a request to organize tabs in a respective mode; and, in response to detecting the set of one or more inputs: in accordance with a determination that the respective mode is a first mode, displaying, via the one or more display generation components, an indication of a grouping of a first subset of the plurality of tabs, wherein the first subset of the plurality of tabs does not include the tab of the plurality of tabs; and, in accordance with a determination that the respective mode is a second mode, displaying, via the one or more display generation components, an indication of a grouping of a second subset of the plurality of tabs without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs.

In some embodiments, a non-transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a browser application user interface that includes a tab bar with a plurality of tabs, detecting, via the one or more input devices, a set of one or more inputs including an input corresponding to a tab of the plurality of tabs and an input corresponding to a request to organize tabs in a respective mode; and, in response to detecting the set of one or more inputs: in accordance with a determination that the respective mode is a first mode, displaying, via the one or more display generation components, an indication of a grouping of a first subset of the plurality of tabs, wherein the first subset of the plurality of tabs does not include the tab of the plurality of tabs; and, in accordance with a determination that the respective mode is a second mode, displaying, via the one or more display generation components, an indication of a grouping of a second subset of the plurality of tabs without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs.

In some embodiments, a transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a browser application user interface that includes a tab bar with a plurality of tabs, detecting, via the one or more input devices, a set of one or more inputs including an input corresponding to a tab of the plurality of tabs and an input corresponding to a request to organize tabs in a respective mode; and, in response to detecting the set of one or more inputs: in accordance with a determination that the respective mode is a first mode, displaying, via the one or more display generation components, an indication of a grouping of a first subset of the plurality of tabs, wherein the first subset of the plurality of tabs does not include the tab of the plurality of tabs; and, in accordance with a determination that the respective mode is a second mode, displaying, via the one or more display generation components, an indication of a grouping of a second subset of the plurality of tabs without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs.

In some embodiments, a computer system that is configured to communicate with one or more display generation components and one or more input devices is described. In some embodiments, the computer system comprises one or more processors and memory storing one or more programs configured to be executed by the one or more processors. In some embodiments, the one or more programs includes instructions for: while displaying, via the one or more display generation components, a browser application user interface that includes a tab bar with a plurality of tabs, detecting, via the one or more input devices, a set of one or more inputs including an input corresponding to a tab of the plurality of tabs and an input corresponding to a request to organize tabs in a respective mode; and, in response to detecting the set of one or more inputs: in accordance with a determination that the respective mode is a first mode, displaying, via the one or more display generation components, an indication of a grouping of a first subset of the plurality of tabs, wherein the first subset of the plurality of tabs does not include the tab of the plurality of tabs; and, in accordance with a determination that the respective mode is a second mode, displaying, via the one or more display generation components, an indication of a grouping of a second subset of the plurality of tabs without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs.

In some embodiments, a computer system that is configured to communicate with one or more display generation components and one or more input devices is described. In some embodiments, the computer system comprises one or more processors. In some embodiments, the one or more processors are configured for: while displaying, via the one or more display generation components, a browser application user interface that includes a tab bar with a plurality of tabs, detecting, via the one or more input devices, a set of one or more inputs including an input corresponding to a tab of the plurality of tabs and an input corresponding to a request to organize tabs in a respective mode; and, in response to detecting the set of one or more inputs: in accordance with a determination that the respective mode is a first mode, displaying, via the one or more display generation components, an indication of a grouping of a first subset of the plurality of tabs, wherein the first subset of the plurality of tabs does not include the tab of the plurality of tabs; and, in accordance with a determination that the respective mode is a second mode, displaying, via the one or more display generation components, an indication of a grouping of a second subset of the plurality of tabs without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs.

In some embodiments, a computer system that is configured to communicate with one or more display generation components and one or more input devices is described. In some embodiments, the computer system comprises means for performing each of the following steps: while displaying, via the one or more display generation components, a browser application user interface that includes a tab bar with a plurality of tabs, detecting, via the one or more input devices, a set of one or more inputs including an input corresponding to a tab of the plurality of tabs and an input corresponding to a request to organize tabs in a respective mode; and, in response to detecting the set of one or more inputs: in accordance with a determination that the respective mode is a first mode, displaying, via the one or more display generation components, an indication of a grouping of a first subset of the plurality of tabs, wherein the first subset of the plurality of tabs does not include the tab of the plurality of tabs; and, in accordance with a determination that the respective mode is a second mode, displaying, via the one or more display generation components, an indication of a grouping of a second subset of the plurality of tabs without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs.

In some embodiments, a computer program product is described. In some embodiments, the computer program product comprises one or more programs configured to be executed by one or more processors of a computer system that is in communication with one or more display generation components and one or more input devices. In some embodiments, the one or more programs include instructions for: while displaying, via the one or more display generation components, a browser application user interface that includes a tab bar with a plurality of tabs, detecting, via the one or more input devices, a set of one or more inputs including an input corresponding to a tab of the plurality of tabs and an input corresponding to a request to organize tabs in a respective mode; and, in response to detecting the set of one or more inputs: in accordance with a determination that the respective mode is a first mode, displaying, via the one or more display generation components, an indication of a grouping of a first subset of the plurality of tabs, wherein the first subset of the plurality of tabs does not include the tab of the plurality of tabs; and, in accordance with a determination that the respective mode is a second mode, displaying, via the one or more display generation components, an indication of a grouping of a second subset of the plurality of tabs without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for tabbed browsing, thereby increasing the effectiveness, efficiency, and user satisfaction with such devices. Such methods and interfaces may complement or replace conventional methods for tabbed browsing.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5AG illustrate example user interfaces for automatically grouping and rearranging tabs in a browser application, in accordance with some embodiments.

FIG. 6 is flow diagram of a process for automatically grouping and rearranging tabs in a browser application, in accordance with some embodiments.

FIGS. 7A-7Y illustrate exemplary user interfaces for organizing tabs in a web browser in accordance with some embodiments.

FIG. 8 is a flow diagram illustrating a process for organizing tabs in accordance with some embodiments.

### DESCRIPTION OF EMBODIMENTS

Some users overfill a browser’s tab bar with many open tabs. A tab bar that is cluttered with many open tabs becomes inefficient to navigate. Tab groups are useful for organizing open tabs. However, a user may need to create many tab groups while browsing. Some methods for organizing tabs in groups and rearranging the tabs in the tab bar require series of inputs that navigate various menus, thereby interrupting and hindering the browsing user experience. For example, a user may need to search through multiple menus and/or sub-menus to find a menu that has the menu option for creating a tab group and/or to manually select tabs that are form a group. Searching for the correct menu options and/or controls can be inefficient and time consuming. Additionally, the menus and/or controls clutter the browser application’s user interface. The methods and systems described herein automatically (e.g., without explicit user input or command) generating a system-generating grouping of tabs in a tab bar and/or automatically rearranging the tabs in the tab bar according to the system-generated grouping in response to detecting an occurrence of a tab-usage event (e.g., opening a new tab, loading a new page in an existing tab, and/or editing the tabs in the tab bar). Automatically (e.g., without explicit user input or command) generating a system-generating grouping of tabs in a tab bar and/or automatically rearranging the tabs in the tab bar according to the system-generated grouping in response to detecting an occurrence of a tab-usage event reduces the number of inputs and the amount of time necessary to organize tabs in the browser application, thereby providing making the user-device interaction more efficient without cluttering the user interface of the browser application with additional controls.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

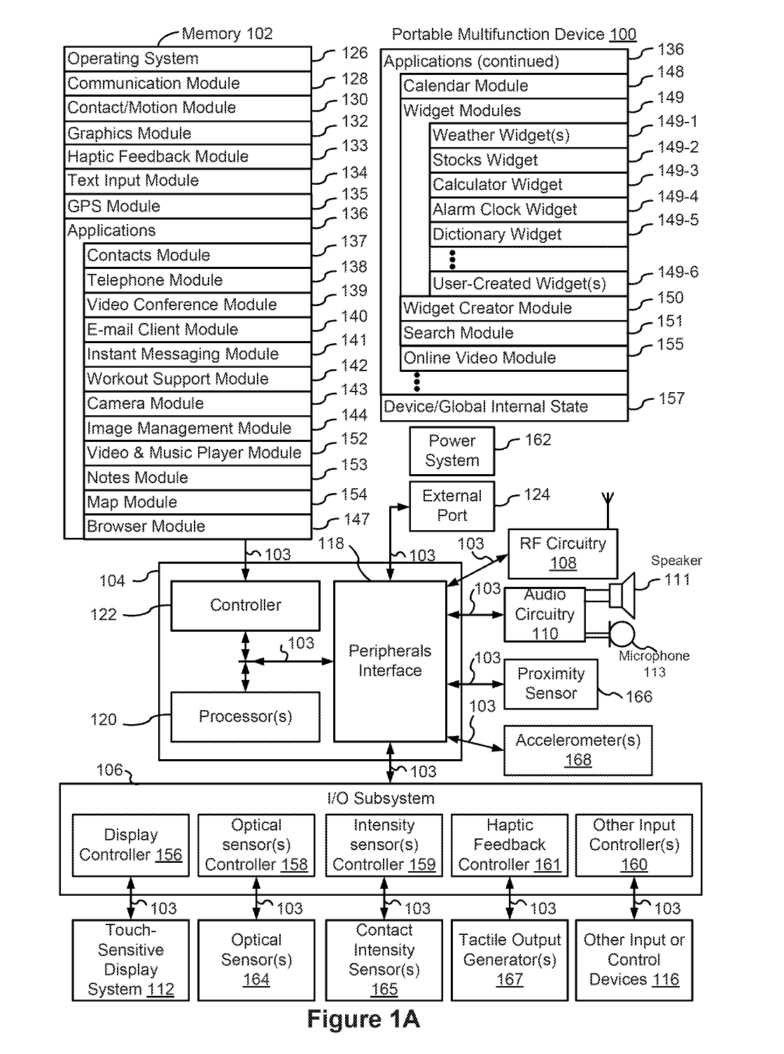

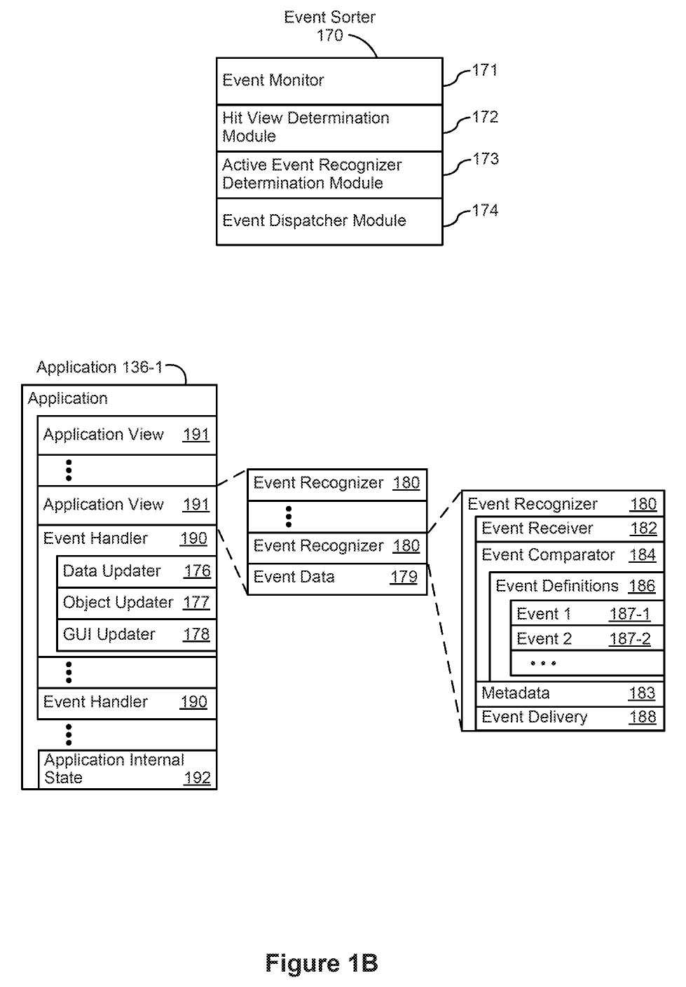

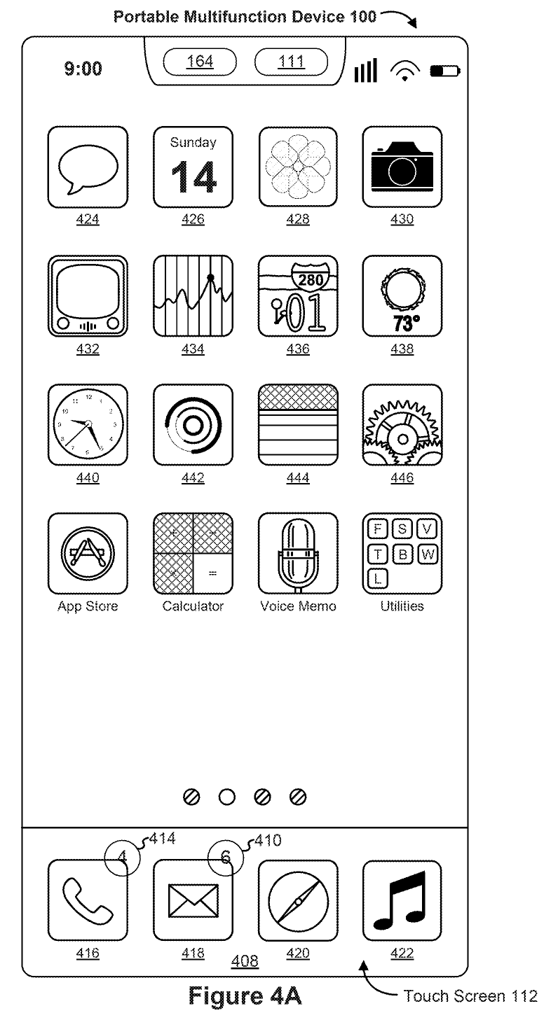

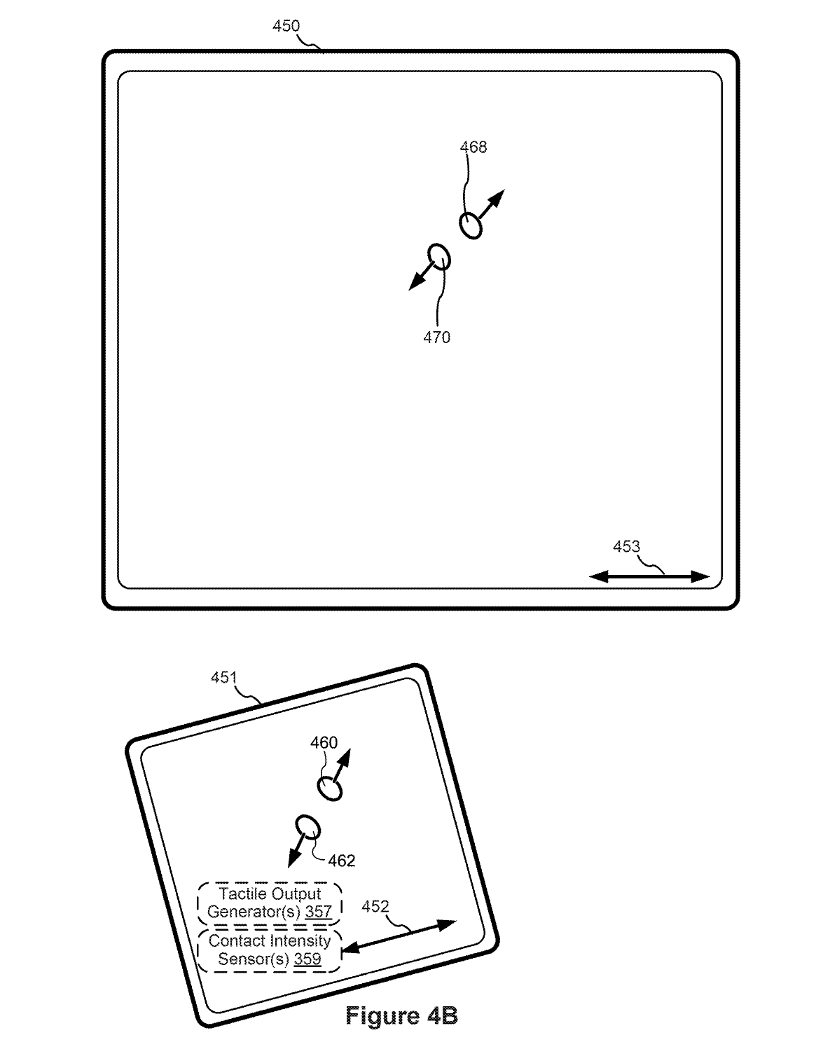

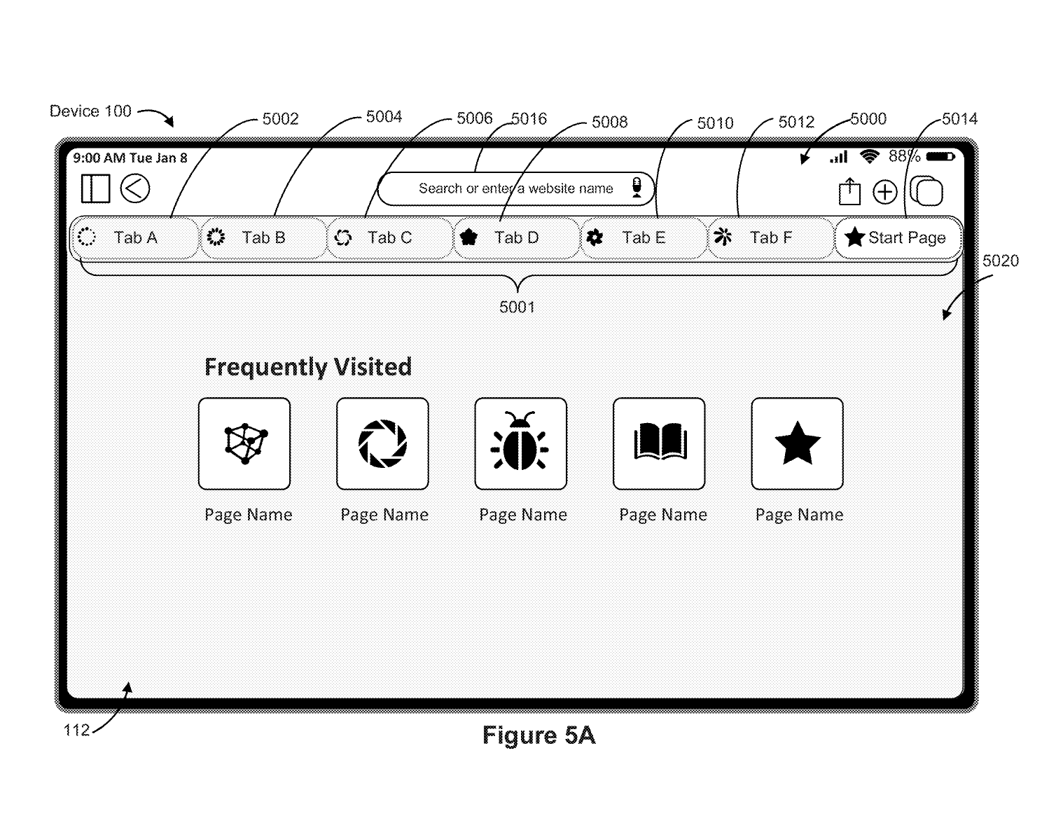

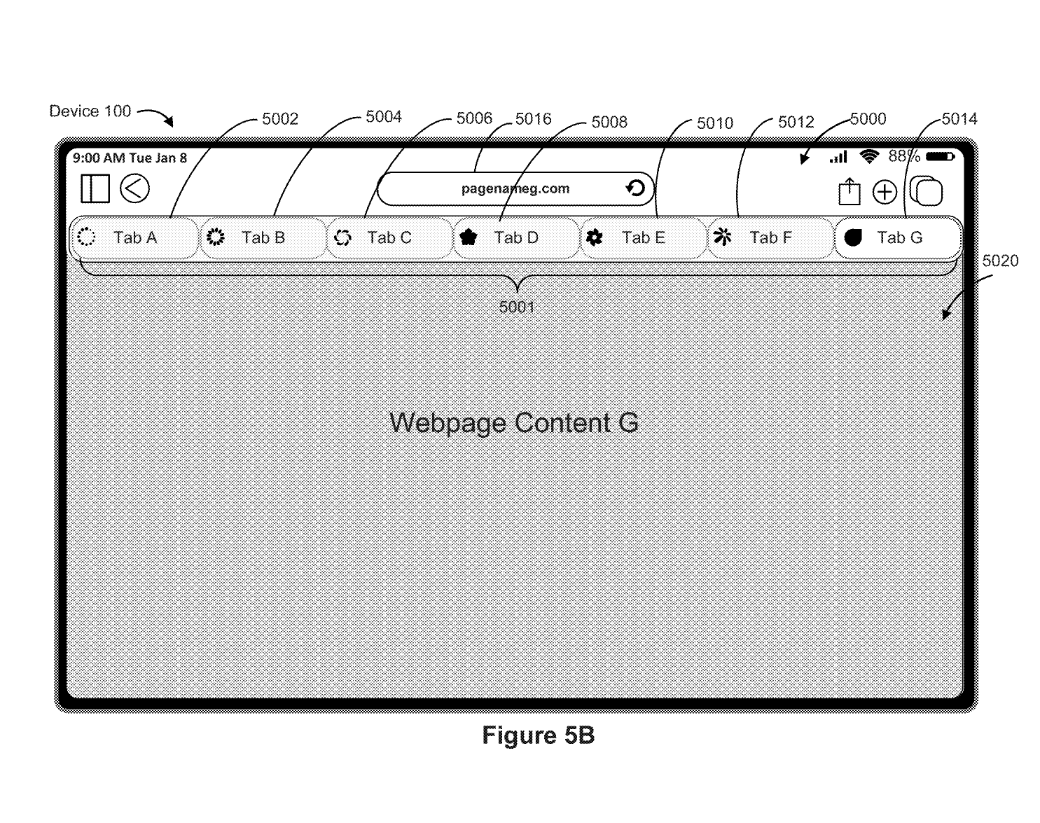

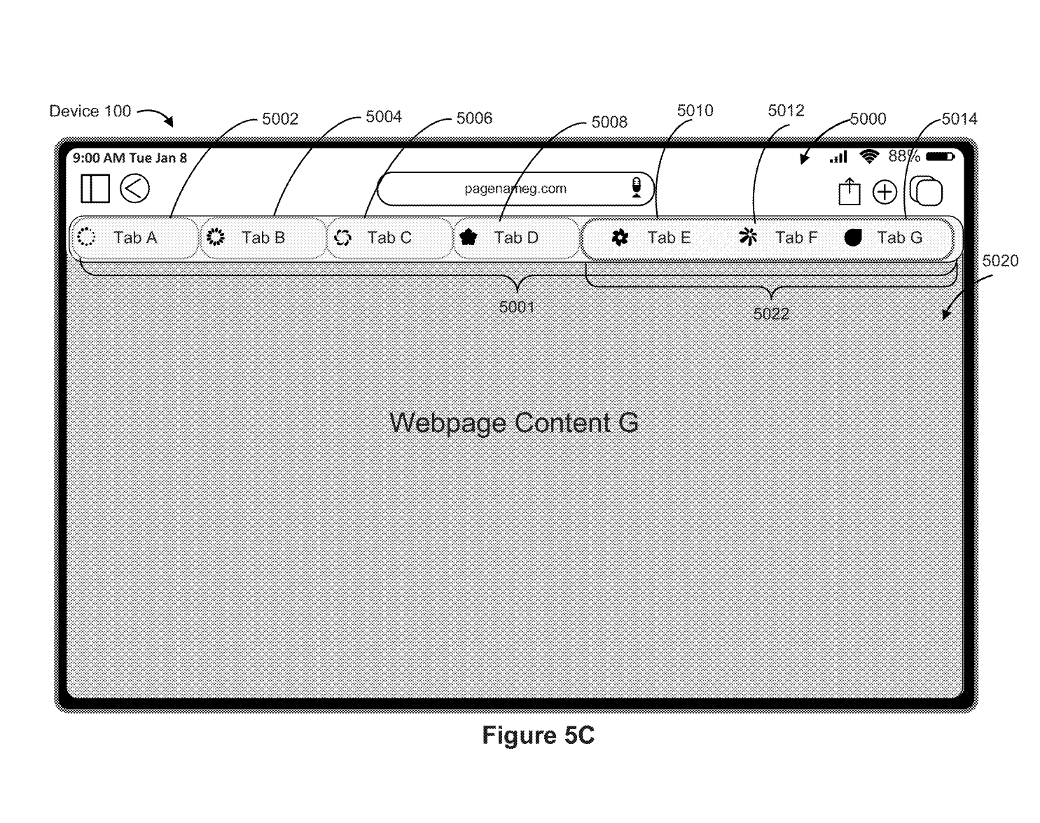

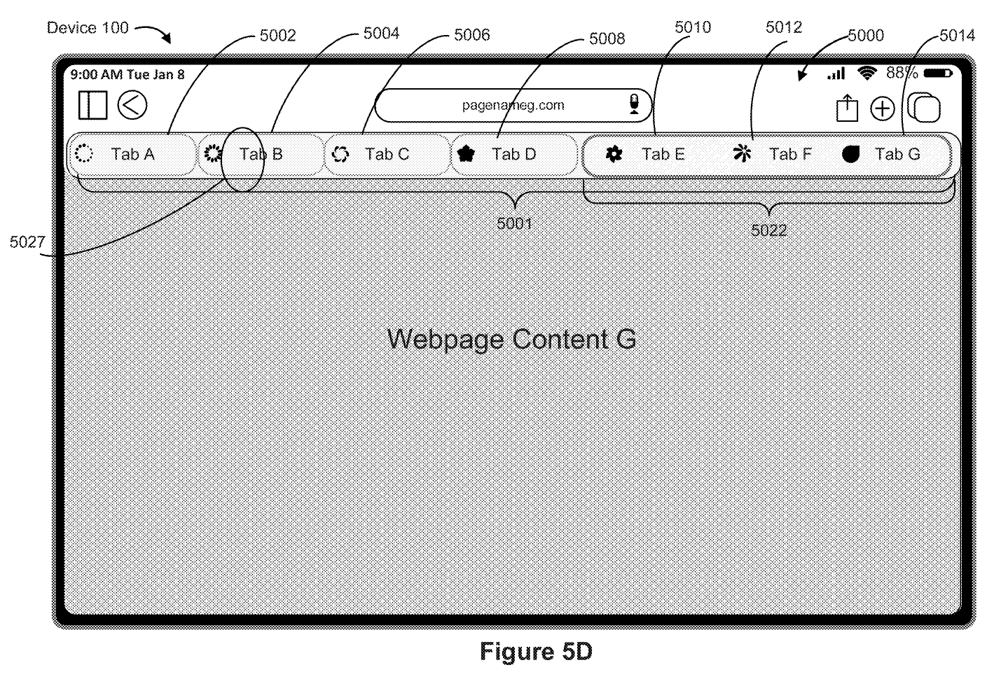

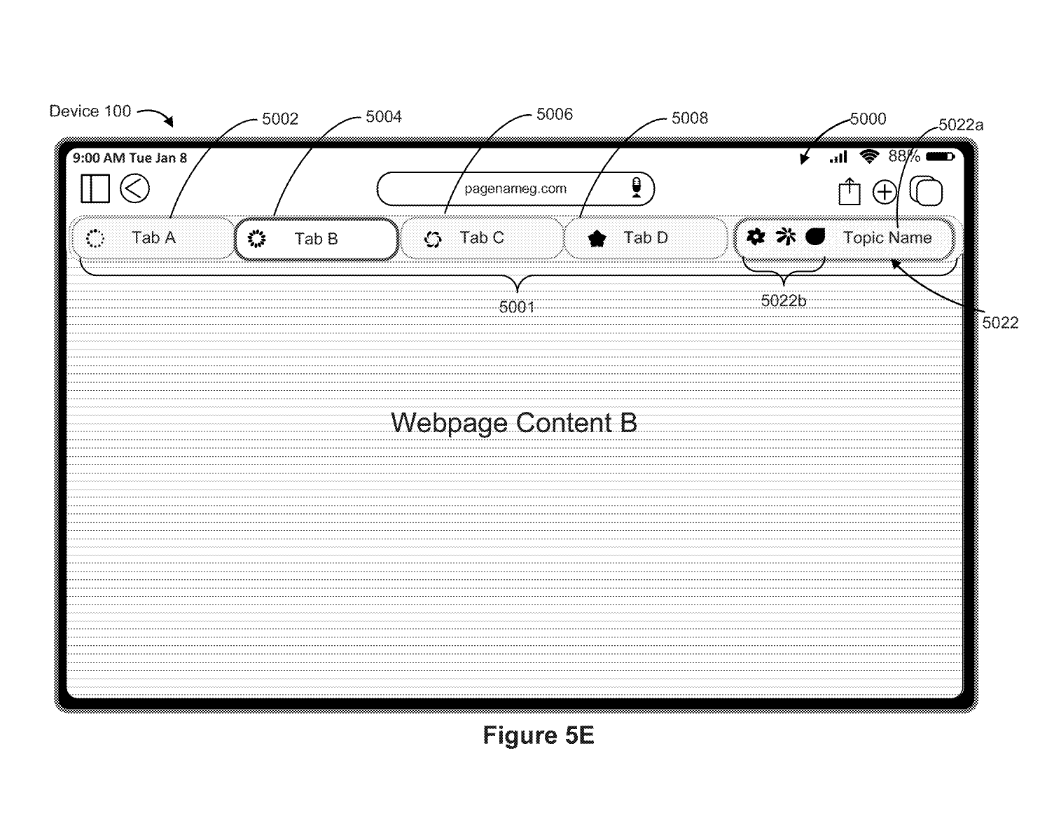

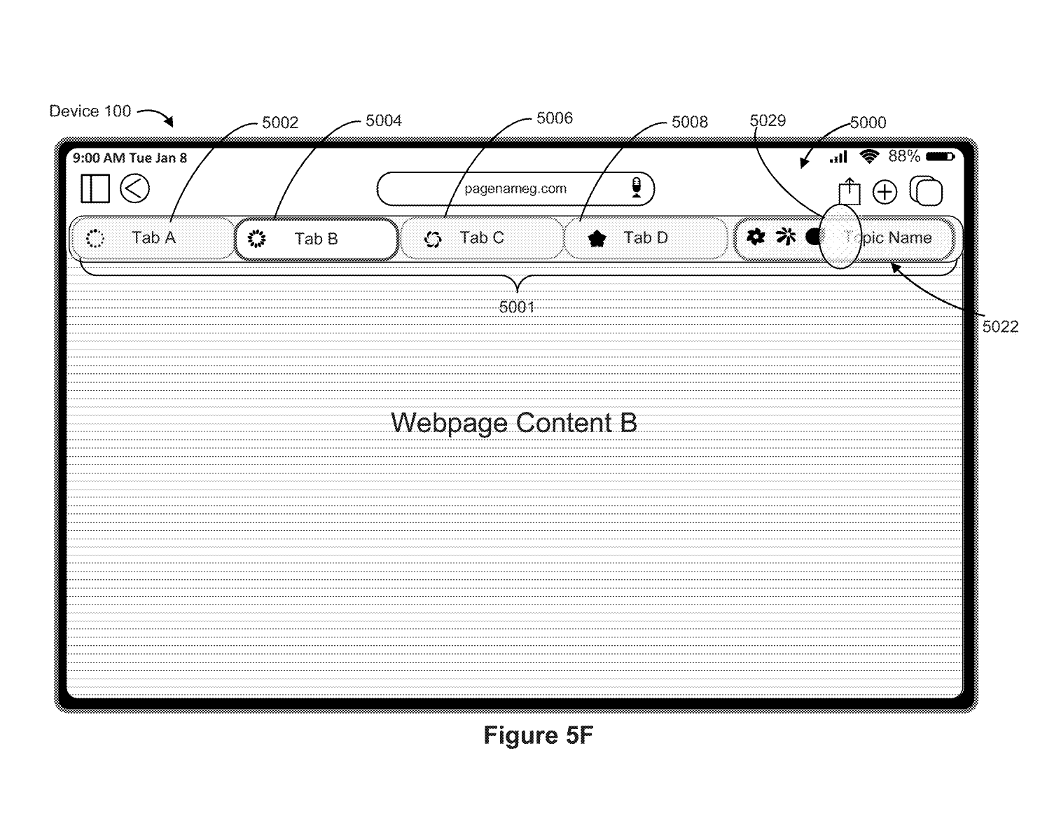

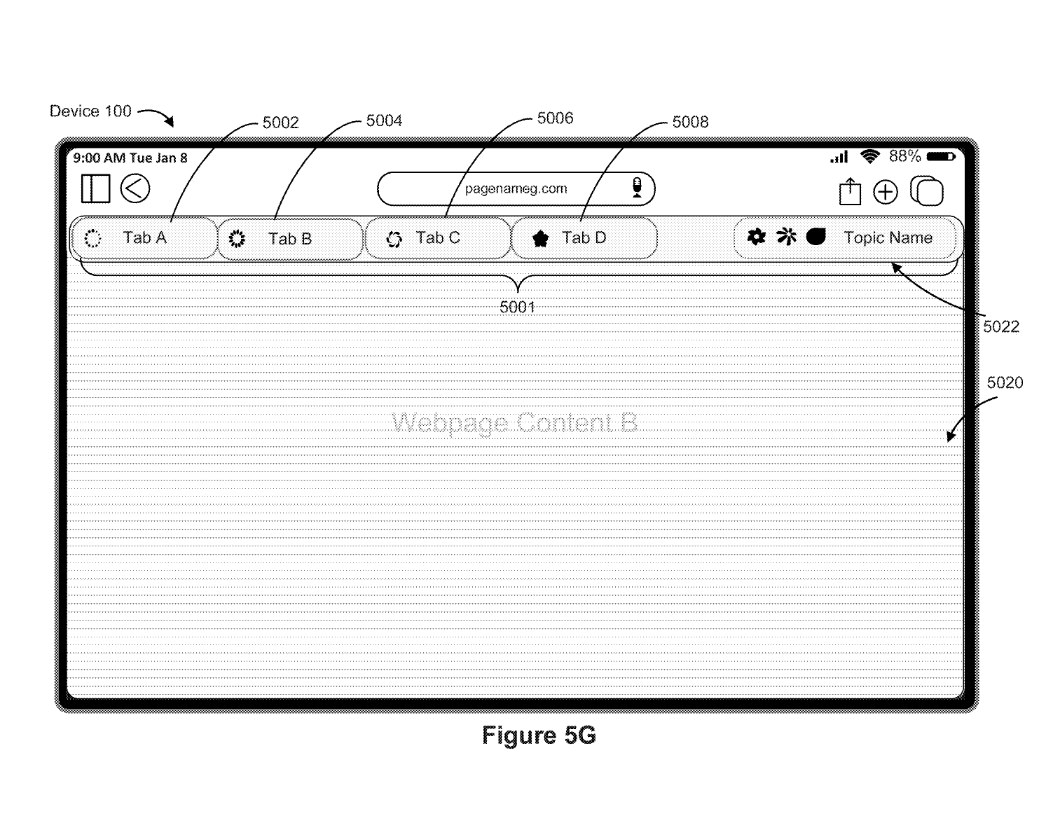

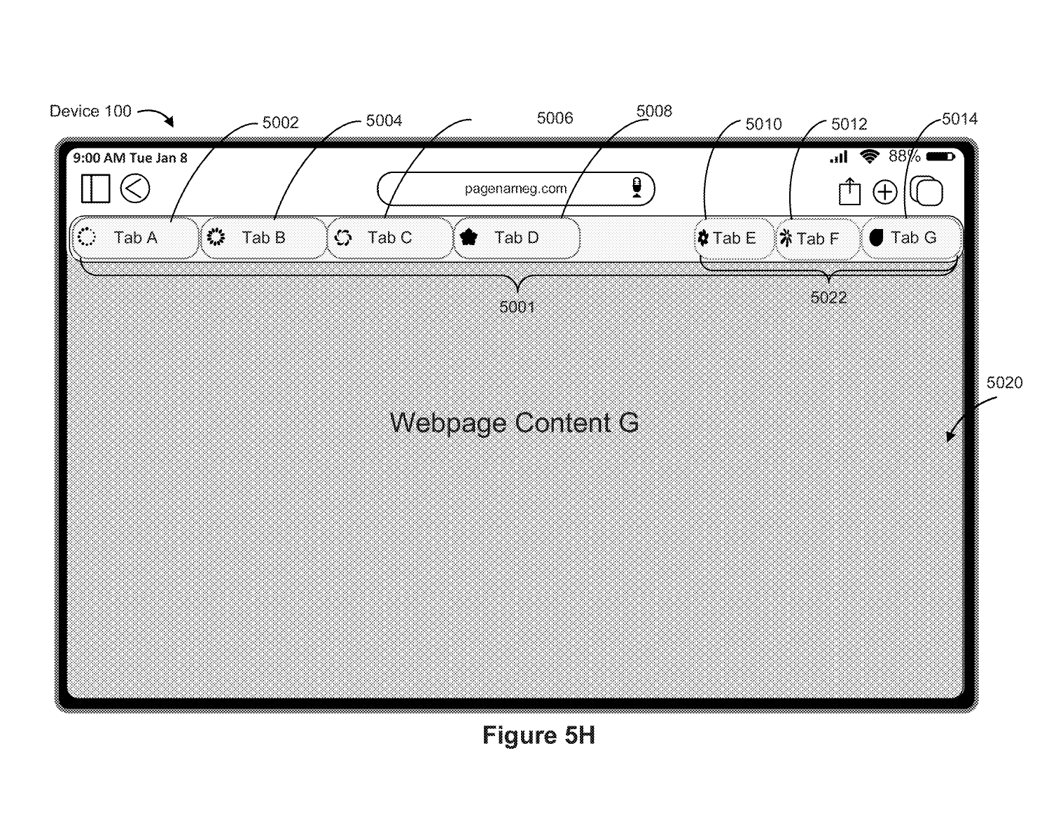

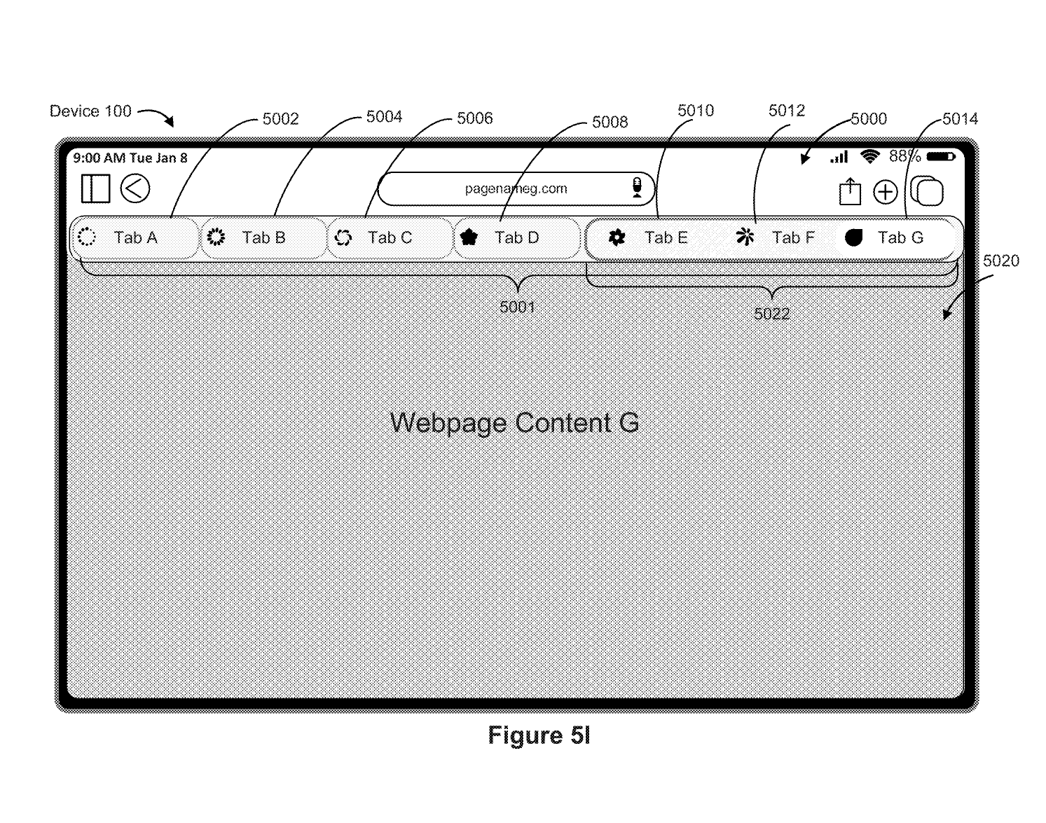

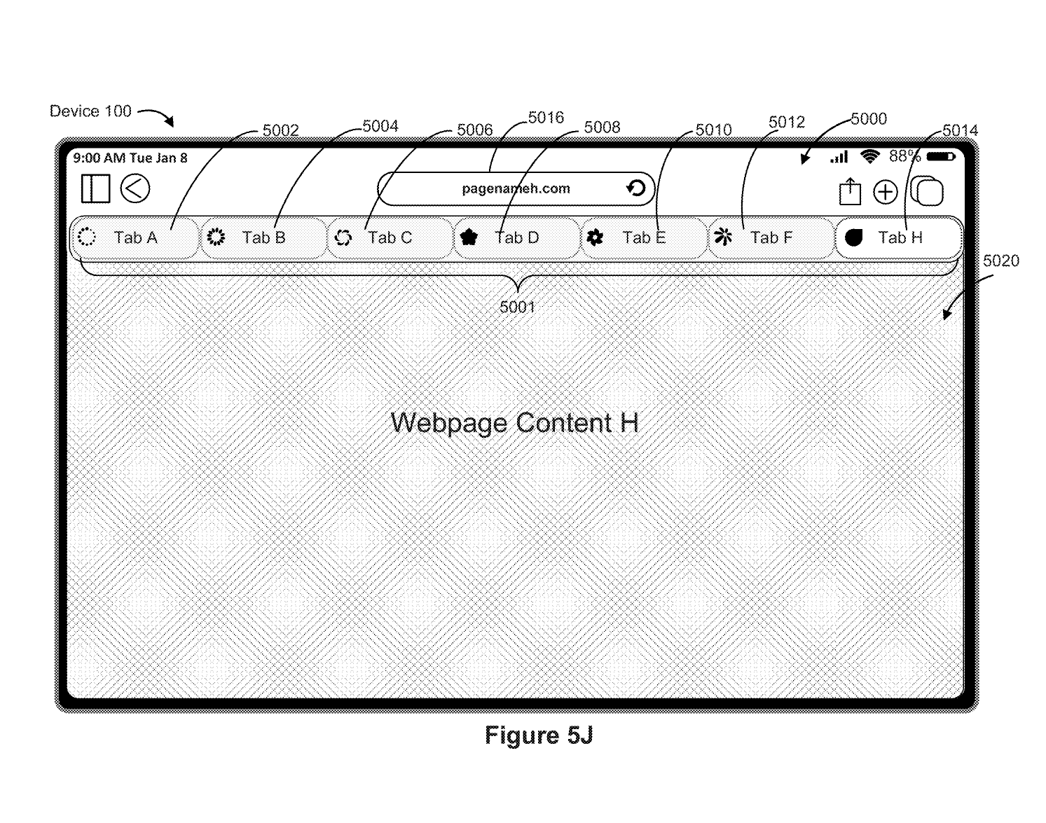

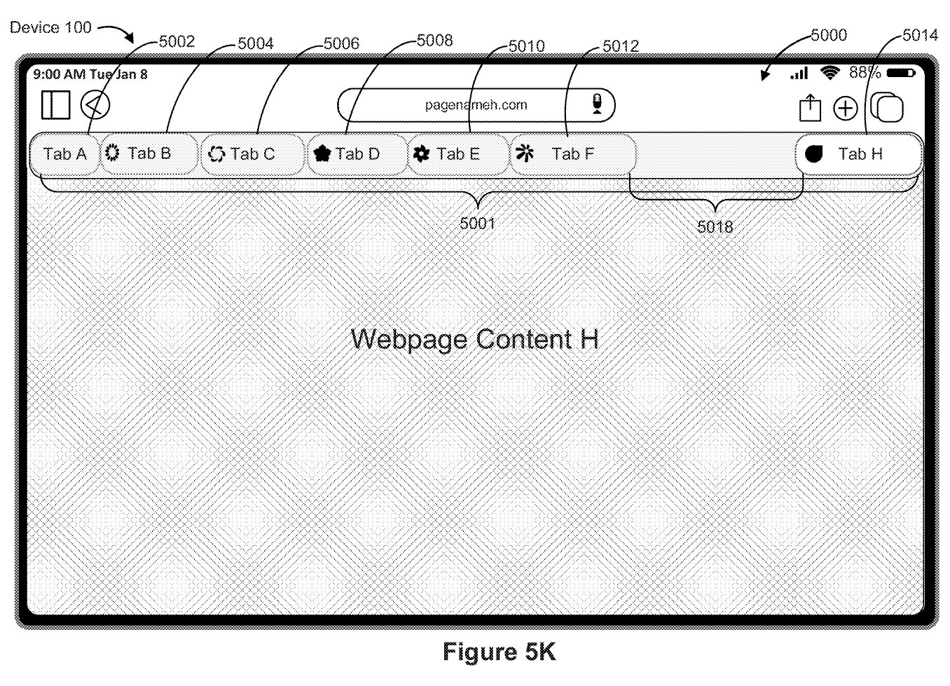

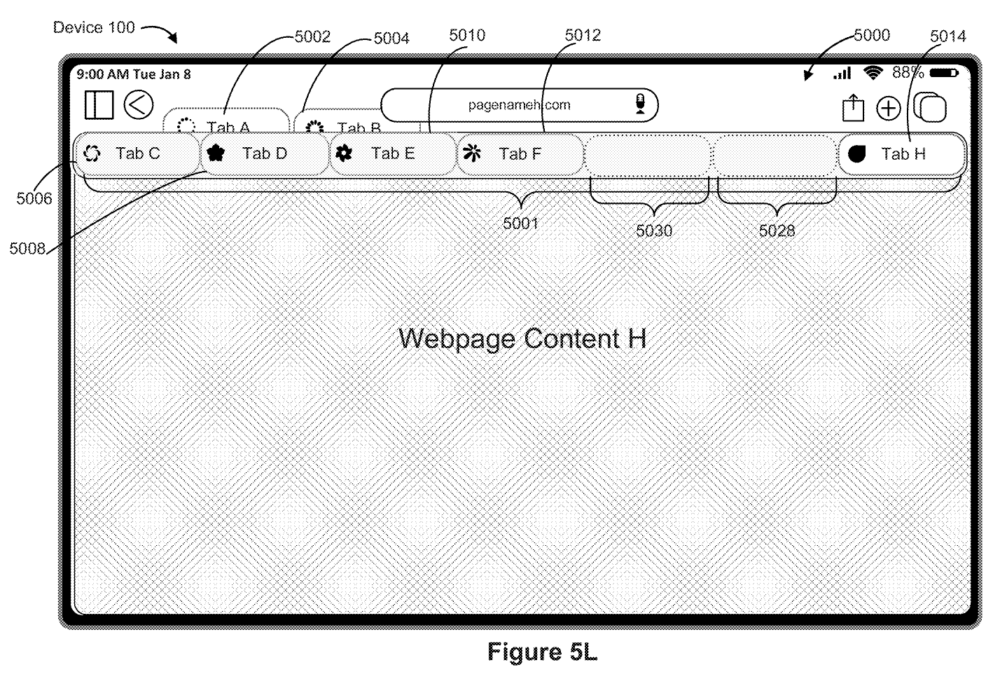

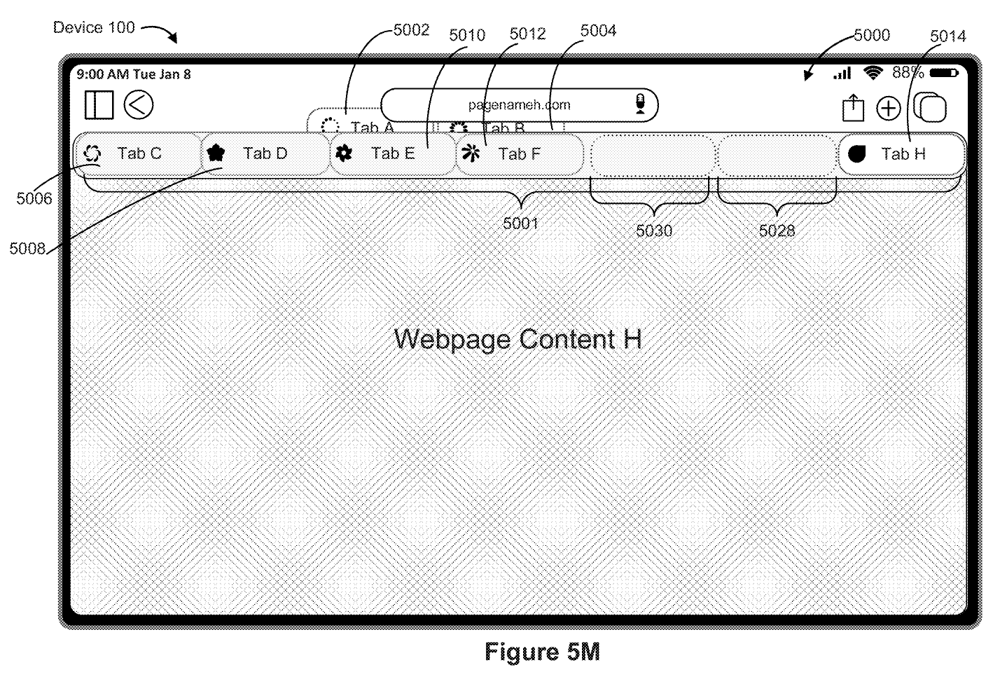

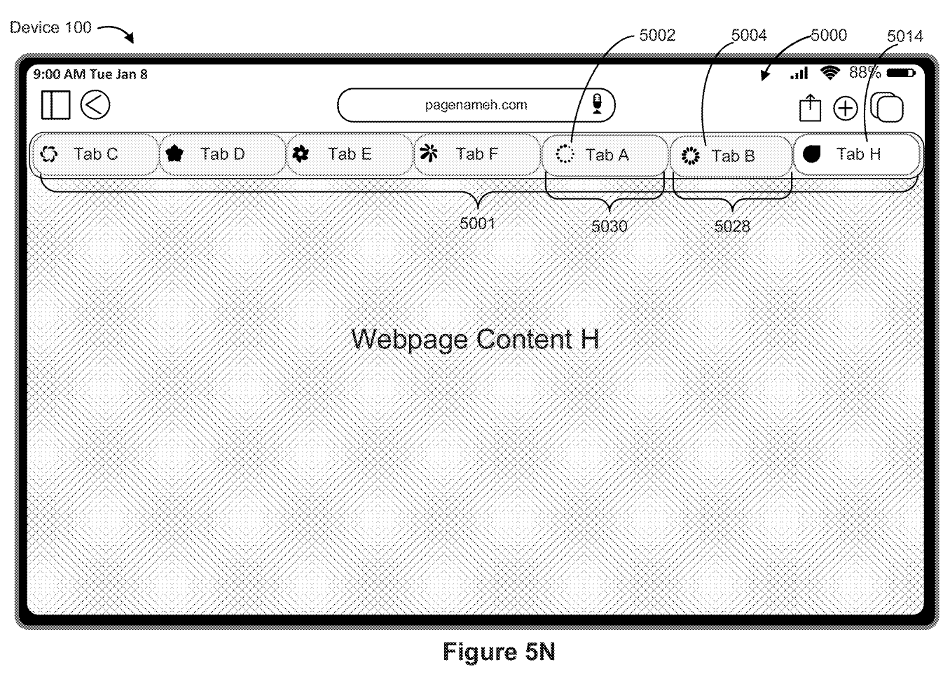

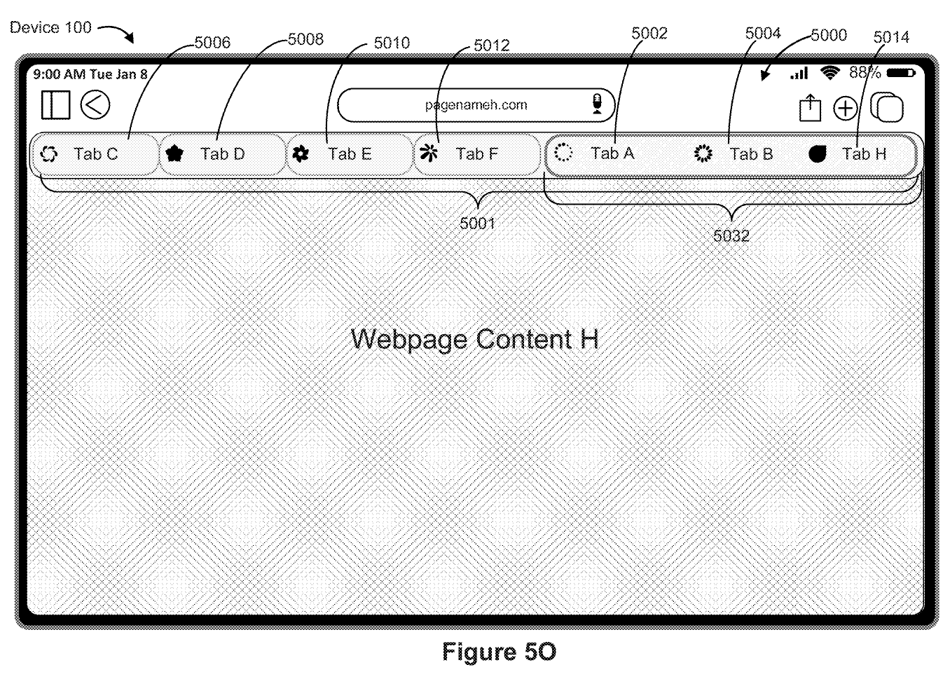

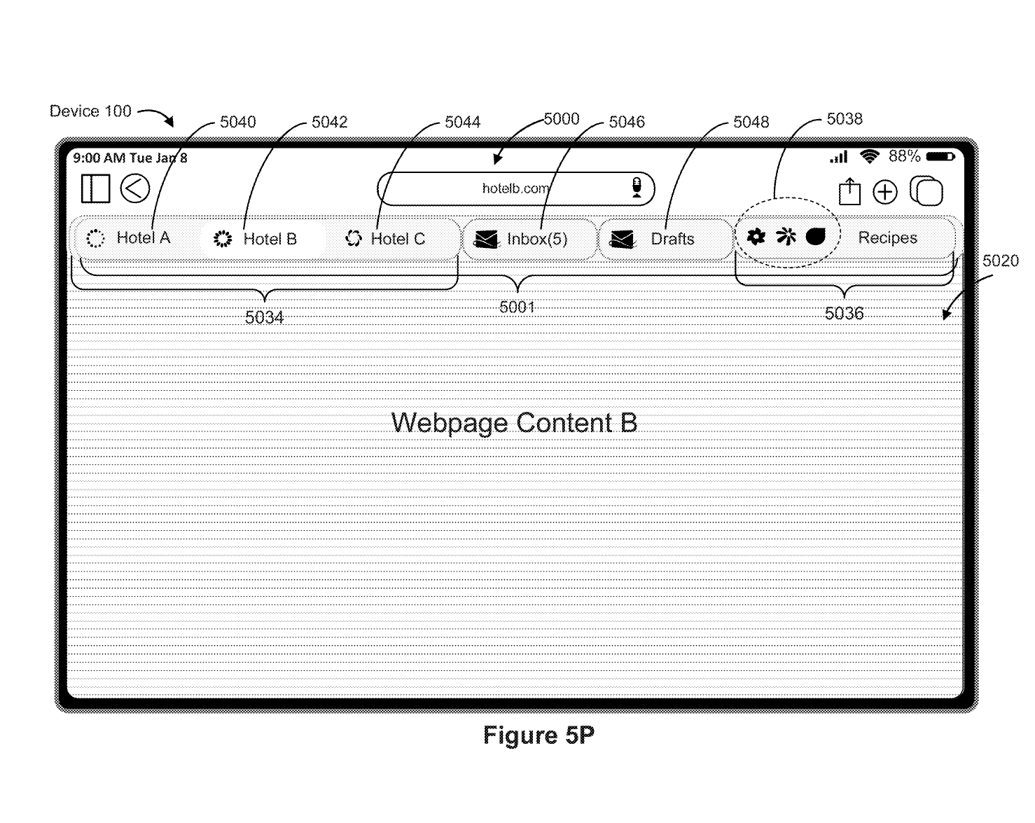

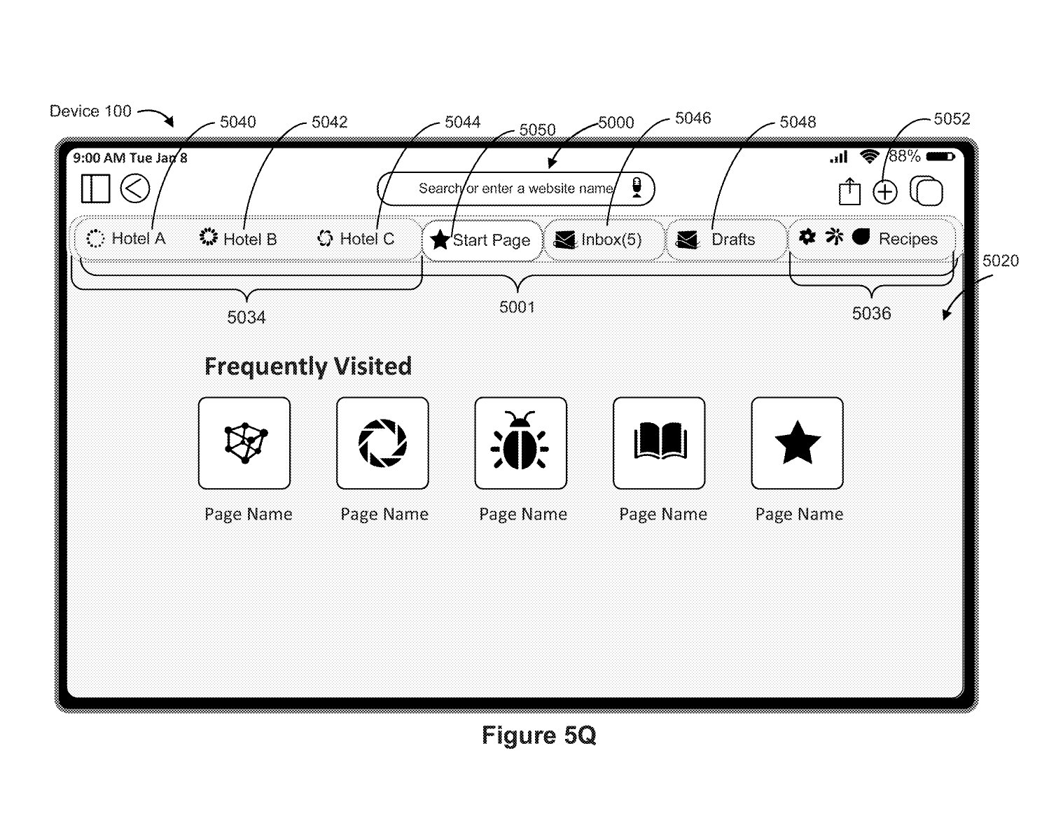

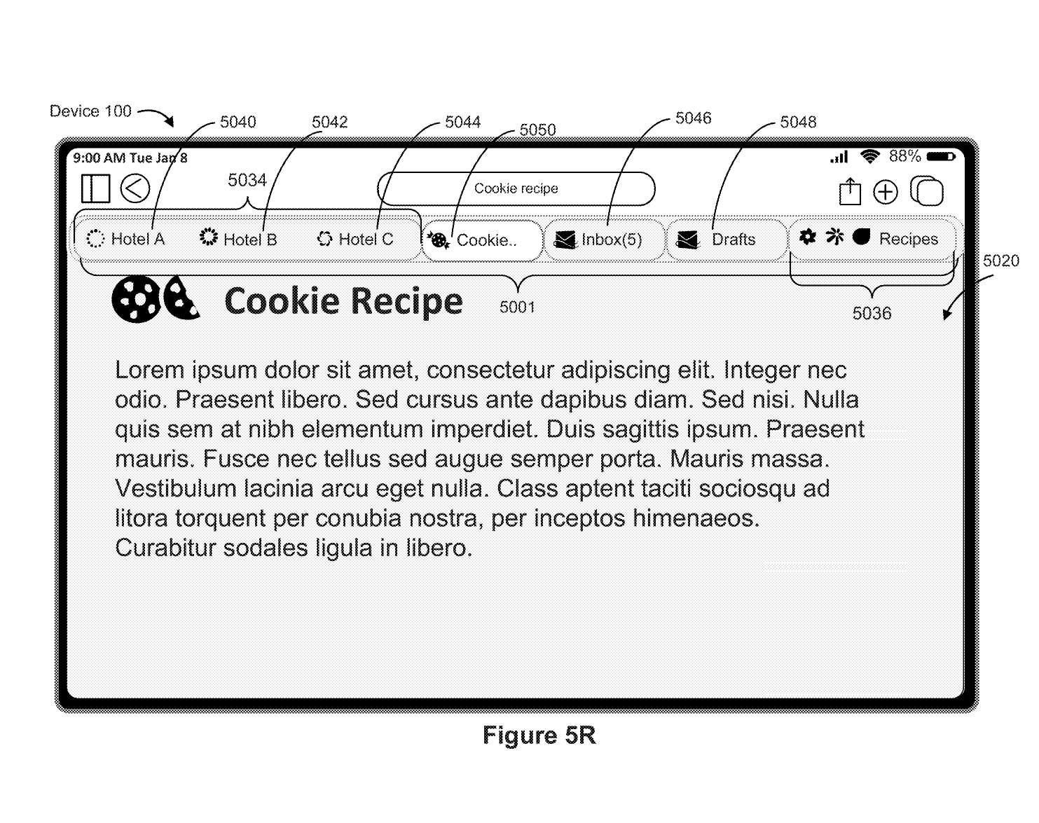

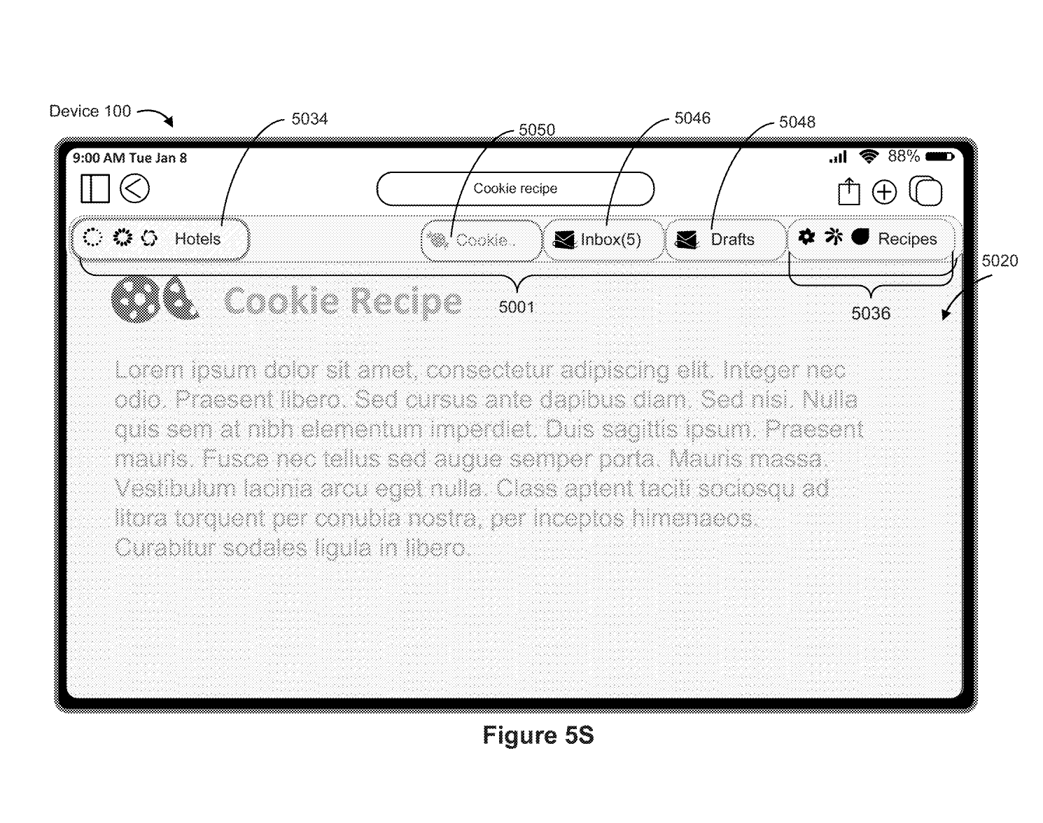

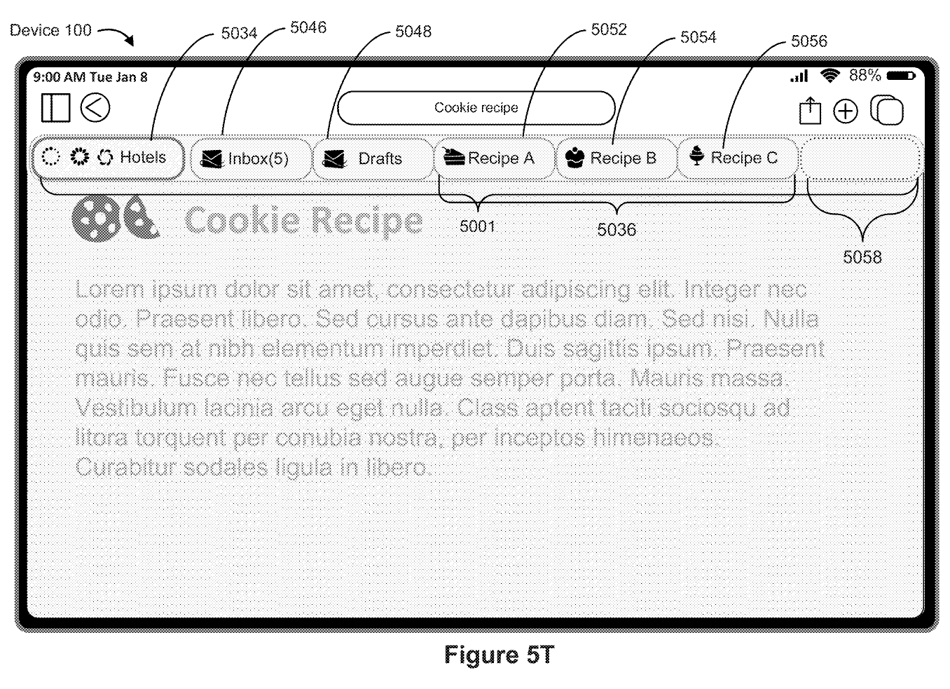

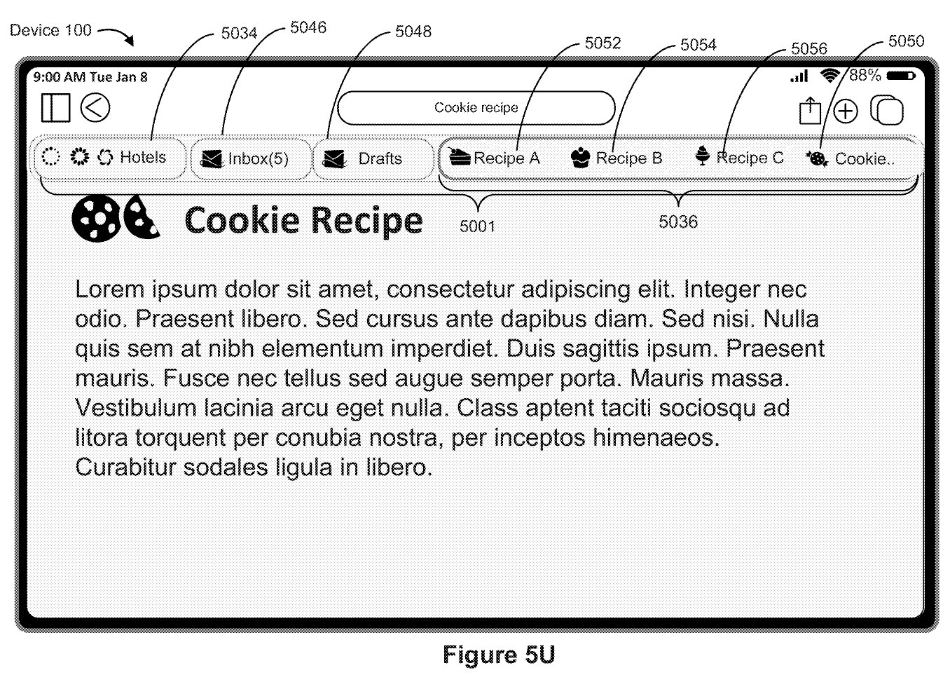

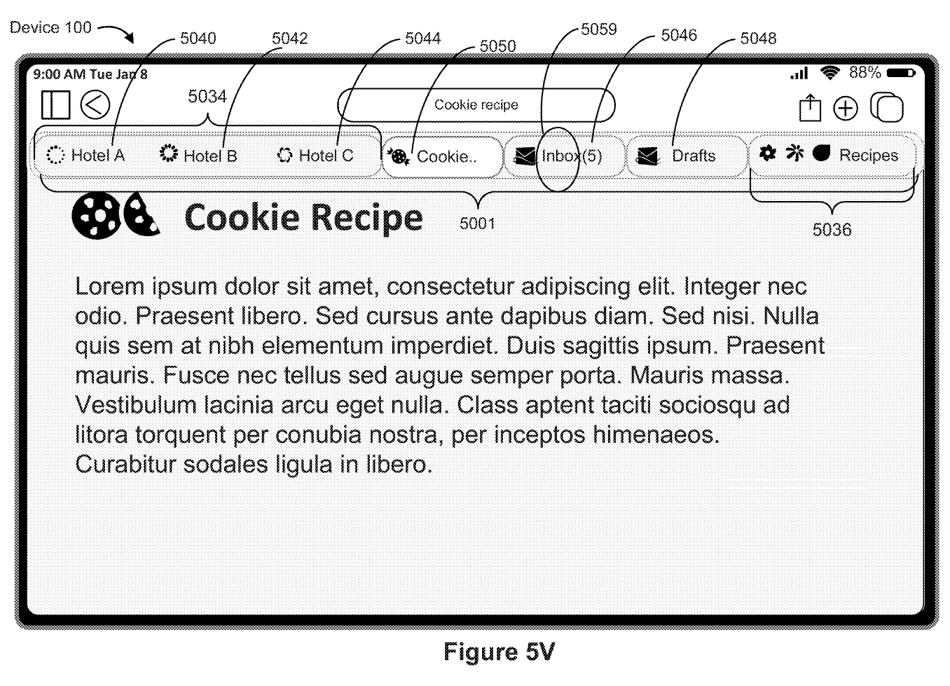

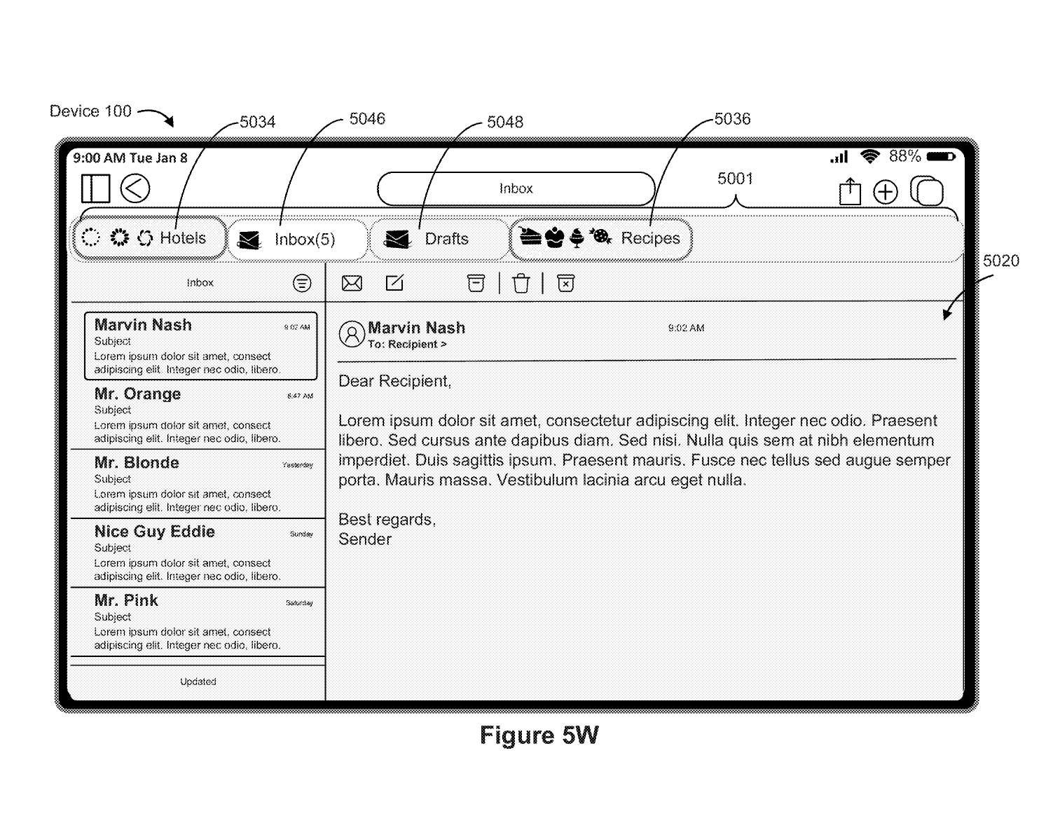

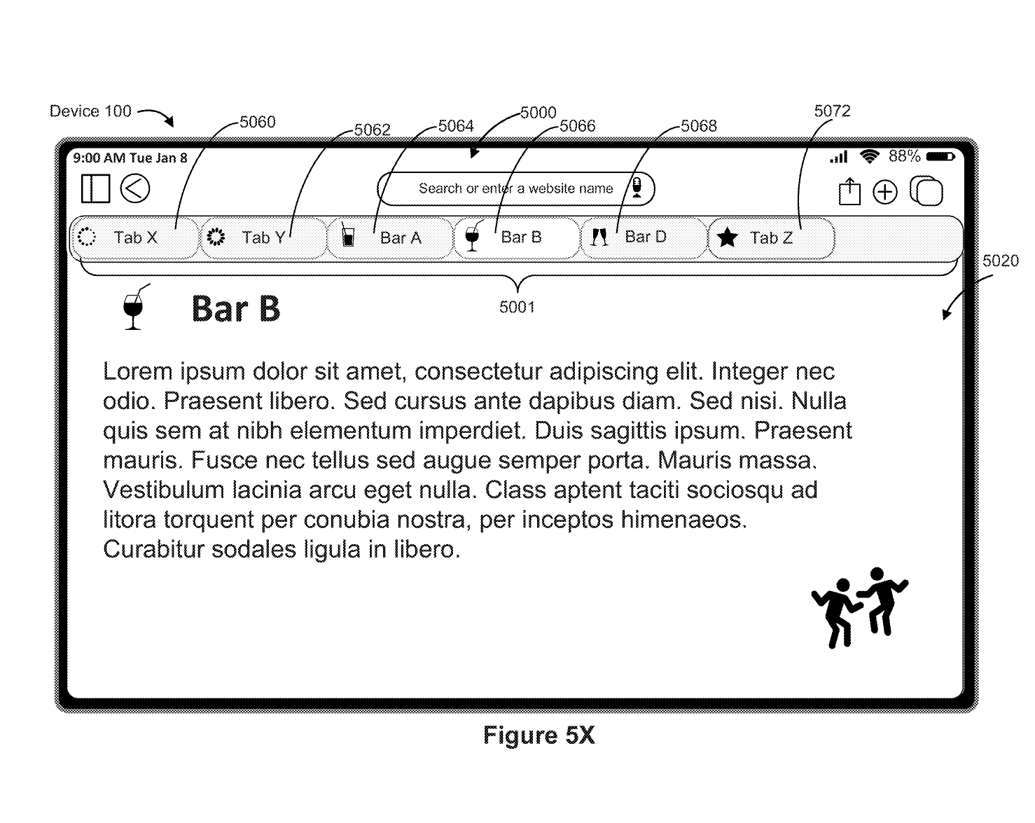

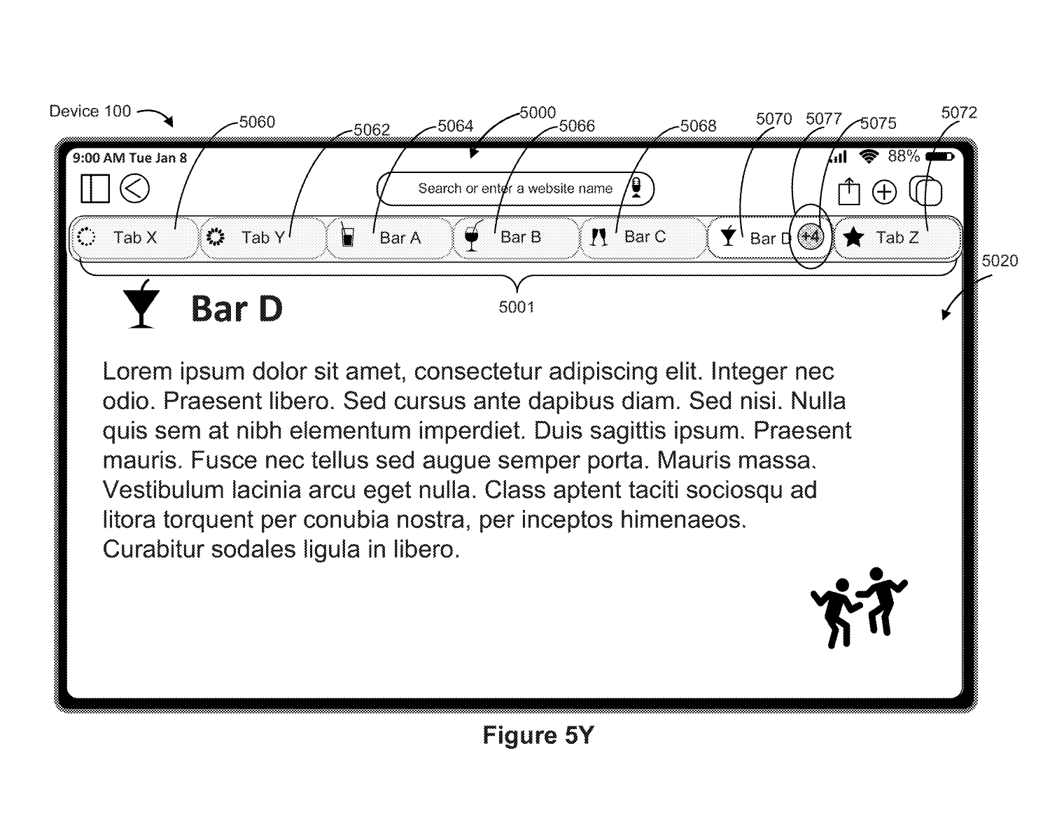

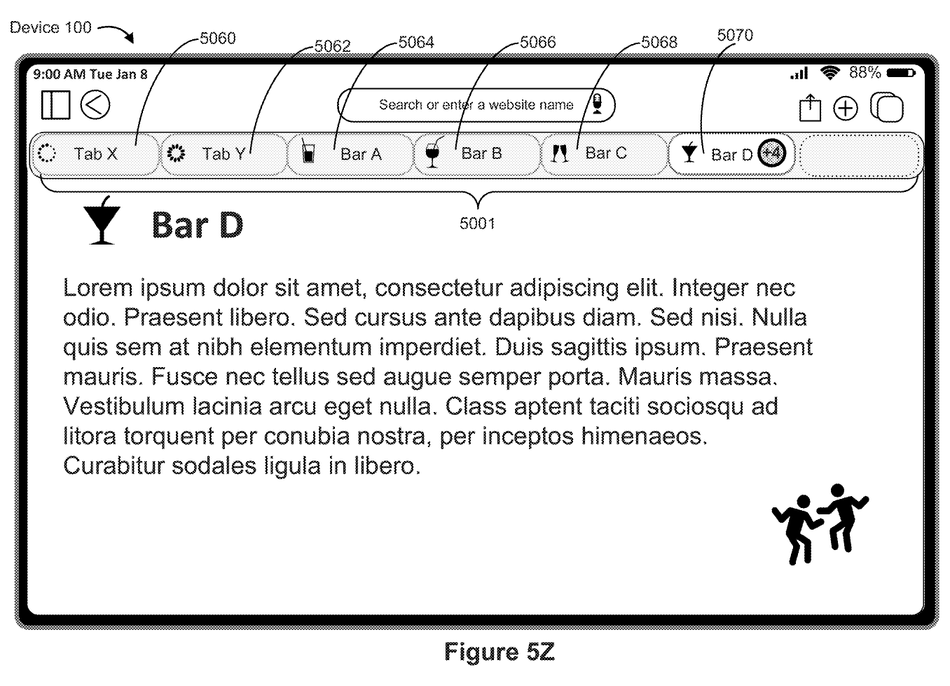

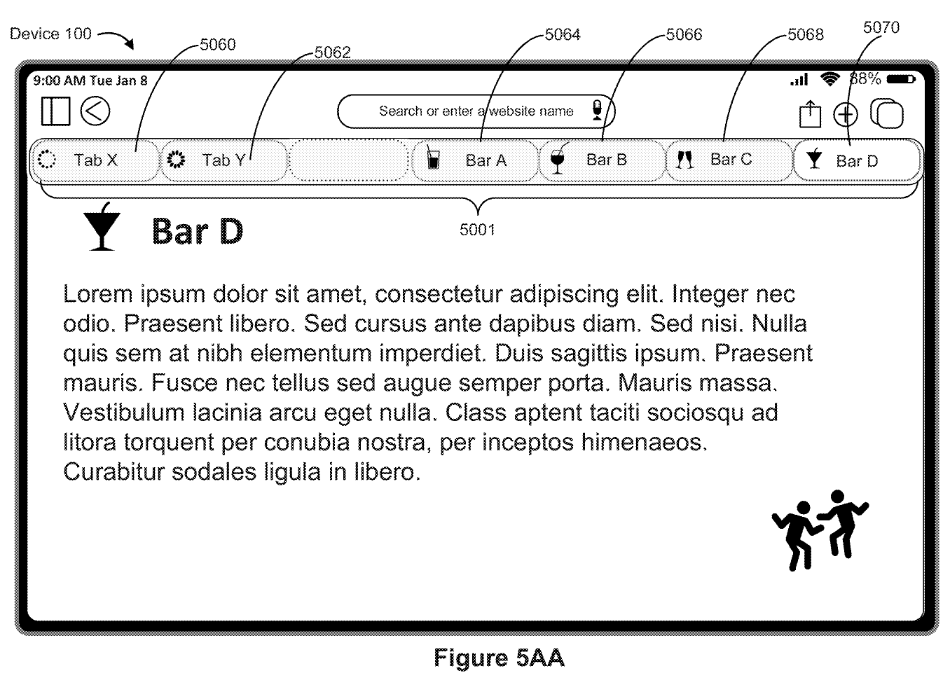

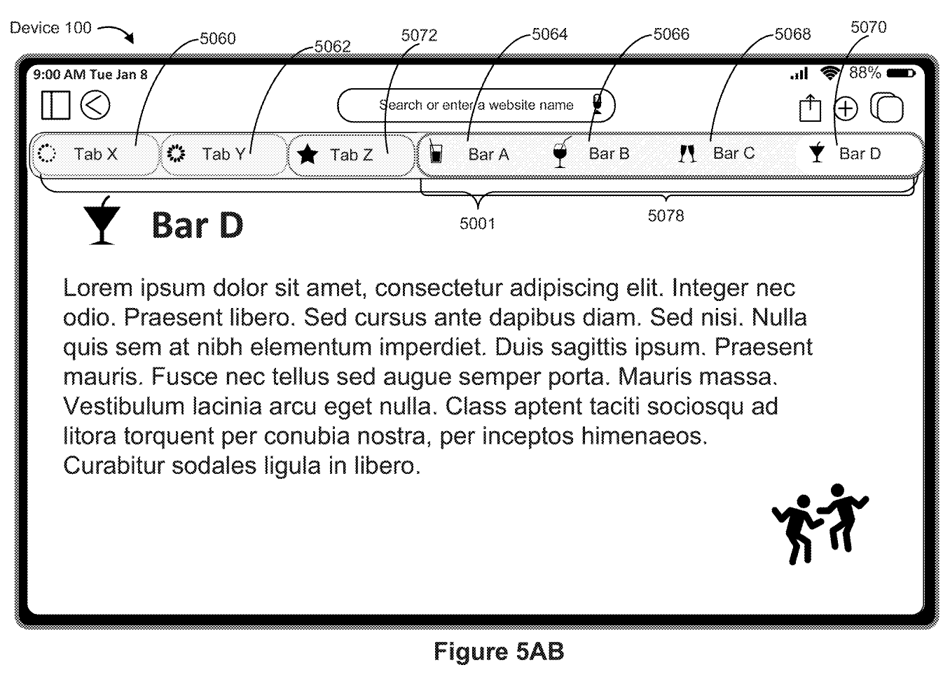

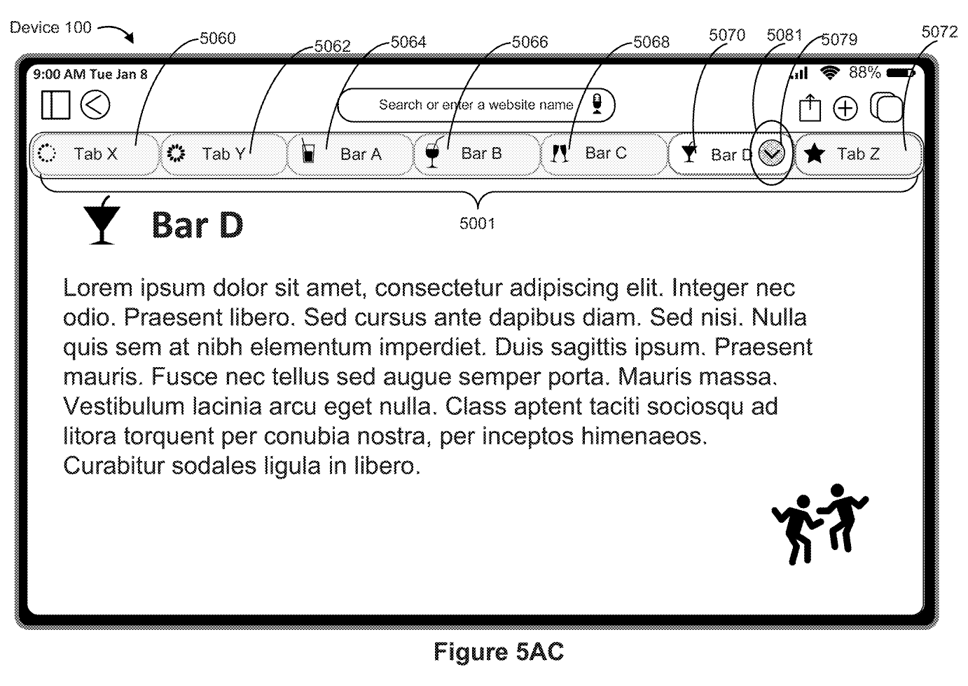

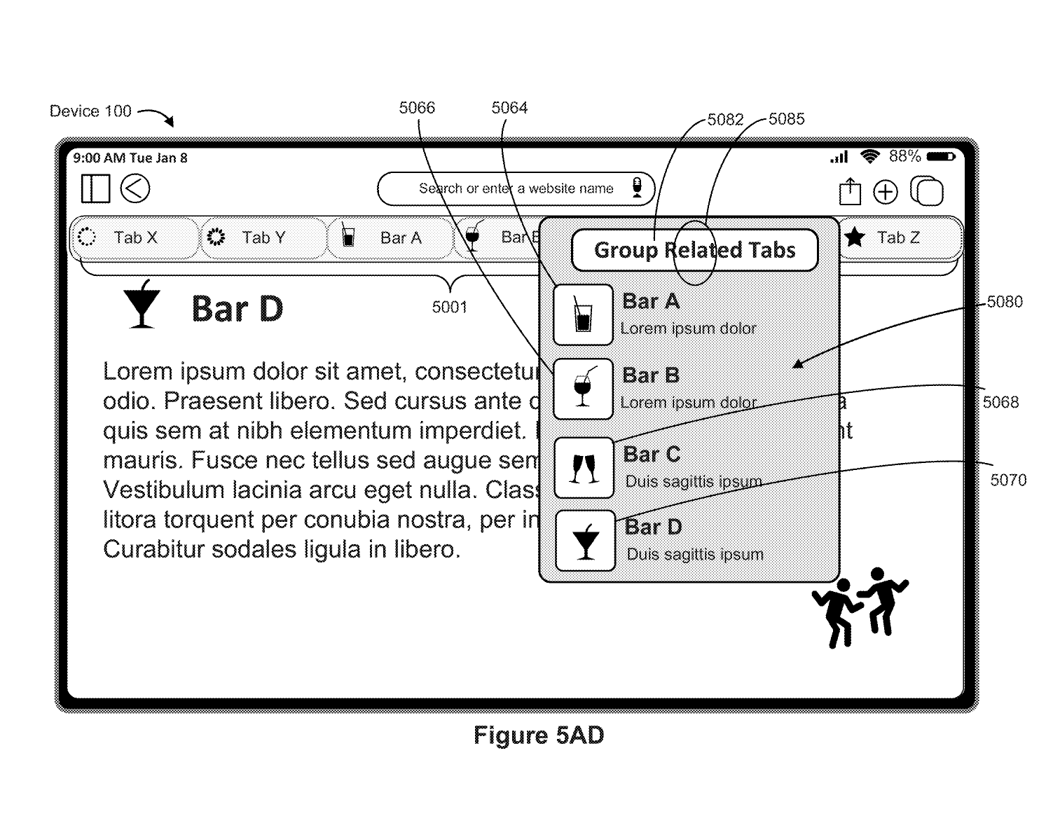

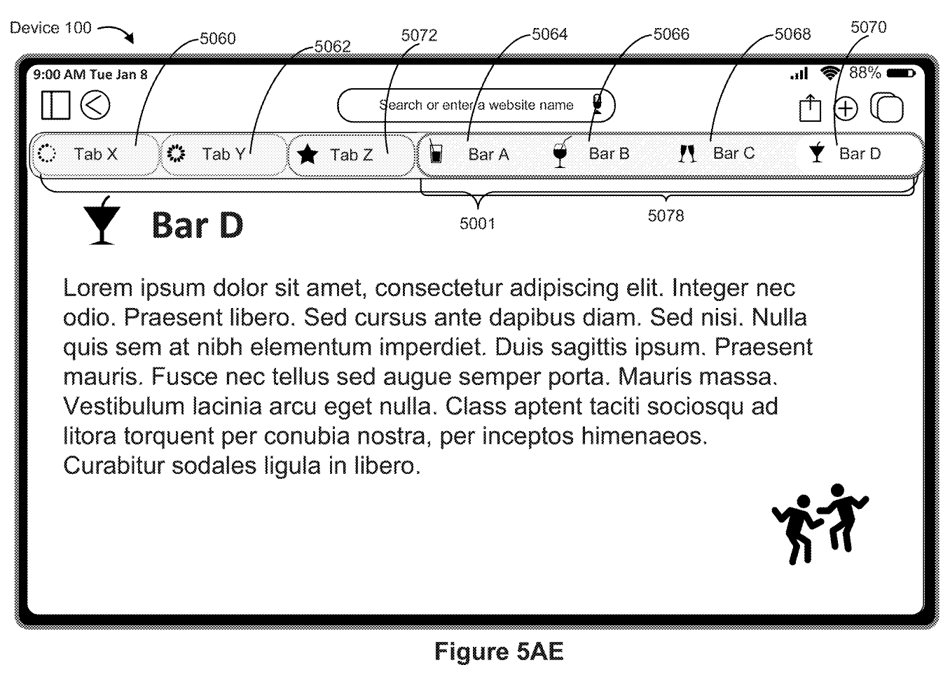

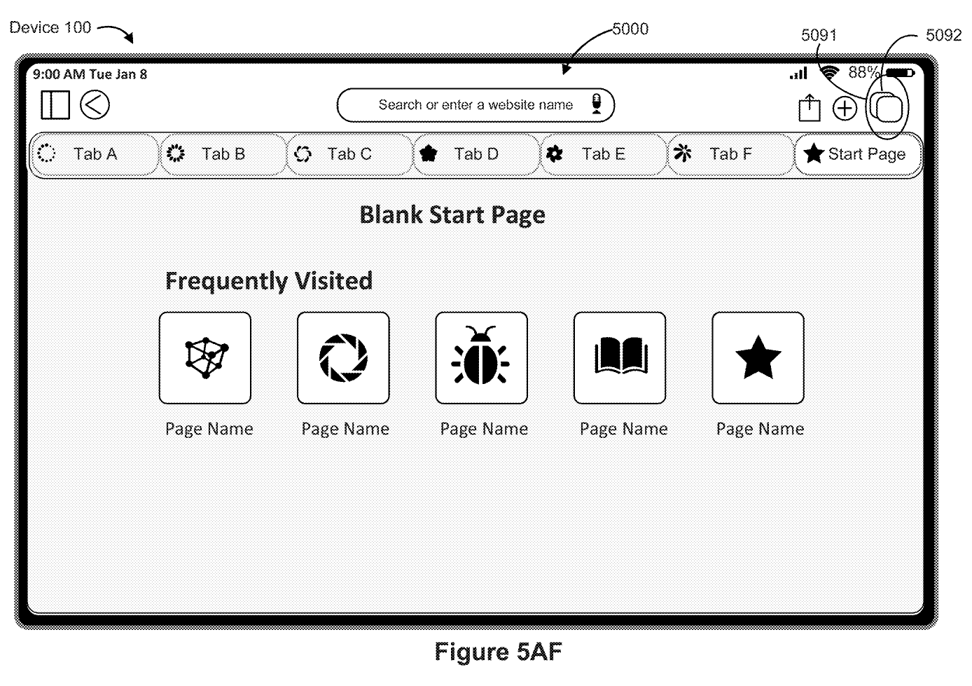

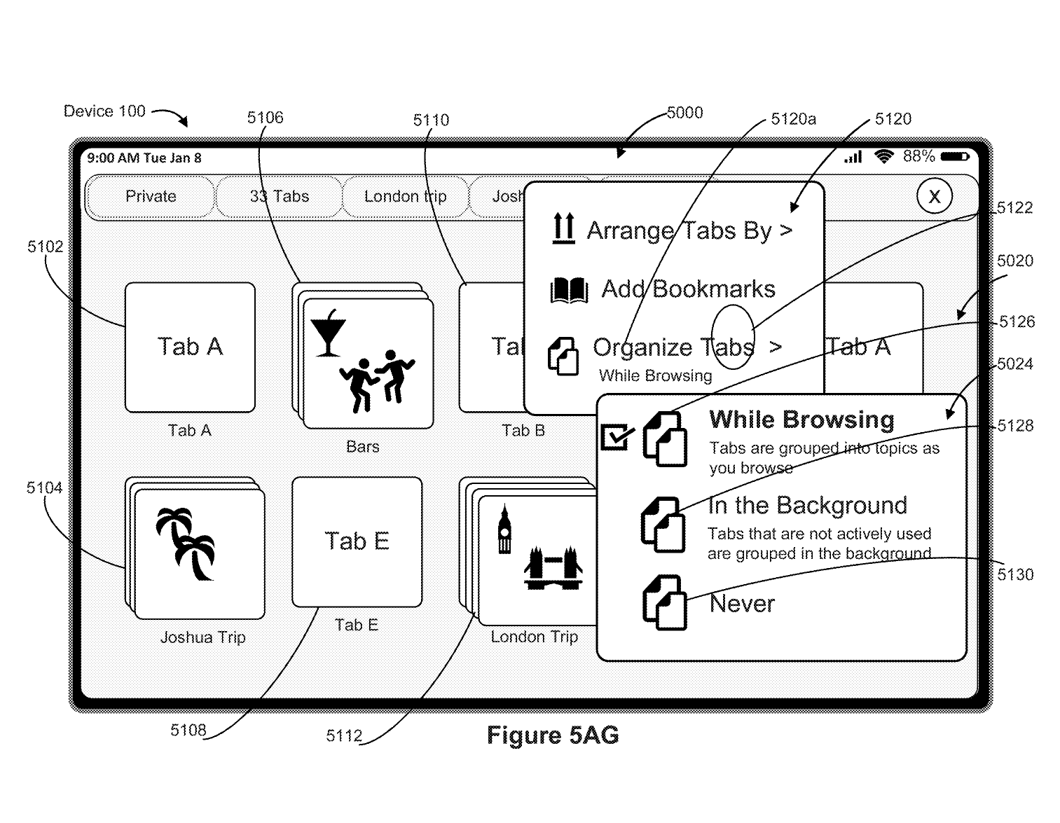

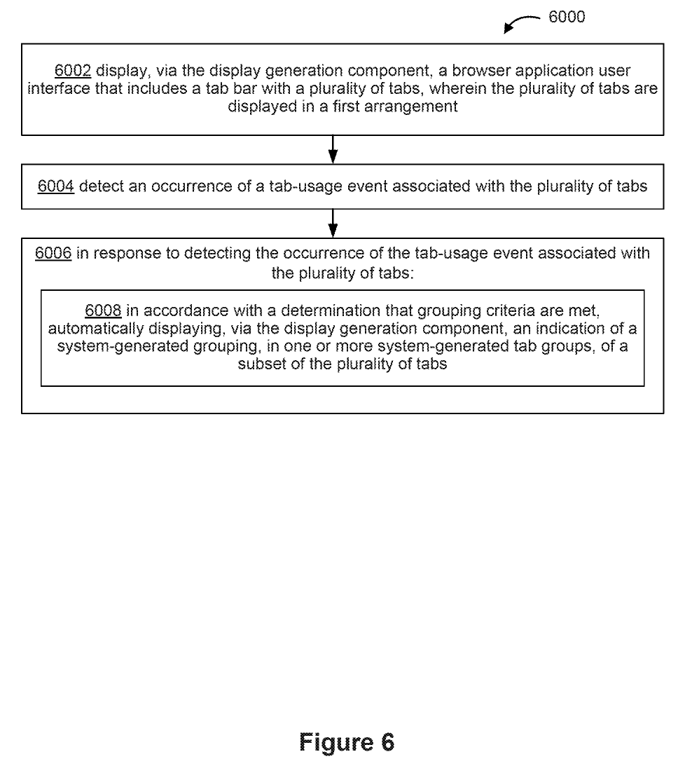

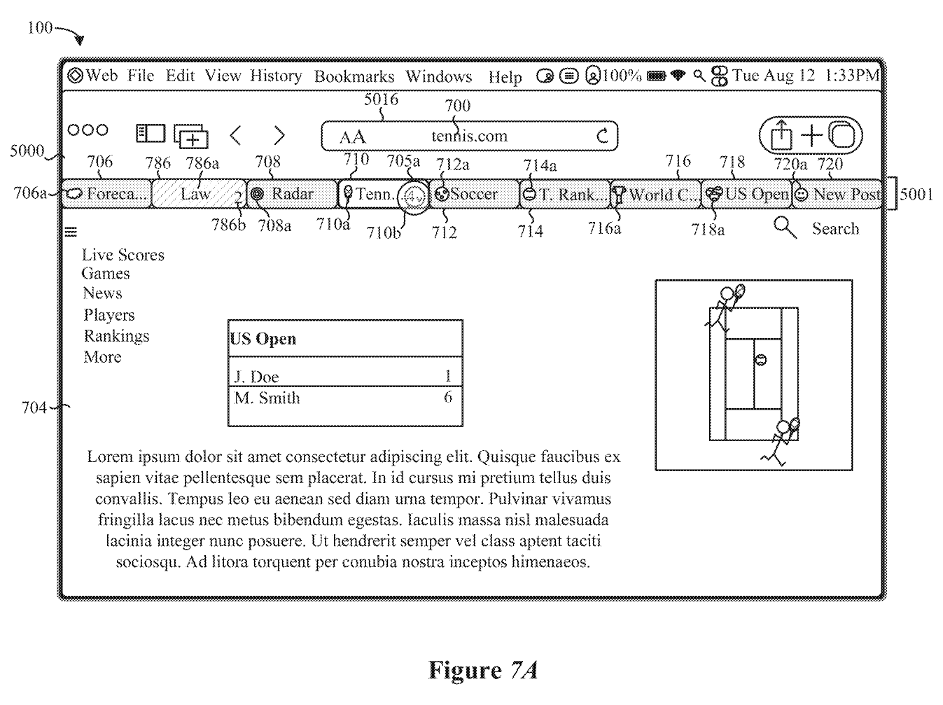

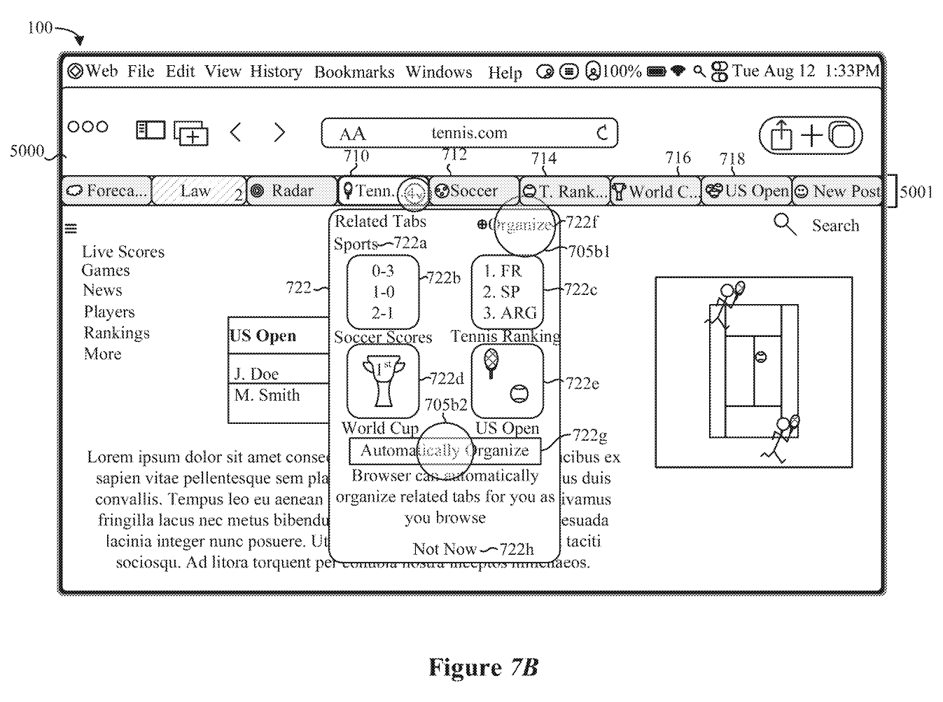

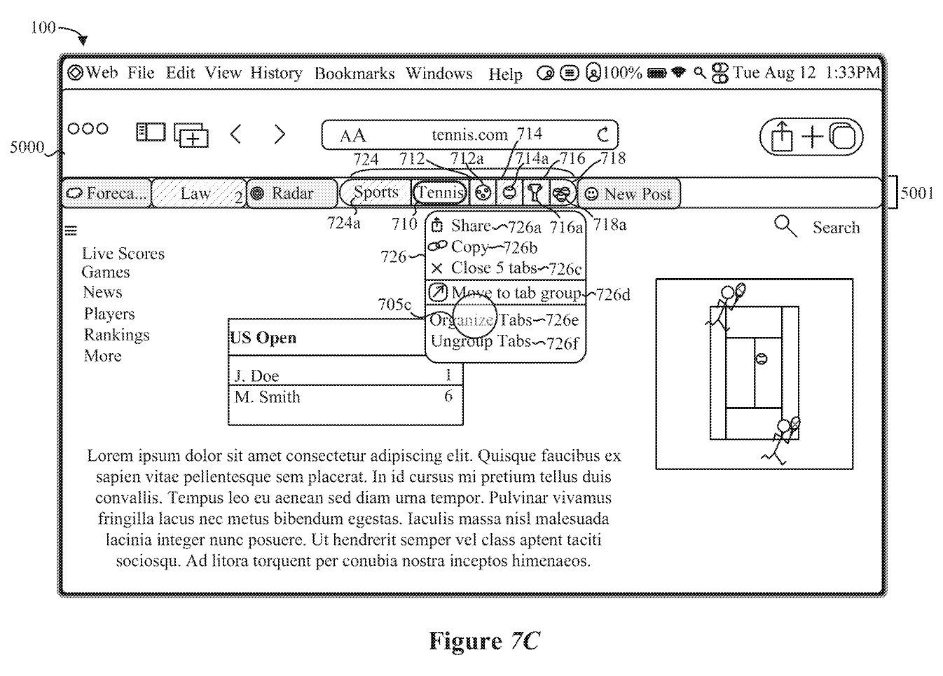

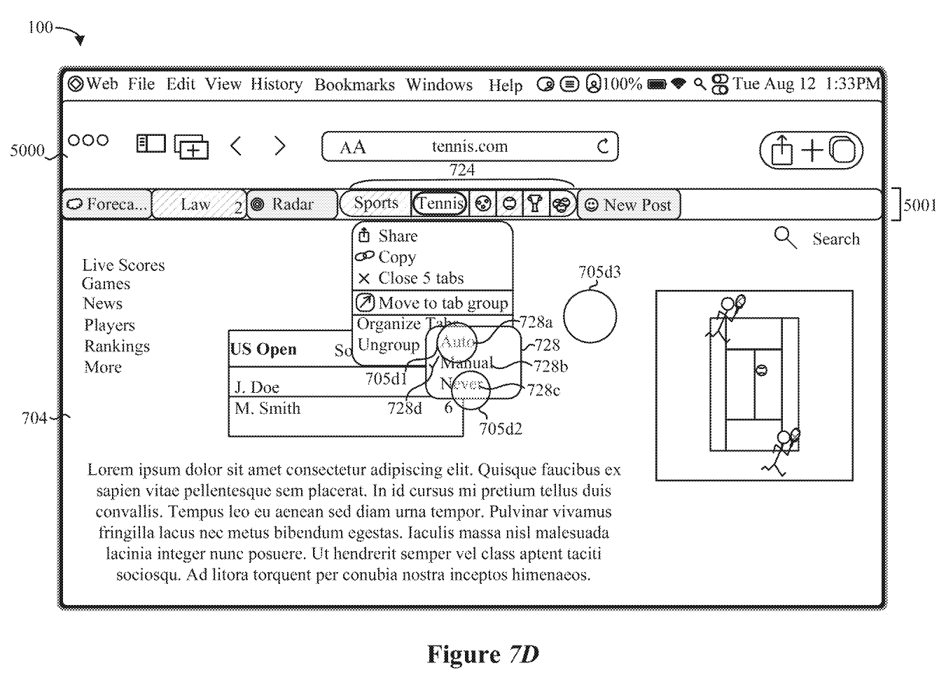

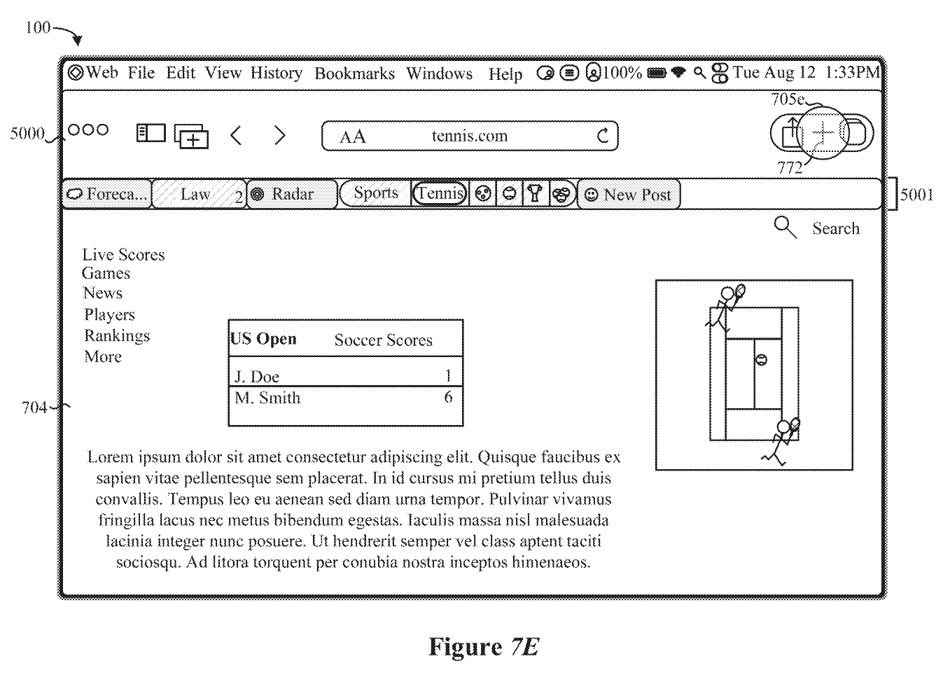

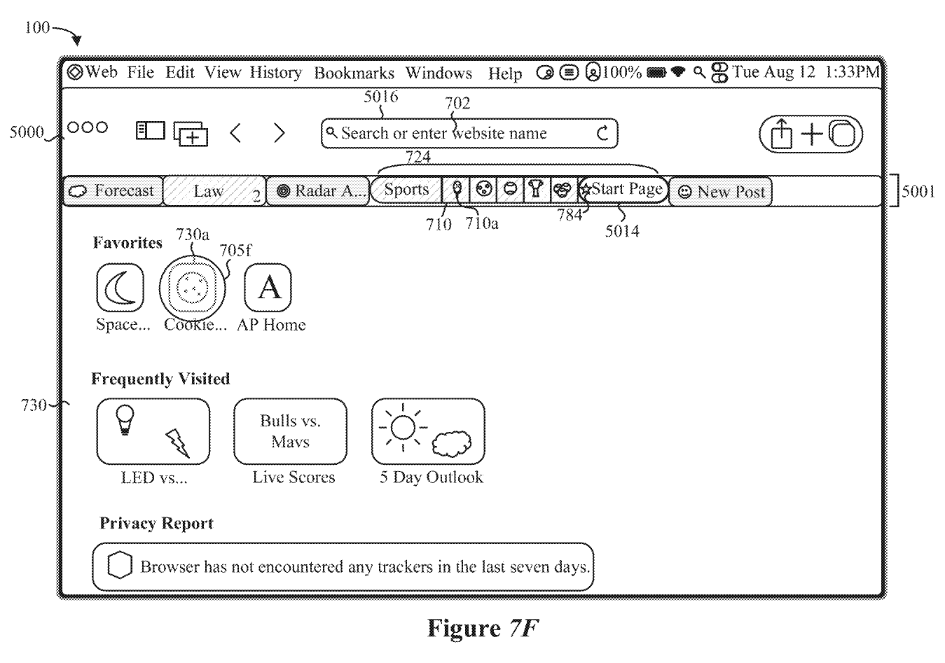

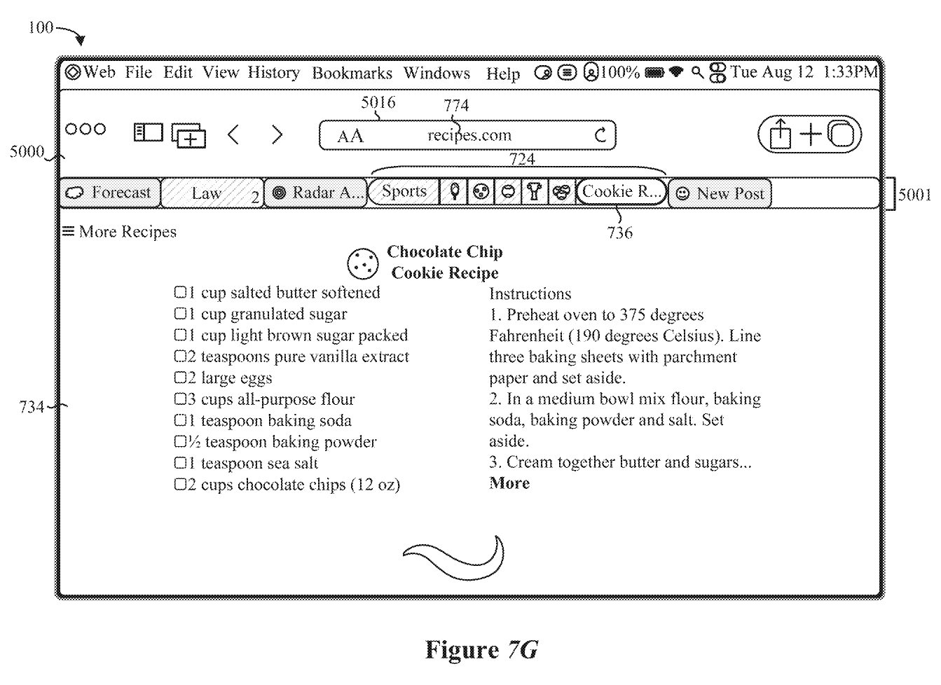

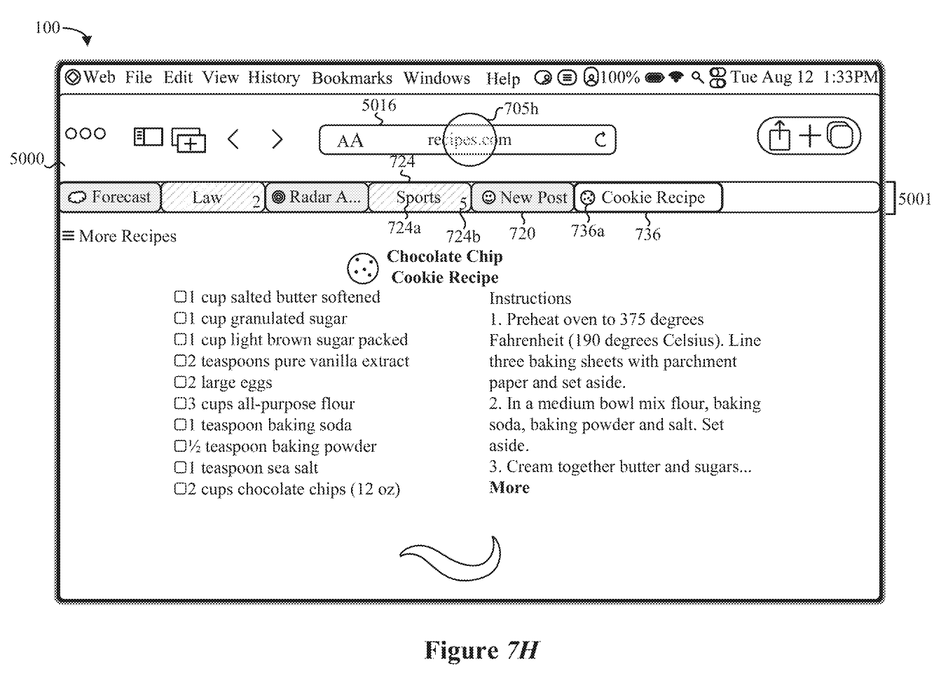

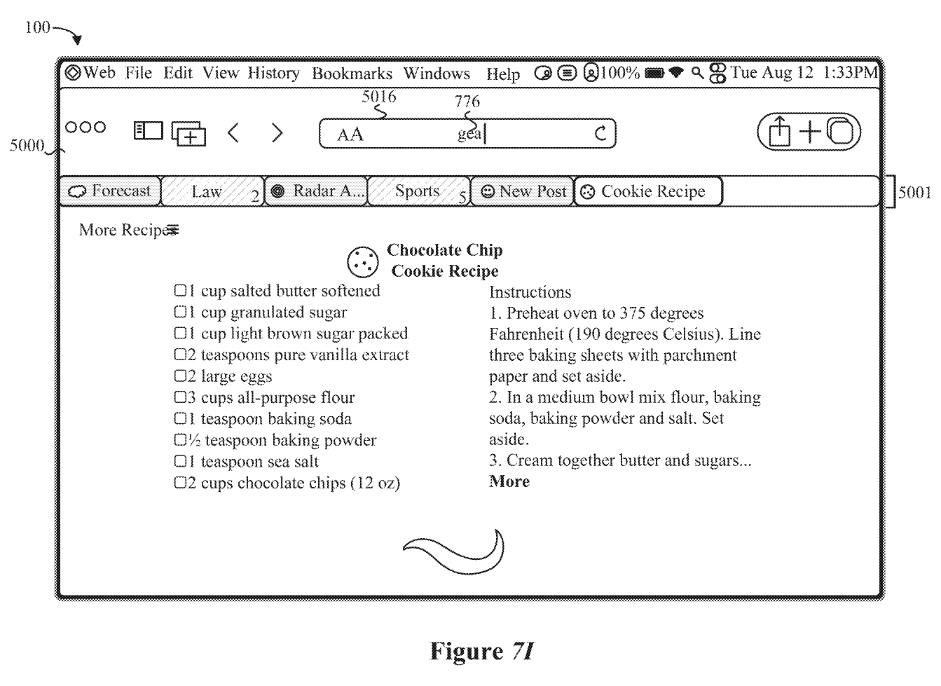

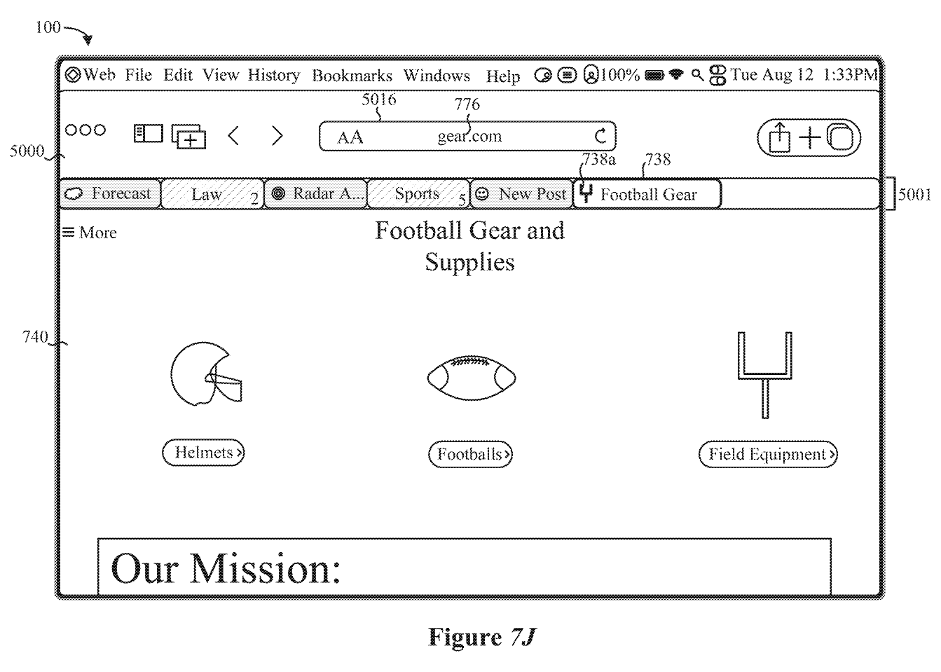

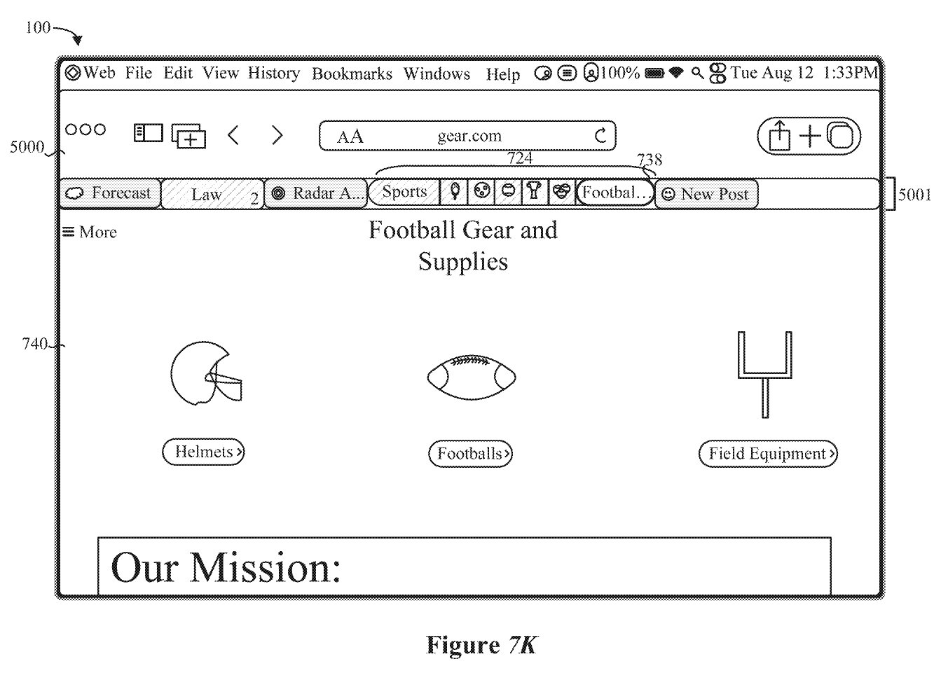

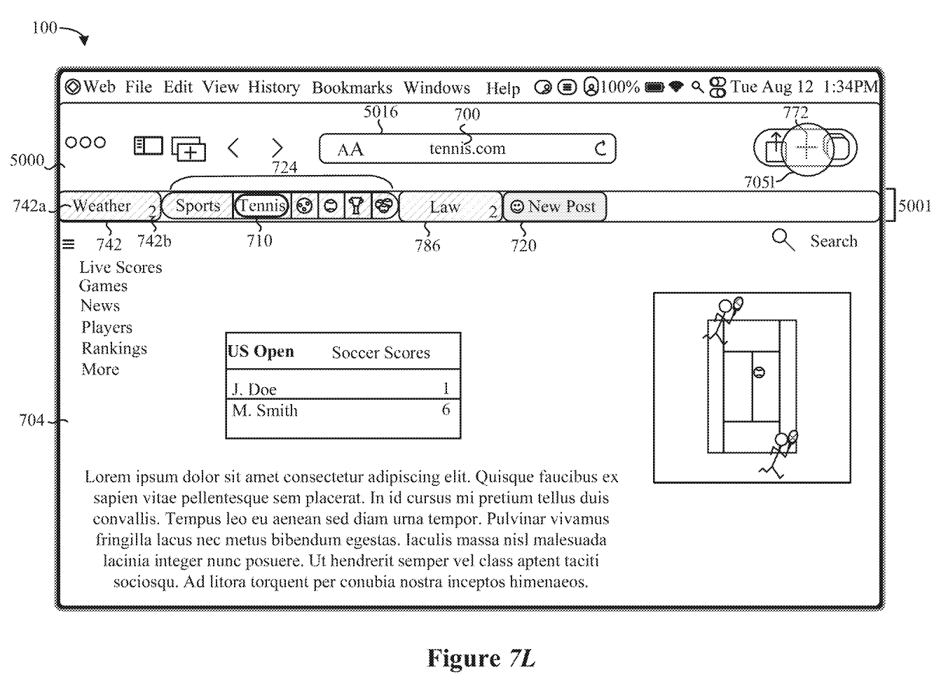

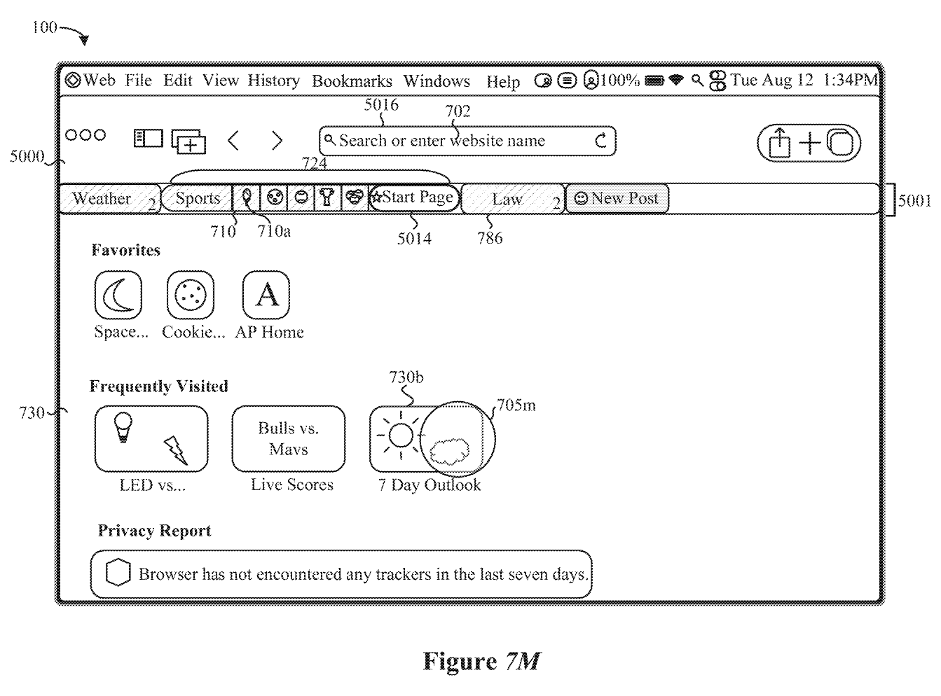

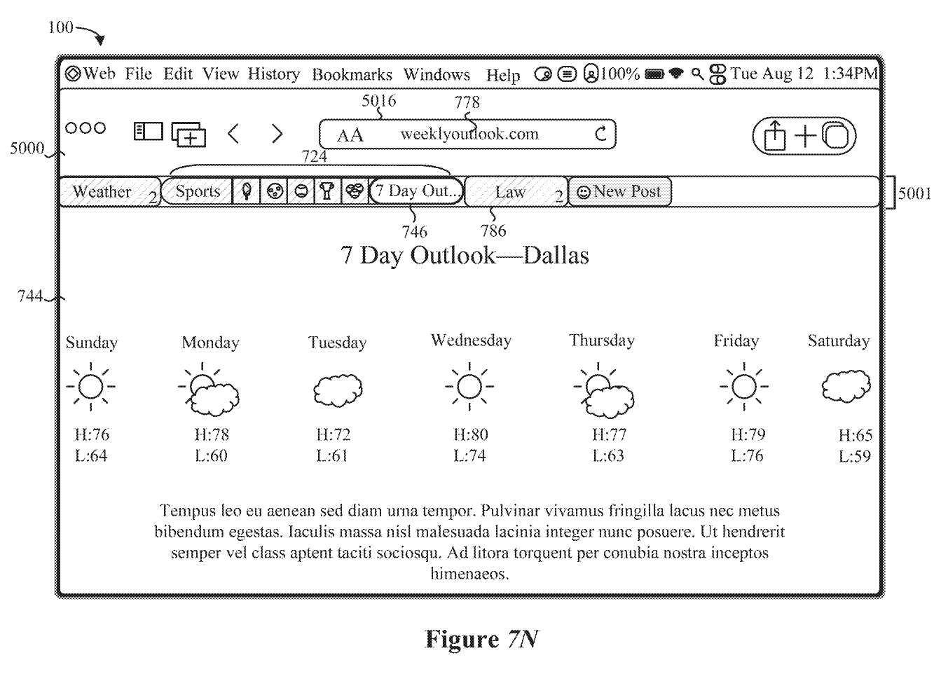

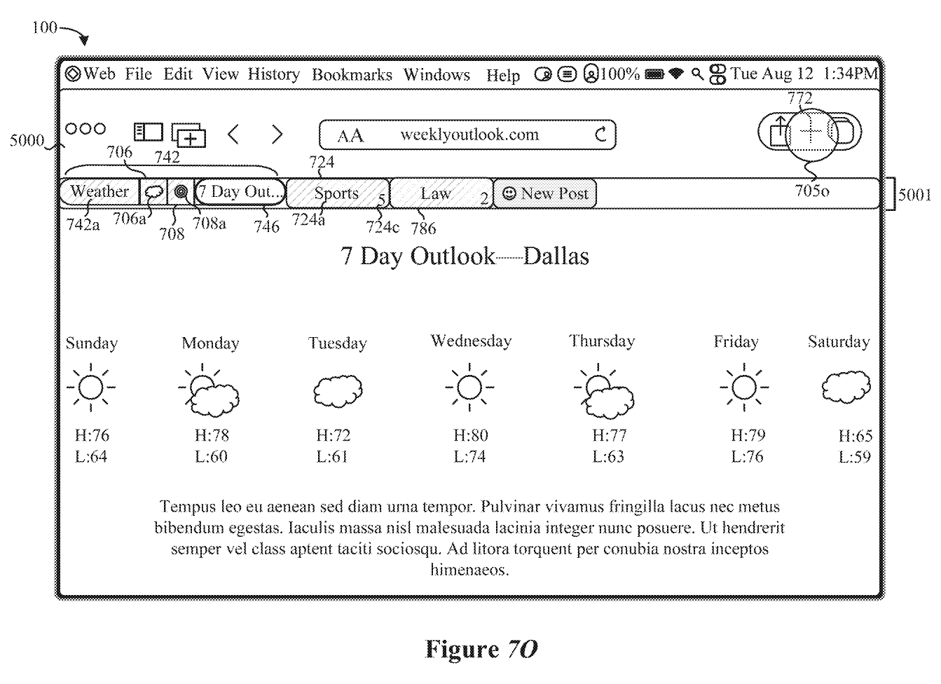

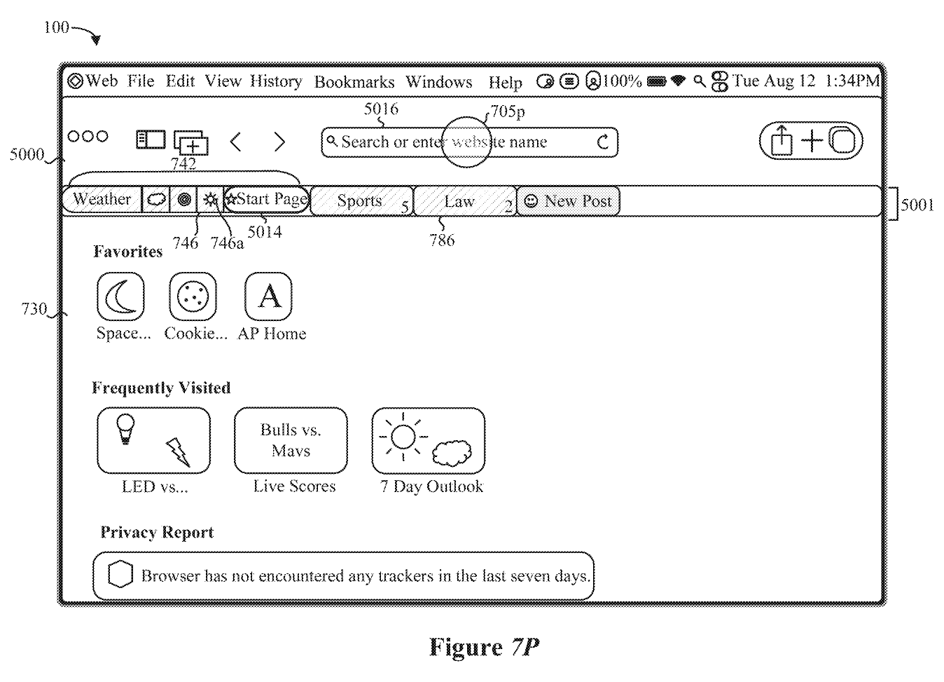

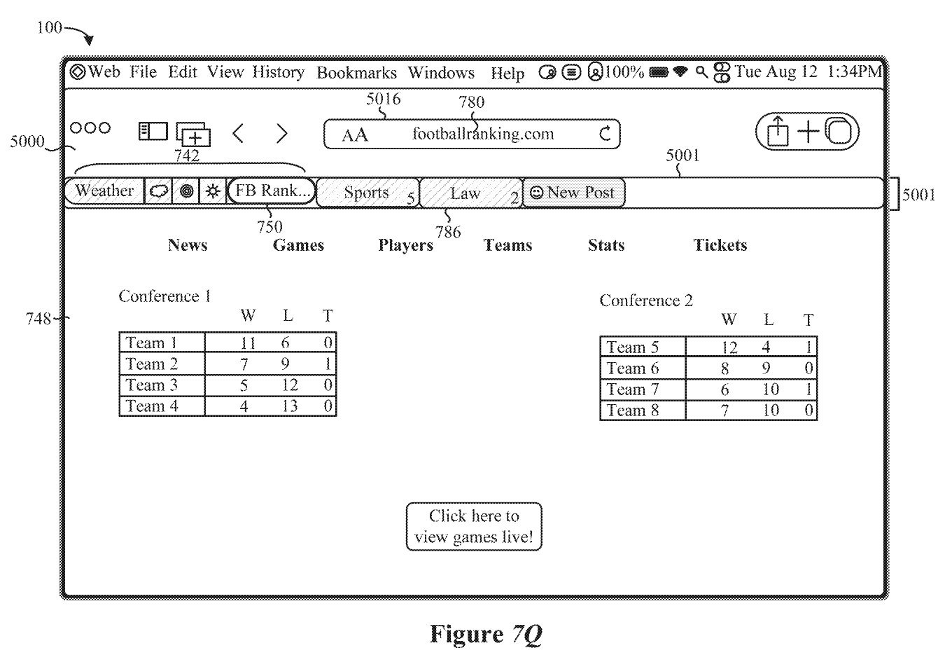

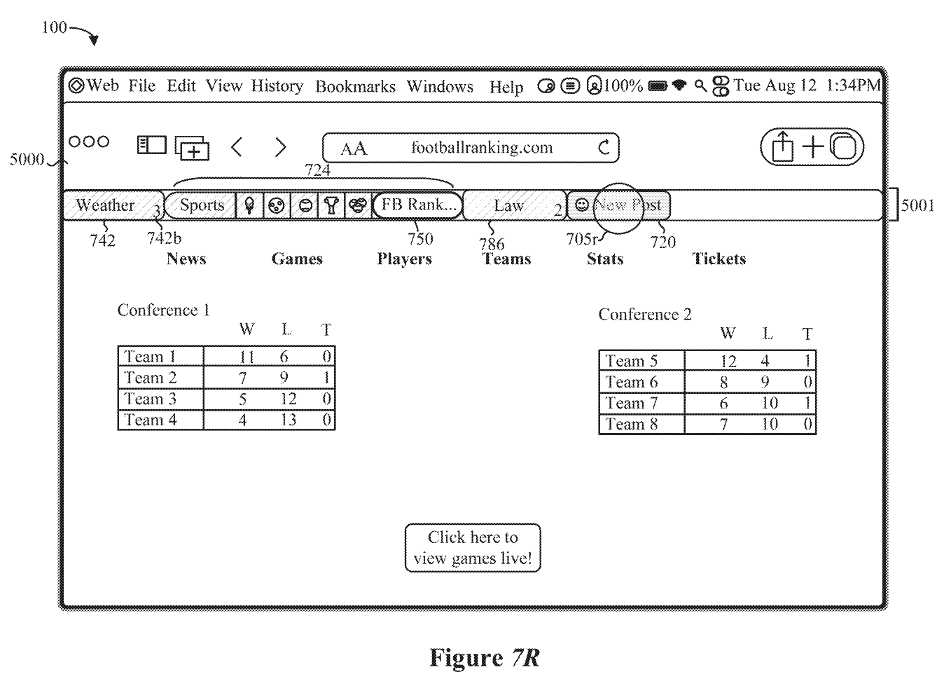

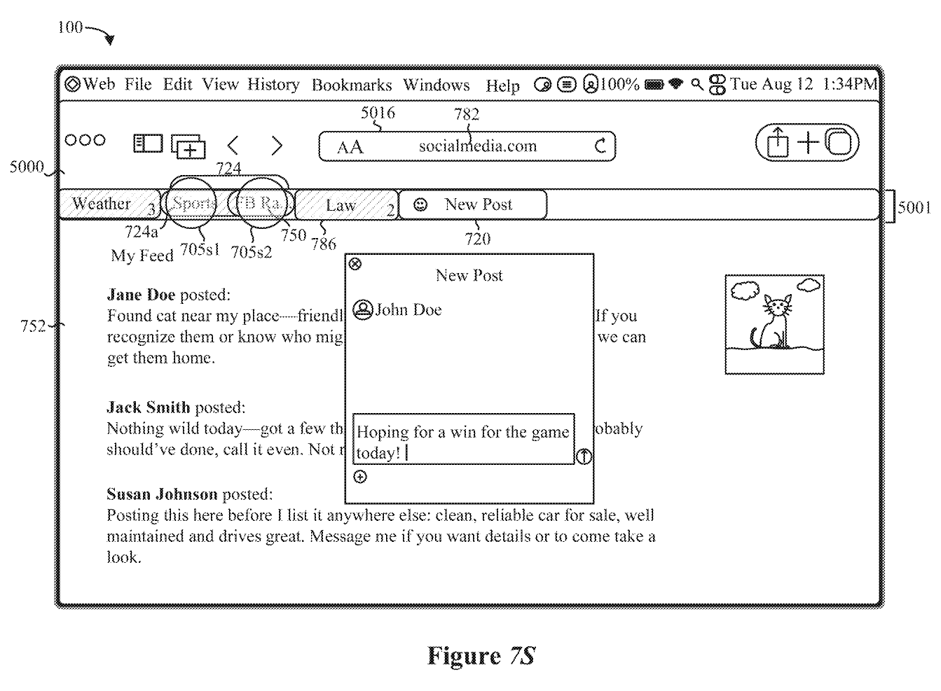

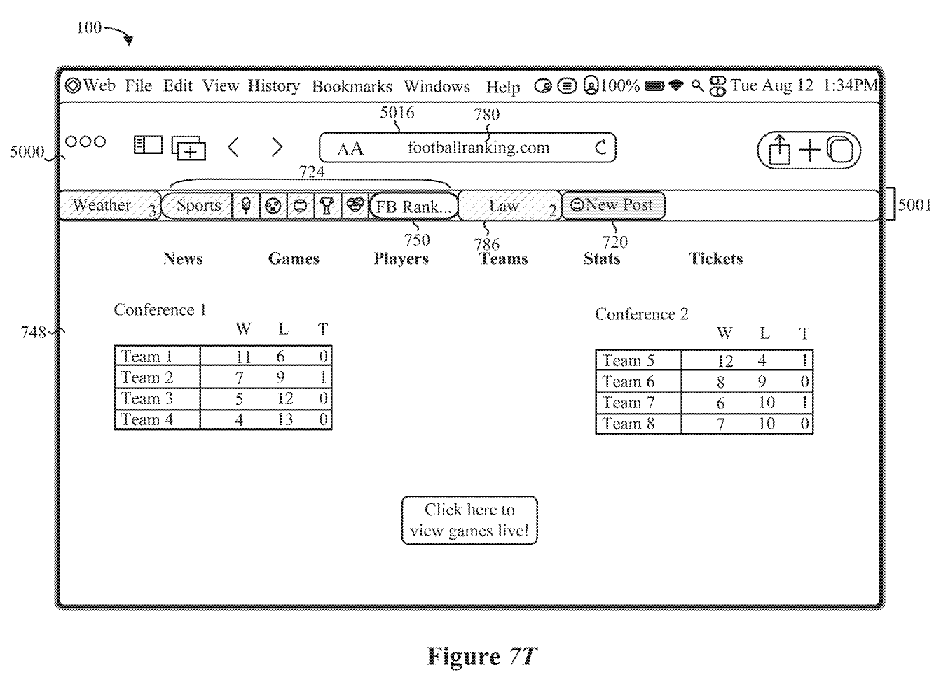

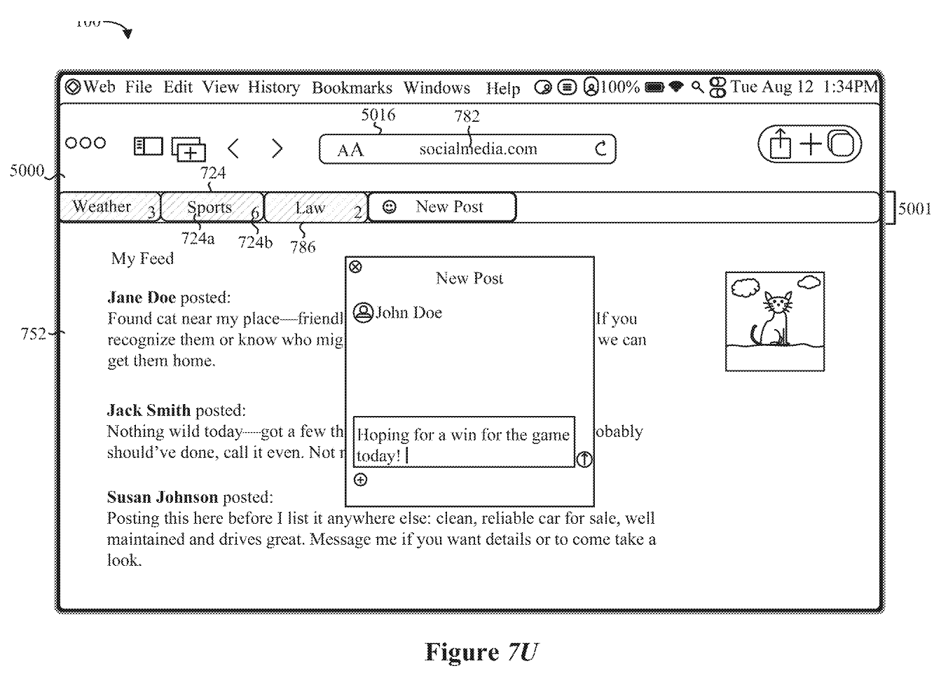

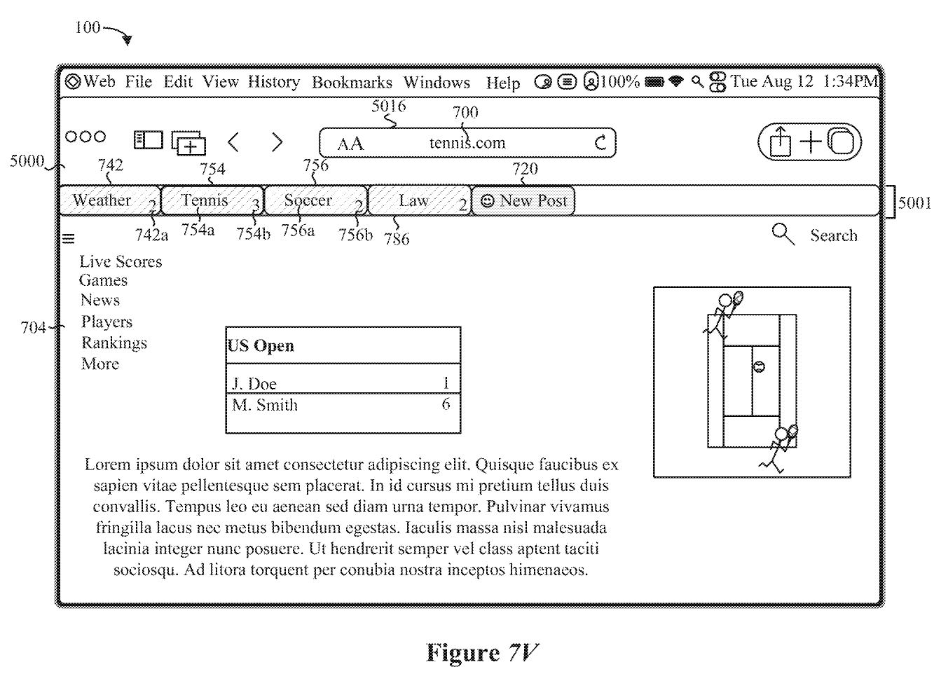

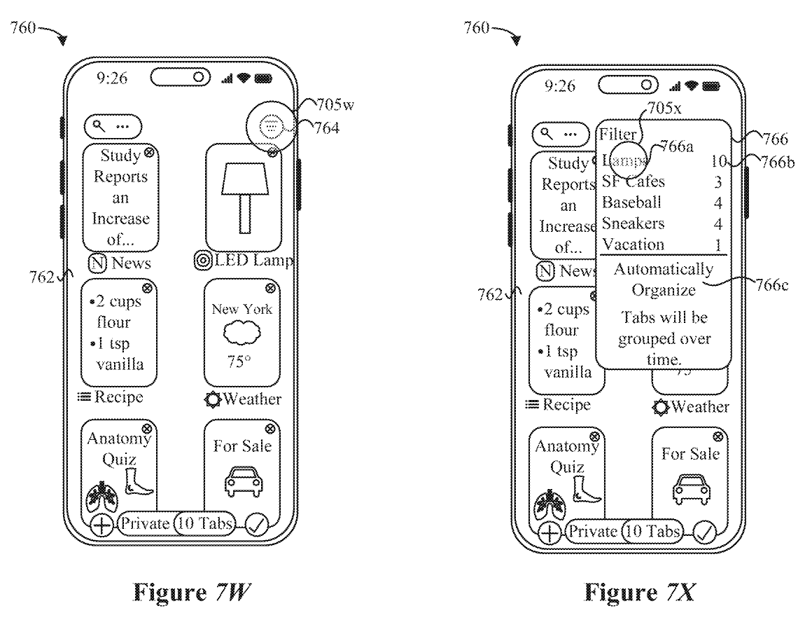

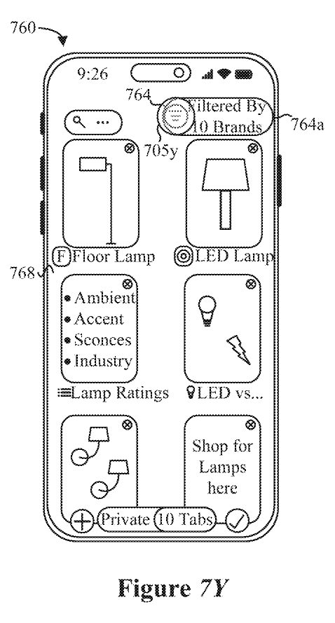

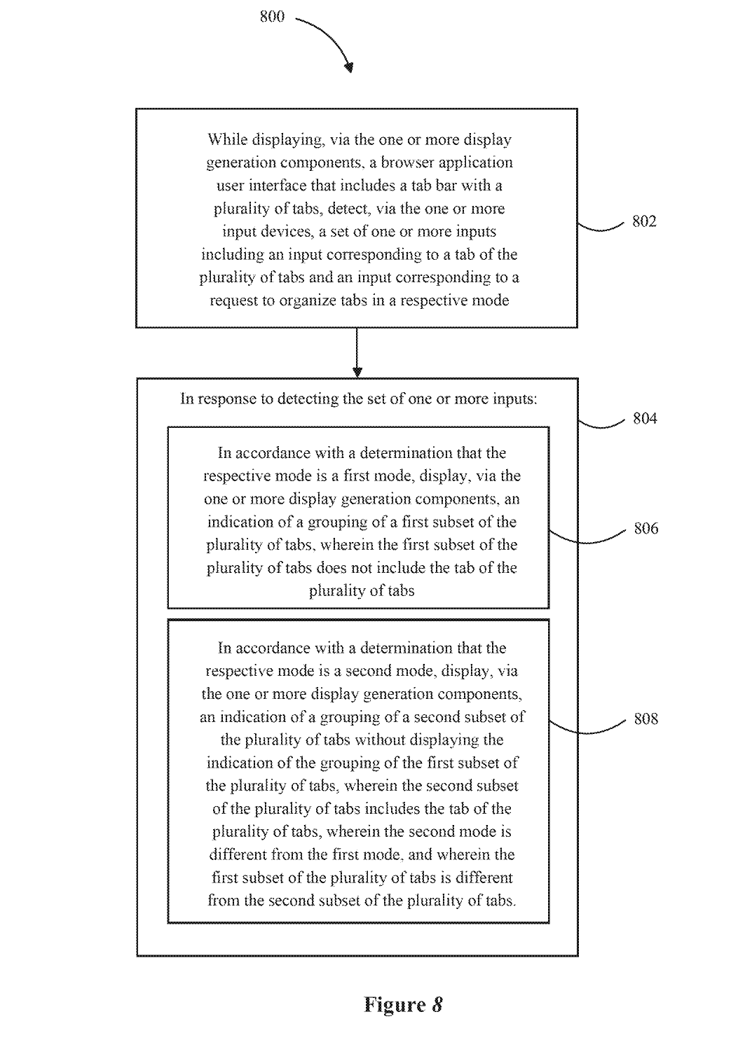

Below, FIGS. 1A-1B, 2, and 3 provide a description of example devices. FIGS. 4A-4B and 5A-5AG illustrate example user interfaces for switching between tab groups in a browser application. FIG. 6 illustrates a flow diagram of a method of for switching between tab groups in a browser application. FIGS. 7A-7Y illustrate exemplary user interfaces for organizing tabs in a web browser in accordance with some embodiments. FIG. 8 is a flow diagram illustrating a process for organizing tabs in accordance with some embodiments. The user interfaces in FIGS. 7A-7Y are used to illustrate the processes described below, including the processes in FIG. 8.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user’s sense of touch. For example, in situations where the device or the component of the device is in contact with a surface of a user that is sensitive to touch (e.g., a finger, palm, or other part of a user’s hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user’s movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user’s perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user’s operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user’s operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user’s experience when the user interacts with a user interface and/or the device, and facilitate better conveyance of information regarding the state of the user interface and/or the device, and which reduce input errors and increase the efficiency of the user’s operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

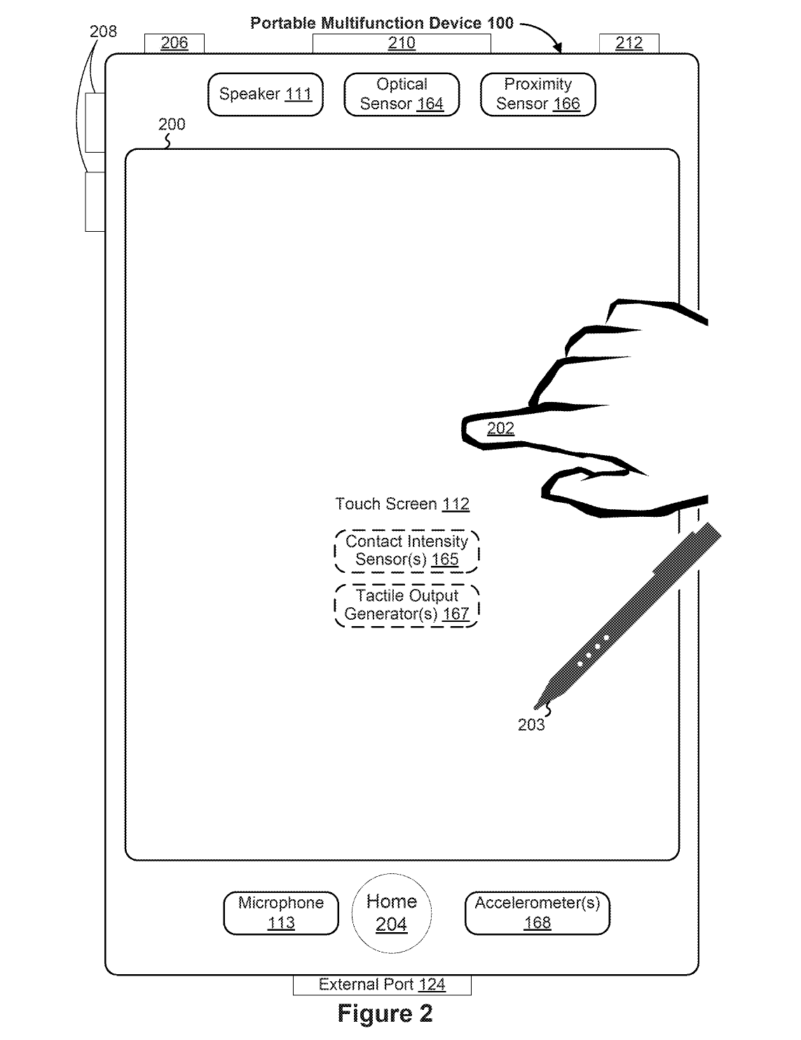

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

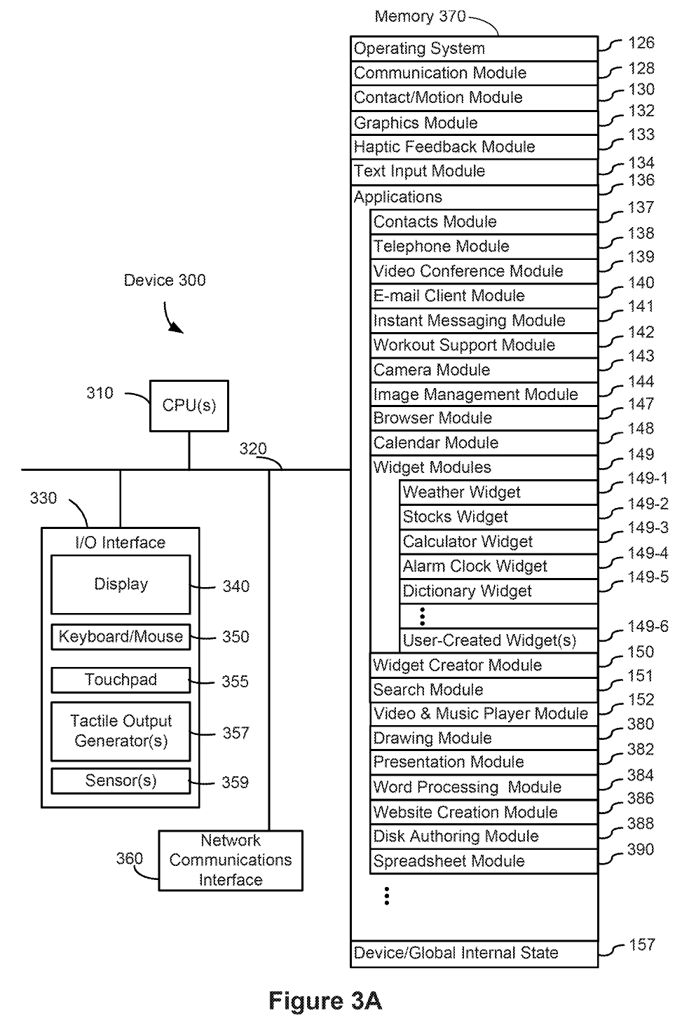

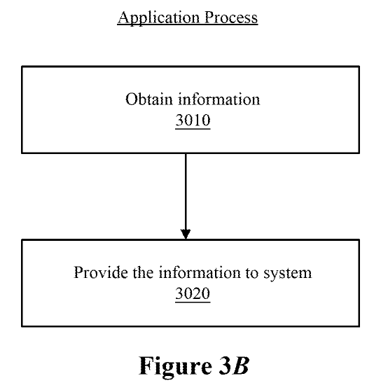

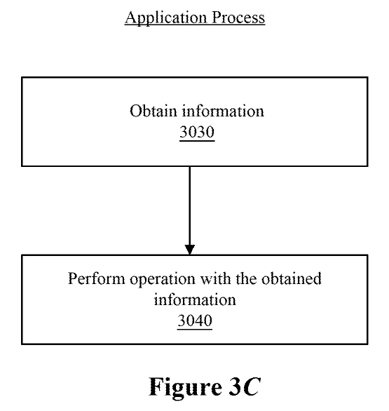

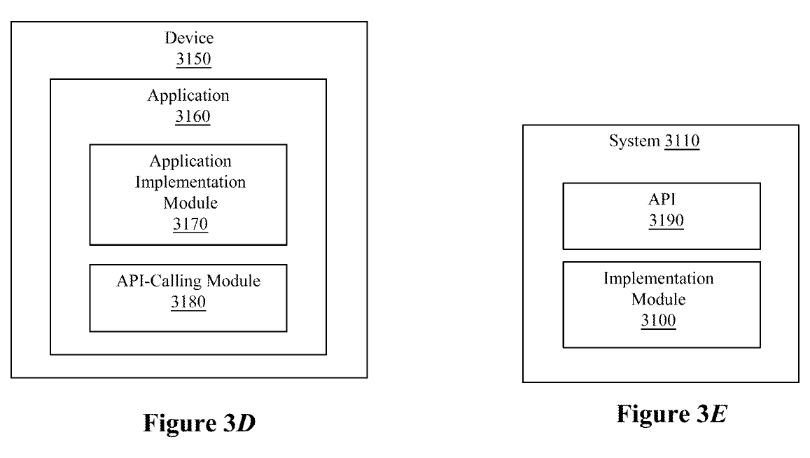

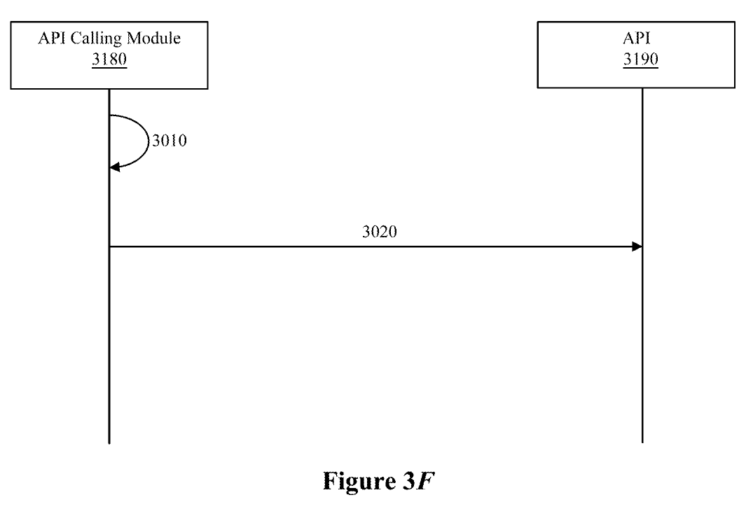

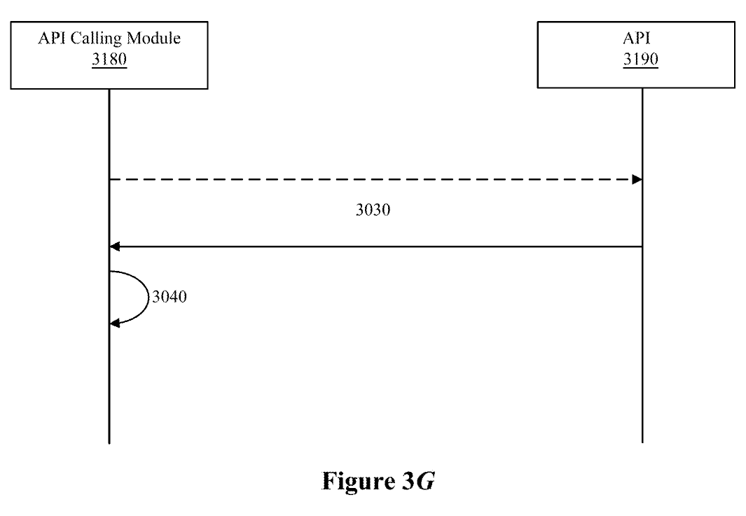

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device’s various sensors and other input or control devices 116; and location and/or positional information concerning the device’s location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture – which do not require that the intensity of the contact(s) meet a respective intensity threshold in order for the first gesture recognition criteria to be met – are in competition with second gesture recognition criteria for a second gesture – which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIGS. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application’s user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer’s event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child’s learning toy), a gaming system, or a control device (e.g., a home or industrial controller). Device 300 typically includes one or more processing units (CPU’s) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIGS. 3B and 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIGS. 3C and 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform operations described below including those described with reference to FIGS. 6 and/or 8 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user’s intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. Patent Application Serial Nos. 14/399,606 and 14/624,296, which are incorporated by reference herein in their entireties.

### USER INTERFACES AND ASSOCIATED PROCESSES

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AG illustrate example user interfaces for automatically grouping and rearranging tabs in a browser application, in accordance with some embodiments. The user interfaces in these figures are used to illustrate the processes described below, including the processes described herein with respect to FIG. 6. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch- sensitive surface 451 (e.g., as shown in FIG. 4B) in response to detecting the contacts on the touch-sensitive surface 451 while displaying on display 450 user interfaces such as the user interfaces described herein with reference to FIGS. 5A-5AG, along with a focus selector.

FIGS. 5A-5AG illustrate example user interfaces for automatically grouping and rearranging tabs in a browser application, in accordance with some embodiments.

FIGS. 5A-5C illustrate example user interfaces for automatically grouping adjacent tabs (e.g., or consecutive tabs) in a browser application in response to detecting a tab-usage event (e.g., opening a webpage in a tab) and determining that grouping criteria are met, in accordance with some embodiments.

FIG. 5A illustrates portable multifunction device 100 with integrated touch-sensitive display 112. User interface 5000 (sometimes herein called a browser application user interface) of a browser application (e.g., browser module 147) is currently displayed on the touch-sensitive display 112. The user interface 5000 includes tab bar 5001. Tab bar 5001 includes open tabs. In this example, tab bar 500 includes tab 5002 “A”, tab 5004 “B”, tab 5006 “C”, tab 5008 “D”, tab 5010 “E”, tab 5012 “F”, and blank tab 5014 (e.g., collectively referred to as tabs 5002-2014). Optionally, a respective tab of tabs 5002-5014 includes a logo, a name, an URL address, and/or other webpage identifier of a webpage that is opened in the tab. In the example in FIG. 5A, the blank tab 5014 is currently selected (e.g., is currently active). Because no web page is loaded in blank tab 5014, the device 100 displays a start page in content area 5020 of the user interface 5000, where, in this example, the start page includes tiled images of suggested web pages (e.g., the tiled images are linked to webpages) that, when selected, cause the device 100 to open respective web pages. Field 5016 is a search field or an address field. A user can enter a web address and/or a search phrase to open a webpage (e.g., in the currently active tab 5014 or, optionally, in a new tab).

FIG. 5B is a transition from FIG. 5A after a webpage “G” is opened in blank tab 5014. For example, FIG. 5B illustrates that field 5016 includes an URL address of the webpage “G” (e.g., “pagenameg.com”), where in FIG. 5A, the field 5016 includes a textual prompt for the user to enter a website name (e.g., “Search or enter a website name”). FIG. 5B shows that content of the webpage “G” is displayed in the content area 5020. In some embodiments, in response to detecting that the webpage “G” is opened and/or loaded in the tab 5014, and in accordance with a determination that webpages of tabs 5010 and 5012 are related to webpage “G” of tab 5014, the device 100 automatically groups tabs 5010, 5012, and 5014 in a system-generated grouping.

FIG. 5C is a transition from FIG. 5B in response to a determination that, after the webpage “G” is loaded in the tab 5014, the tabs 5010, 5012, and 5014 meet grouping criteria. In some embodiments, grouping criteria is based on various characteristics of the tabs. In some embodiments, grouping criteria includes criteria based on content similarity (e.g., grouping based on topic clustering, semantic analysis, and/or page title similarity). For example, multiple tabs that include content related to a same or similar topic are grouped together. In some embodiments, grouping criteria includes criteria based on activity or task context. For example, trained machine learning models are used to infer context, intent, and/or recognize tasks (e.g., shopping, research, etc.), and group tabs accordingly. In some embodiments, grouping criteria includes criteria based on tab hierarchy or relatedness. For example, tabs that are opened from the same parent tab are grouped together. In some embodiments, grouping criteria includes criteria based on time of tab opening. For example, tabs opened within a short time window (e.g., within a few minutes of each other) or within the same session are determined to be contextually related and grouped together. In some embodiments, grouping criteria includes criteria based on domain name or hostname matching. For example, the device 100 groups the tab 5014 and adjacent tabs 5010 and 5012 in accordance with a determination that content of webpages of the tabs 5010, 5012, and 5014 are associated with a same topic or similar topics. In some embodiments, the grouping criteria include a requirement that more than a predetermined number of tabs in tab bar 5001 be related for the tabs to be grouped (e.g., also referred to as minimum threshold requirement). In response to determining that the tabs 5010, 5012, and 5014 meet the grouping criteria, the device 100 automatically groups the tabs 5010, 5012, and 5014 and display a visual indication of the newly formed tab group 5022. In some embodiments, displaying the visual indication includes removing visual boundaries between tabs 5010, 5012, and 5014 and displaying tabs 5010, 5012, and 5014 as one (e.g., large) container tab representing tab group 5022. In some embodiments, displaying the visual indication includes highlighting or otherwise visually emphasizing tab group 5022 when it is generated, as illustrated in FIG. 5C. Displaying the tabs 5010, 5012, and 5014 in a container tab provides a visual demarcation between the grouped tabs 5010, 5012, and 5014 and other tabs in the tab bar 5001 that are not part of the same group (e.g., tabs 5002, 5004, 5006, and 5008). In FIG. 5C, tab group 5022 is in an expanded state, where individual tabs 5010, 5012, and 5014 are visible. For example, the device 100 maintains the display of logos and/or names of tabs 5010, 5012, and 5014 (e.g., webpage name “Tab E” of the tab 5010, the webpage name “Tab F” of the tab 5012, and the webpage name “Tab G” of the tab 5014) even though boundaries between them are removed and the tabs 5010, 5012, and 5014 are displayed as a single container tab.

In some embodiments, while at least one tab is active (e.g., currently selected) in a tab group, the tab group itself is active (e.g., currently selected). In some embodiments, an active tab group is displayed in an expanded state. In the example in FIGS. 5C-5D, tab group 5022 is displayed in an expanded state because tab 5014, which is included in tab group 5022, is currently active. In some embodiments, a tab group collapses and becomes inactive in response to switching focus to a tab that is outside the tab group. In some embodiments, a tab group collapses and becomes inactive in response to other inputs that move focus away from the tab group (e.g., by opening a new tab and/or selecting other controls or fields in the user interface 5000 of the browser application). Collapsing a tab group in response to switching focus to a tab outside the tab group is illustrated in FIGS. 5D-5E, as described below.

FIG. 5D shows a tap input 5027 that causes the device 100 to select tab 5004, which is outside (e.g., not included in) the active tab group 5022. FIG. 5E shows a transition from FIG. 5D in response to detecting the tap input 5027 selecting the tab 5004 that is not included in the active tab group 5022. In response to detecting the tap input 5027 selecting the tab 5004, the device switches focus from the tab 5014 to the selected tab 5004, and the tab 5004 becomes currently active, as illustrated in FIG. 5E. For example, content of the webpage “B” of the currently active tab 5004 is displayed in the content area 5020. In response to switching focus from the tab 5014, which is included in the tab group 5022, to the tab 5004, which is not included in the tab group 5022, the tab group 5022 becomes inactive (e.g., because there is no active tab in the group) and device 100 displays the tab group 5022 in a collapsed state. In some embodiments, in the collapsed state, tabs in the tab group are represented by a container tab, such that individual tabs in the tab group are not displayed. For example, in FIG. 5E, the tabs 5010, 5012, and 5014 included in the tab group 5022 are not (individually) visible. In some embodiments, in conjunction with collapsing the tab group 5022, the device 100 automatically generates and displays a label 5022a that represents a system-generated name or topic of the tab group 5022. In some embodiments, the device 100 generates the label 5022a using a language model. In some embodiments, collapsing of the tab group 5022 is animated. For example, animating the collapse of the tabs 5010, 5012, and 5014 of the tab group 5022 includes morphing the tabs 5010, 5012, and 5014 into the container tab. In some embodiments, morphing the tabs 5010, 5012, and 5014 into the container tab includes gradually reducing the size of tabs 5010, 5012, and 5014, removing names, labels, and/or other identifying information of the individual tabs, and, eventually, merging the tabs 5010, 5012, and 5014 into one container tab (e.g., after the size of tabs 5010, 5012, and 5014 is reduced below a respective threshold size). In some embodiments, merging tabs into one container tab includes ceasing display of individual labels of the tabs 5010, 5012, and 5014. In some embodiments, while the tab group 5022 is in a collapsed state, the device 100 optionally maintains display of logos 5022b of the individual tabs 5010, 5012, and 5014 that are included in the tab group 5022, even though the names (e.g., or labels or addresses) of the individual tabs 5010, 5012, and 5014 are not visible, as illustrated in FIG. 5E.

FIG. 5F shows a transition from FIG. 5E after the tab group 5022 is displayed in the collapsed state. While the tab 5004 is active and the tab group 5022 is inactive and in the collapsed state, the device 100 detects a tap input 5029 selecting tab group 5022. In response to detecting the tap input 5029 selecting the group 5022, the device 100 expands the tab group 5022 to reveal tabs included in the tab group 5022. In some embodiments, the expansion of the tab group 5002 is animated, as illustrated in FIGS. 5G-5I.

FIGS. 5G-5I show an example of a series of intermediate states of expansion of the tab group 5022 in response to detecting the tap input 5029 (see FIG. 5F) selecting the tab group 5022. For example, FIG. 5G shows several changes in the tab bar 5001 that are performed in response to activating the tab group 5002. For example, the webpage content of the last active tab, the tab 5004 (e.g., the tab 5004 was active last before detecting the tap input 5029 selecting the tab group 5022) fades out, other tabs 5002, 5004, 5006, and 5008 shift (e.g., in a leftward direction) and compress to make room, in the tab bar 5001, for the hidden tabs included in the tab group 5022, and the container tab representing the tab group 5022 gradually expands (e.g., the width of the container tab increases in FIG. 5G relative to the width of the container tab in FIG. 5F).

FIG. 5H shows a transition from FIG. 5G. In FIG. 5H, tabs 5010, 5012, and 5014, which were hidden in FIG. 5G, are gradually revealed as individual tabs, while the other tabs 5002, 5004, 5006, and 5008 are further compressed and shifted (e.g., leftward) to make room for the tabs 5010, 5012, and 5014 that are gradually expanding. In some embodiments, when an inactive tab group is activated and expanded, the tab that was last active in the tab group is selected as the currently active tab. For example, because the tab 5014 was the last active tab in the tab group 5022 before the tab group 5022 collapsed in FIG. 5E, device 100 automatically selects the tab 5014, making it the currently active tab in the expanding tab group 5022. For example, FIG. 5H shows that the content of webpage “G” of the tab 5014 is redisplayed in content area 5020.

FIG. 5I shows the final state of the user interface 5000 of the browser application after tab group 5022 is fully expanded (e.g., the animation is finished). In some embodiments, the state of tab bar 5001 in FIG. 5I, after tab group 5022 has expanded, is the same or similar to the state of tab bar 5001 in FIG. 5D before tab group 5022 was collapsed, in response to tap input 5027 selecting the tab 5004.

FIGS. 5J-5O illustrate example user interfaces for automatically grouping non-adjacent tabs (e.g., or non-consecutive tabs) in a browser application. In FIGS. 5J-5O, the device 100 automatically groups the non-adjacent tabs in response to detecting a tab-usage event (e.g., opening a webpage in a tab) and determining that the grouping criteria are met, in accordance with some embodiments.

FIG. 5J illustrates a transition from FIG. 5A after webpage “H” is opened in the new tab 5014. For example, webpage “H” is opened in the blank tab 5014 (e.g., the same tab in which webpage “G” is opened in FIG. 5B; the content of webpage “H” is displayed in content area 5020, and the field 5016 includes the URL address of webpage “H” (e.g., “pagenameh.com”). In some embodiments, webpage “G” opened in blank tab 5014 in FIG. 5B is different from webpage “H” opened in the same tab in FIG. 5J. For example, the two webpages have different URLs and relate to different topics. In some embodiments, in response to detecting that webpage “H” is opened and/or loaded in tab 5014 and determining that the webpages of tabs 5002 and 5004 are related to webpage “H” of tab 5014, the device 100 automatically groups tabs 5002, 5004, and 5014 into one system-generated grouping.

FIGS. 5K-5O illustrate an example of animated rearrangement of tabs in the tab bar 5001 to organize related tabs 5002, 5004, and 5014 in one (e.g., a single) system-generated grouping. The animated rearrangement of tabs in the tab bar 5001 is triggered or is performed in response to opening the webpage “H” in the blank tab 5014, and determining that the tabs 5002, 5002, and 5014 meet grouping criteria. The rearrangement of the tab bar 5001 includes displaying the tabs 5002, 5002, and 5014 in one container tab representing the system-generated grouping, as described in further detail below.

FIG. 5K shows a transition from FIG. 5J. FIG. 5K shows an intermediate state during the process of rearranging the tabs in the tab bar 5001. In some embodiments, because the tab 5014 is currently active, the device 100 maintains location of the tab 5014 while moving the other related tabs, in this example tabs 5002 and 5004, to a location in the tab bar 5001 near or adjacent to the tab 5014. Initially, the device 100 shifts and compress other tabs in the tab bar 5001 to make room for the tabs 5002 and 5004 next to the currently active tab 5014. As illustrated in FIG. 5K, the tabs 5002, 5004, 5006, 5008, 5010, and 5012 are compressed and shifted in a leftward direction away from the active tab 5014, thereby opening a space in the tab bar 5001 adjacent to the tab 5014. In some embodiments, instead of compressing and shifting the tabs 5002 and 5004 that are about to be moved to different positions in the tab bar 5001 in order to join the other related tab 5014, the tabs 5002 and 5004 fade out from the tab bar 5001 and the other tabs 5006, 5008, 5010, and 5012 shift in the leftward direction, and are optionally compressed, to make room for moving the tabs 5002 and 5002 to a location next to the tab 5012; when the rearranging of the tabs is completed, tabs 5006 and 5008 are positioned in the space in the tab bar 5001 at the locations previously occupied by the tabs 5002 and 5004.

FIG. 5L is a transition from FIG. 5K. FIG. 5L shows a later stage of the process of rearranging the tab bar 5001 relative to the stage illustrated in FIG. 5K. In FIG. 5L, tabs 5002 and 5004 are faded out from their original positions in tab bar 5001, and tabs 5006, 5008, 5010, and 5012 are moved so that tabs 5006 and 5008 occupy the positions previously held by tabs 5002 and 5004. In some embodiments, tabs 5002 and 5004 move from their original positions to positions 5030 and 5028 in tab bar 5001, where device 100 created the space in the tab bar 5001 by shifting tabs 5006-5012. As illustrated in FIG. 5L, tabs 5002 and 5004 are in motion, moving towards positions 5030 and 5028 next to tab 5014. In some embodiments, the device 100 forgoes showing tabs 5002 and 5004 in motion (e.g., moving towards positions 5030 and 5028), and, instead, the animation includes fading out tabs 5002 and 5004 from their original positions and fading them back in at positions 5028 and 5030, next to the currently active tab 5014 (e.g., as illustrated in FIG. 5N below), without showing tabs 5002 and 5004 in motion.

FIG. 5M illustrates a transition from FIG. 5L. FIG. 5M shows a later stage of the process of rearranging the tab bar 5001 relative to the stage illustrated in FIG. 5L. For example, tabs 5002 and 5004 are closer to positions 5030 and 5028 next to tab 5014 compared to FIG. 5L. As explained above, the device 100 optionally shows the tabs 5002 and 5004 in motion, moving toward the positions 5030 and 5028. In some embodiments, instead of showing the tabs 5002 and 5004 in motion, the device 100 fades the tabs 5002 and 5004 back in the positions 5030 and 5028.

FIG. 5N shows a transition from FIG. 5M. FIG. 5N shows an intermediate stage of the process of rearranging the tab bar 5001, after the tabs 5002 and 5004 have been moved to and displayed in positions 5030 and 5028, adjacent to related tab 5014. In FIG. 5N, tabs 5002, 5004, and 5014 are grouped or clustered together by placing them next to one another in sequence, without any other tabs interrupting the sequence.

FIG. 5O shows a transition from FIG. 5N. FIG. 5O shows the final stage of the animated rearrangement of tabs in tab bar 5001. After placing related tabs 5002, 5004, and 5014 next to one another in sequence, device 100 merges them into one container tab representing the newly formed tab group 5032. In some embodiments, the device 100 visually emphasizes or highlights the newly formed tab group 5032, as illustrated in FIG. 5O. In some embodiments, after merging related tabs 5002, 5004, and 5014 into one container tab, the device 100 maintains the tab group 5032 in an expanded state, allowing individual tabs 5002, 5004, and 5014 to continue to be visible, as illustrated in FIG. 5O. In some embodiments, merging the tabs 5002, 5004, and 5014 into one container tab also provides a visual demarcation between tabs 5002, 5004, and 5014 that are included in tab group 5032 and tabs that are not part of the tab group 5032.

FIGS. 5P-5U show an example of animated rearrangement of tabs in the tab bar 5001 in accordance with a system-generated grouping, performed in response to opening a new tab, where the animated rearrangement of tabs includes collapsing one tab group and expanding another tab group, in accordance with some embodiments.

FIG. 5P shows a tab group 5034 in an expanded state, a tab group 5036 in a collapsed state, and two ungrouped tabs, a tab 5046 and a tab 5048, in the tab bar 5001 of the user interface 5000 of the browser application. In some embodiments, tab group 5036 is system-generated. In some embodiments, a container tab representing tab group 5036 includes a system-generated label, “Recipes.” The label "Recipes" represents a common topic to which the tabs in tab group 5036 are related. For example, webpages opened in the tabs in the tab group 5036 are related to recipes. Logos 5038 indicate logos of webpages of tabs that are included in the tab group 5036 (e.g., three logos indicate that there are three tabs that are included in the tab group 5036). In some embodiments, the two ungrouped tabs 5046 and 5048 are related but ungrouped because fewer than a predetermined threshold number (e.g., three, four, or other integer number) of tabs meet grouping criteria (e.g., are related to similar or the same topic). Tabs 5040, 5042, and 5044 include webpages related to hotel information and are grouped in one (e.g., a single) tab group 5034. Tab group 5034 is expanded because tab 5042 is active. The content area 5020 of the browser application user interface 5000 displays webpage "B" from tab 5042.

FIG. 5Q illustrates a transition from FIG. 5P in response to detecting a user input requesting to open a new tab. This request can be made via control 5052, a key command, or other inputs. The device 100 opens a new blank tab 5050, which becomes active. In some embodiments, since no webpage is loaded yet in tab 5050, a start page with suggested web pages is displayed in content area 5020. In some embodiments, the new tab 5050 appears after the last tab of the active tab group 5034 (e.g., instead of after a last tab in the tab bar 5001). In some embodiments, if a webpage related to the same topic as adjacent tabs 5040, 5042, and 5044 is opened in new tab 5050, the new tab 5050 maintains its original position and is merged (e.g., by device 100) with tabs 5040, 5042, and 5044 in tab group 5034. In some embodiments, based on (or taking into account) the content of the webpage loaded in the new tab 5050, the device 100 determines whether there are tabs in the tab bar 5001 that meet the grouping criteria.

FIGS. 5R-5U illustrate a scenario where the webpage in the new tab 5050 is unrelated to adjacent tabs in the active tab group 5034 but is related to non-adjacent tabs in the inactive tab group 5036, according to some embodiments.

FIG. 5R illustrates a transition from FIG. 5Q after a webpage that includes content related to a cookie’s recipe opens in tab 5050. In some embodiments, in accordance with a determination that tab 5050 meets grouping criteria with tabs in tab group 5036, the device 100 automatically rearranges tabs in tab bar 5001 to place tab 5050 next to the last tab in group 5036.

FIG. 5S illustrates a transition from FIG. 5Q. When a cookie’s recipe webpage loads in tab 5050 and meets grouping criteria with tabs in tab group 5036, device 100 rearranges the tab bar 5001 according to a system-generated grouping of tabs. FIG. 5S shows an example of an initial stage of the animated rearrangement of the tab bar 5001. The animated rearrangement includes fading tab 5050 and, optionally, fading its content in content area 5020, as illustrated in FIG. 5S. In some embodiments, the tab 5050 in the tab bar 5001 is faded out without fading its content in content area 5020. Further, the animation includes collapsing tab group 5034 (e.g., by reducing a size of the container tab that represents the tab group 5034 and ceasing (e.g., gradually ceasing) display of individual tabs 5040, 5042, and 5044). In some embodiments, a label, such as “Hotels,” is displayed for tab group 5034 (e.g., in the container tab representing the tab group 5034), reflecting a shared topic of webpage content of the tab group 5034’s tabs (e.g., related tabs 5040, 5042, and 5044 include content related to hotels).

FIG. 5T illustrates a transition from FIG. 5S. FIG. 5T shows an intermediate stage of the animated rearrangement of the tab bar 5001. For example, tab 5050 is completely faded out from tab bar 5001, and tab group 5036 is expanded, revealing individual tabs 5052, 5054, and 5056. Furthermore, tabs 5046 and 5048 have moved leftward to occupy the space previously held by tab 5050 (now faded out) and the container tab of tab group 5034 (now collapsed). Additionally, the revealed tabs 5052, 5054, and 5056 of tab group 5036 are also shifted leftward to make room for tab 5050 at position 5058 in the tab bar 5001, adjacent to the last tab in tab group 5036. At the stage of the animated rearrangement shown in FIG. 5T, tab 5050 is about to fade back into position 5058, next to the last tab in tab group 5036.

FIG. 5U shows a transition from FIG. 5T after tab 5050 fades back in at the position 5058, next to the last tab in tab group 5036 (e.g., tab 5056). After tab 5050 fades back in the tab bar 5001 at position 5058, next to the last tab in tab group 5036, the device 100 displays a visual indication of the grouping of tabs 5052, 5054, 5056 and 5050 in tab group 5036. In some embodiments, displaying the visual indication includes removing visual boundaries between tabs 5052, 5054, 5056 and 5050 and displaying tabs 5052, 5054, 5056 and 5050 as one container tab representing tab group 5036. In some embodiments, displaying the visual indication includes highlighting or otherwise visually emphasizing tab group 5036 after tabs 5052, 5054, 5056 and 5050 have morphed into one container tab, as illustrated in FIG. 5U. In some embodiments, tab 5050 continues to be the currently active tab. In some embodiments, tab group 5036 remains in an expanded state while at least one tab in tab group 5036 is currently selected (e.g., currently active).

FIGS. 5V-5W illustrate automatic rearrangement of tab bar 5001, according to a system-generated grouping, in response to switching focus from the new tab (e.g., tab 5050) to another tab in tab bar 5001 (e.g., tab 5046) after a webpage is loaded in the new tab (e.g., after loading the webpage that includes content related to cookie’s recipe in tab 5050, as illustrated in FIG. 5R). In contrast, in FIGS. 5R-5U, the automatic rearrangement of the tab bar 5001 is performed in response to loading a webpage in the new tab (e.g., switching to another tab is not a precondition for rearranging tabs in the tab bar 5001).

FIG. 5V illustrates a transition from FIG. 5R after the webpage that includes content related to cookie’s recipe is loaded in the new tab 5050 and before the tabs in tab bar 5001 are rearranged. In some embodiments, a system-generated grouping of tabs in the tab bar 5001 is determined when a webpage is loaded in a new or existing tab, but automatic rearrangement of the tab bar 5001 in accordance with the system-generated grouping is performed later, in response to switching focus from the currently active tab (e.g., where the webpage is loaded) to another tab. For example, device 100 determines that tab 5050 and tabs 5052, 5054, and 5056 meet grouping criteria when the webpage that includes content related to cookie’s recipe is loaded in the new tab 5050, but rearranging the tab bar 5001, such that tabs 5052, 5054, 5056, and tab 5050 are displayed in one grouping, is performed later, in response to switching focus from tab 5050 to another tab.

FIG. 5V illustrates a tap input 5059 selecting tab 5046 (e.g., an ungrouped tab). As illustrated in FIG. 5V, the tap input 5059 selecting tab 5046, which is outside (e.g., not included in) tab group 5034, is detected while tab group 5034 is in an expanded state and tab group 5036 is a collapsed state. In some embodiments, even though tab group 5034 is no longer active (e.g., because focus switched from tab 5042 to the new tab 5050), the tab group 5034 remains in expanded state until automatic rearrangement of the tab bar 5001 is triggered.

FIG. 5W illustrates a transition from FIG. 5V in response to detecting tap input 5059 selecting tab 5046. In response to detecting tap input 5059 selecting tab 5046, the device 100 switches focus from tab 5050 to tab 5046 (e.g., including displaying content of tab 5046 in the content area 5020, and initiates rearrangement of tab bar 5001 according to the system-generated grouping of tabs 5052, 5054, 5056, and tab 5050 into tab group 5036. As explained above, instead of automatically rearranging tabs in the tab bar 5001 in response to loading the webpage that includes content related to cookie’s recipe in the tab 5050, tabs in the tab bar 5001 are automatically rearranged in response to switching focus from tab 5050 to tab 5046.

FIG. 5W illustrates a state of the tab bar 5001 after rearrangement according to the system-generated grouping of tabs 5052, 5054, 5056, and tab 5050 into tab group 5036. In some embodiments, the rearrangement of the tab bar 5001 is animated and includes one or more of: fading out tab 5050, collapsing tab group 5034 (previously in an expanded state before it is collapsed), expanding tab group 5036 (previously in a collapsed state before it is expanded) to include tab 5050, and fading tab 5050 back into the tab bar 5001 at a position next to tabs of tab group 5036 (e.g., after a last tab in the expanded cluster of tabs). In some embodiments, the animated rearrangement includes highlighting or visually emphasizing tab group 5036 after tabs 5052, 5054, 5056, and tab 5050 have morphed into one container tab representing tab group 5036, and collapsing tab group 5036 (e.g., because tab 5046, which is not included in tab group 5036, is selected to be the currently active tab). In some embodiments, ungrouped tabs, such as tabs 5046 and 5048, are positioned consecutively within the tab bar 5001 or are clustered together in response to rearranging tabs in the tab bar 5001.

In some embodiments, in response to detecting a tab-usage event (e.g., opening a webpage in a blank tab, loading a new webpage in an existing tab, opening a new tab, activating a link, and/or other tab-usage events) and determining that tab grouping criteria are met, the device 100 automatically generates and displays a tab grouping affordance that, when selected, causes rearrangement of tabs in accordance with a system-generated grouping of tabs, as described in further detail below with reference to FIGS. 5X-5AA.

FIG. 5X shows the tab bar 5001 of the browser's user interface 5000. In this example, the tab bar 5001 includes ungrouped tabs 5060, 5062, 5064, 5066, 5068, and 5072, without a tab group. In some embodiments, the tab grouping criteria include a minimum threshold requirement that more than a predetermined number of tabs (e.g., two, three, four, five, etc.) be related for the tabs to be grouped. In some embodiments, even though tabs 5064, 5066, and 5066 relate to a same topic (e.g., include webpages with content related to bars), tabs 5064, 5066, and 5066 do not meet the grouping criteria because the minimum threshold requirement is not satisfied.

FIG. 5Y shows a transition from FIG. 5X after a new tab 5070 is opened and a webpage with content related to “Bar D” is loaded in the new tab 5070. In some embodiments, in response to opening that webpage with content related to “Bar D” in new tab 5070, the device 100 determines that the tabs 5064, 5066, 5066 and the new tab 5070 meet the grouping criteria (e.g., because the tabs 5064, 5066, 5066, and tab 5070 relate to the same topic and meet the minimum threshold requirement). In response to determining that these tabs (e.g., the tabs 5064, 5066, 5066 and the new tab 5070) meet the grouping criteria, the device 100 automatically displays grouping affordance 5075. In some embodiments, a grouping affordance is displayed in the currently active tab. For example, grouping affordance 5075 is displayed in the new tab 5070 because the new tab 5070 is currently in focus (e.g., as illustrated in FIG. 5Y, content of the webpage related to “Bar D is displayed in content area 5020). In some embodiments, a grouping affordance includes a count of a total number of tabs included in the system-detected grouping. For example, grouping affordance 5075 includes a count of four related tabs in the system-detected grouping. A grouping affordance, such as grouping affordance 5075, serves a dual purpose. First, it provides a visual indication of a system-detected (or system-generated) grouping in one or more system-generated tab groups in the tab bar 5001. Second, grouping affordance 5075, when selected, causes the device 100 to rearrange tabs in the tab bar 5001 in accordance with the system-generated grouping, as illustrated in FIGS. 5Z-5AB. FIG. 5Y shows a tap input 5077 selecting the grouping affordance 5075.

FIG. 5Z illustrates a transition from FIG. 5Y in response to detecting tap input 5077, which selects the grouping affordance 5075. In response to detecting tap input 5077 selecting the grouping affordance 5075, the device 100 initiates an animated rearrangement of tabs in the tab bar 5001 according to the system-generated grouping. FIG. 5Z shows an initial stage of this animated rearrangement, where tab 5072 (not grouped) has faded out from the tab bar 5001, to be faded back in at a position adjacent to other ungrouped tabs 5060 and 5062. In some embodiments, the appearance of the grouping affordance 5075 in FIG. 5Z is modified compared to its appearance in FIG. 5Y to indicate that it is selected.

FIG. 5AA illustrates a transition from FIG. 5Z. FIG. 5AA shows an intermediate stage of the animated rearrangement after the four grouped tabs 5064, 5066, 5068, and 5070 have shifted rightward, occupying the space previously held by tab 5072 (now faded out), to make room for tab 5072 at the position adjacent to other ungrouped tabs 5060 and 5062. The new position in tab bar 5001 for tab 5072 is illustrated with a dashed outline.

FIG. 5AB illustrates a transition from FIG. 5AA. FIG. 5AB shows the final stage of the animated rearrangement after tab 5072 has faded back in at the position adjacent to other ungrouped tabs 5060 and 5062. Additionally, the device 100 displays a visual indication of a tab group 5078, including tabs 5064, 5066, 5068, and 5070. The visual indication of the tab group 5078 is optionally displayed after the tabs in the tab bar 5001 are rearranged according to the system-generated grouping. As illustrated, tabs 5064, 5066, 5068, and 5070 have morphed into one container tab representing tab group 5078, where the container tab is highlighted and/or visually emphasized.

FIG. 5AC illustrates a transition from FIG. 5X after the new tab 5070 is opened and the webpage with content related to “Bar D” is loaded in the new tab 5070 (similar to FIG. 5Y). FIG. 5AC illustrates the same state of tab bar 5001 as in FIG. 5Y (which also shows a transition from FIG. 5X under the same conditions), except that instead of displaying grouping affordance 5075, the device 100 displays tab grouping menu affordance 5079. In some embodiments, tab grouping menu affordance 5079 is displayed in response to detecting that tabs in the tab bar 5001 meet the grouping criteria (e.g., the same conditions under which the device 100 displays grouping affordance 5075). Like grouping affordance 5075, tab grouping menu affordance 5079 serves a dual purpose. For example, tab grouping menu 5079 provides a visual indication of a system-detected (or system-generated) grouping of tabs in one or more system-generated tab groups in the tab bar 5001. Additionally, tab grouping menu affordance 5079, when selected, causes the device 100 to display a suggested grouping of related tabs and a menu option for grouping the related tabs according to the suggested grouping. FIG. 5AC shows a tap input 5081 selecting tab grouping menu affordance 5079.

FIG. 5AD illustrates a transition from FIG. 5AC in response to detecting tap input 5081 selecting tab grouping menu affordance 5079. In some embodiments, instead of initiating animated rearrangement of the tabs, as described above with reference to FIGS. 5Y-5AB, the device displays a suggested grouping of related tabs. For example, in response to detecting tap input 5081 selecting tab grouping menu affordance 5079, the device 100 displays a suggested grouping of related tabs 5064, 5066, 5068, and 5070, and a menu option 5082. When selected, menu option 5082 causes the device 100 to rearrange the tab bar 5001 and display related tabs 5064, 5066, 5068, and 5070 in a tab group, as described above with reference to FIG. 5AB. For example, FIG. 5AE shows a transition from FIG. 5AD in response to detecting tap input 5085 selecting menu option 5082. FIG. 5AE shows the same state of the tab bar as in FIG. 5AB after the tabs in the tab bar 5001 are rearranged according to the suggested grouping.

In some embodiments, if a first browsing mode is active (e.g., active browsing mode or prompt rearrangement mode), the device 100 promptly rearranges the tabs according to the system-generating grouping in response to detecting the occurrence of the tab-usage event, without delay. Prompt rearrangement of tabs, performed in response to detecting the occurrence of the tab-usage event, is illustrated in FIGS. 5J-5O and 5Q-5U. In some other embodiments, the computer system determines the system-generated grouping in response to detecting the occurrence of the tab-usage event, but the tabs are rearranged according to the system-generating grouping later. For example, if a second browsing mode is active (e.g., delayed rearrangement mode), the device 100 automatically rearranges the tabs in the tab bar according to the system-generating grouping in response to detecting a browser event and in accordance with a determination that the tabs in the tab bar have been idle for a threshold amount of time. In some embodiments, a browser event includes reopening a browser application window after the browser application has been running in the background without being interacted with for a threshold amount of time. In some embodiments, a browser event includes viewing a browser application window after the device 100 exits a sleep mode. In some embodiments, whether the device 100 operates in the first browsing mode or the second browsing mode, can be configured by a user by selecting a setting in a menu, as described below with reference to FIGS. 5AF-5AG.

FIGS. 5AF illustrates a tap input 5091 selecting a tab overview button 5092 in user interface 5000 in the browser application. In response to detecting tap input 5091 selecting tab overview button 5092, the device 100 displays an overview of tabs (e.g., ungrouped) and tabs groups in content area 5020 of user interface 5000, as illustrated in FIG. 5AG. For example, the device 100 displays tab groups 5104, 5106, and 5112, and ungrouped tabs 5102, 5108, and 5110. In some embodiments, tab groups 5104, 5106, and 5112 include a stack of thumbnail images representing tabs in respective tabs groups 5104, 5106, and 5112. In some embodiments, menu 5120 for tab configuration is displayed in response to tap input 5091 selecting tab overview button 5092. In some embodiments, menu 5120 for tab configuration is displayed in response to a different input (e.g., an input selecting a different control). In some embodiments, menu 5120 includes a menu option 5120a that, when selected, displays a sub-menu for browsing mode configuration. For example, in response to input 5122 selecting menu option 5120a, the device 100 displays sub-menu 5024 for browsing mode configuration. In some embodiments, sub-menu 5024 for browsing mode configuration includes menu option 5126, menu option 5128, and menu option 5130. In some embodiments, menu option 5126, when selected, activates the first browsing mode (e.g., the active browsing mode or prompt rearrangement mode), where the device 100 promptly (e.g., without delay) rearranges the tabs according to the system-generating grouping in response to detecting the occurrence of the tab-usage event. In some embodiments, menu option 5128, when selected, activates the second browsing mode (e.g., delayed rearrangement mode), where the device 100 rearranges the tabs according to the system-generating grouping with delay, in response to detecting a browser event and in accordance with a determination that the tabs in the tab bar have been idle for a threshold amount of time. In some embodiments, menu option 5130, when selected, disables automatic tab organization.

FIG. 6 is a flow diagram illustrating a method 6000 for automatically grouping and rearranging tabs in a browser application, in accordance with some embodiments. Method 6000 is performed at a computer system (e.g., device 300, FIG. 3, or portable multifunction device 100, FIG. 1A) that is in communication with a display generation component, and one or more input devices. In some embodiments, the display generation component is a touch-screen display and a touch-sensitive surface is on or integrated with the display generation component. In some embodiments, the display is separate from the touch-sensitive surface. Some operations in method 6000 are, optionally, combined and/or the order of some operations is, optionally, changed.

As described herein, method 6000 automatically organizes tabs in a tab bar in response to detecting a tab-usage event. Some conventional methods require a sequence of inputs navigating menus or other controls to switch from one tab group to another. Searching for the correct menu option or control can be tedious and time consuming. Additionally, the menus and/or controls clutter the browser application’s user interface. In response to detecting a tab-usage event (e.g., opening a new tab, loading a webpage into an existing tab, loading a webpage into a blank tab, activating a link that causes the device to open a webpage, etc.), and in accordance with a determination that grouping-criteria are met, the computer system automatically displays an indication of a system-generated (e.g., system-detected) grouping of tabs, in one or more system-generated tab groups, of a subset of tabs in the tab bar. In some embodiments, displaying the indication of the system-generated grouping includes displaying a visual demarcation of tabs in a system-generated group relative to other tabs in the tab bar that are not grouped, or relative to other group of tabs. In some embodiments, displaying the indication of the system-generated grouping includes visually highlighting related tabs. In some embodiments, displaying the indication of the system-generated grouping includes grouping related tabs in one container tab. In some embodiments, displaying the indication of the system-generated grouping includes, in response to detecting the tab-usage event, displaying a control in the browser application user interface. The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Reducing the number of inputs needed to perform an operation (such as by automatically rearranging tabs in the tab bar in accordance with a system-generated grouping in response to detecting a tab-usage event) enhances the operability of the device by reducing the number of inputs and time required to perform a particular operation, reducing energy usage by the device. Further, animating the automatic rearrangement of tabs in the tab bar assists the user in managing and organizing tabs in the tab bar by providing continued guidance of location, movement, and/or grouping(s) of tabs in the tab bar. Providing improved feedback (such as by displaying the indication of the system-generated grouping) enhances the operability of the device by reducing accidental and mistaken inputs, reducing energy usage by the device. Performing an operation when a set of conditions has been met without requiring further user input (such as by automatically displaying an indication of a system-generated grouping in accordance with a determination that grouping criteria are met, and/or by automatically rearranging tabs in the tab bar into tab groups in accordance with the system-generated grouping) enhances the operability of the device by reducing unnecessary inputs and/or steps to navigate through different user interfaces or sets of controls, reducing energy usage by the device. Automatically rearranging tabs in the tab bar in accordance with the system-generated grouping in response to detecting a tab-usage event makes the user-device interaction more efficient without cluttering the user interface of the browser application with additional controls.

In some embodiments, method 6000 is performed at a computer system (e.g., device 300, FIG. 3, or portable multifunction device 100, FIG. 1A) that is in communication with a display generation component (e.g., touch screen 112 or display 450) and one or more input devices (e.g., touch screen 112 or touch-sensitive surface 451). The computer system displays (6002), via the display generation component, a browser application user interface that includes a tab bar (e.g., a platter with tabs) with a plurality of tabs. The plurality of tabs are displayed in a first arrangement (e.g., in a first order, sequence, and/or grouping). The computer system detects (6004) an occurrence of a tab-usage event associated with the plurality of tabs (e.g., opening a new tab, loading a webpage in an existing tab or a blank tab, closing an open tab, changing a webpage associated with an existing tab; and/or modifying the plurality of tabs). At 6006, in response to detecting the occurrence of the tab-usage event associated with the plurality of tabs, and in accordance with a determination that grouping criteria are met, the computer system automatically displays (6008), via the display generation component, an indication of a system-generated grouping, in one or more system-generated tab groups, of a subset of the plurality of tabs. In some embodiments, the computer system automatically groups tabs based on various characteristics of the plurality of tabs, including topics associated with corresponding webpages of the plurality of tabs, domains of the webpages, sources of the webpages, topics of user-defined groups, topics of system-generated groups, and/or other information about the plurality of tabs and/or tab groups in the tab bar. In some embodiments, the tab-usage event does not include explicit user commands to organize tabs into tab groups. In some embodiments, displaying the indication of the system-generated grouping includes displaying a visual demarcation of tabs in a system-generated group relative to other tabs in the tab bar that are not grouped, or relative to other group of tabs. In some embodiments, displaying the indication of the system-generated grouping includes visually highlighting related tabs. In some embodiments, displaying the indication of the system-generated grouping includes grouping related tabs in one container tab. In some embodiments, displaying the indication of the system-generated grouping includes in response to detecting the tab-usage event, displaying a control in the browser application user interface. In some embodiments, ungrouped tabs in the tab bar are split from tabs in the one or more system-generated tab groups or tabs in manually generated groups (e.g., where, optionally, tab groups are displayed in expanded and/or collapsed state), and tabs in a system-generated group are split from tabs in other groups (e.g., system-generated or manually created).

In some embodiments, the tab-usage event includes editing one or more of the plurality of tabs in the tab bar. In some embodiments, the tab-usage event includes closing an existing tab, loading a new page in an existing tab, repositioning an existing tab (e.g., dragging a tab out of a group of tabs, thereby removing the tab from the group of tabs, and/or dropping a tab into a group of tabs, thereby adding the tab into the group of tabs), but excludes selecting a tab operation from a menu of available tab operations. For example, as described with reference to FIGS. 5A-5C, in response to loading a webpage in the blank tab 5014, and in accordance with a determination that the tab 5014 and tabs 5010 and 5012 meet the grouping-criteria, the device 100 groups tabs 5010, 5012, and 5014 into one system-generated tab group 5022, and displays visual indication of the system generated tab group 5022.

In some embodiments, the tab-usage event excludes selecting a tab operation from a menu of available tab operations. For example, the tab-usage does not include explicit user commands to organize tabs into tab groups. For example, as described with reference to FIGS. 5A-5AE, a visual indication of a system-detected grouping of tabs is displayed automatically in response to a tab-usage event, as opposed to a user command requesting that the device 100 determines whether tabs in the tab bar 5001 meet grouping criteria.

In some embodiments, the tab-usage event includes opening a new tab in the tab bar. In some embodiments, opening the new tab includes loading a webpage in a tab that, prior to loading the webpage, was not associated with a webpage (e.g., a tab associated with a blank page). In some embodiments, opening the new tab includes loading a new webpage in a tab that was previously associated with another webpage (e.g., a webpage different from the new webpage). In some embodiments, the computer system opens a new tab with content from a respective webpage, in response to detecting a user input activating a link associated with the respective webpage. For example, as described with reference to FIGS. 5A-5C, in response to loading a webpage in the blank tab 5014, and in accordance with a determination that the tab 5014 and tabs 5010 and 5012 meet the grouping-criteria, the device 100 groups tabs 5010, 5012, and 5014 into one system-generated tab group 5022, and displays visual indication of the system generated tab group 5022. In another example, as described with reference to FIGS. 5J-5O, in response to loading a webpage in the blank tab 5014, and in accordance with a determination that the tab 5014 and tabs 5002 and 5004 meet the grouping-criteria, the device 100 groups tabs 5002, 5004, and 5014 into one system-generated tab group 5032, and displays visual indication of the system generated tab group 5032.

In some embodiments, the computer system displays, in the browser application user interface, content of a first respective webpage that corresponds to a tab that is in focus (e.g., an active tab or a currently active tab). In some embodiments, the tab-usage event includes activating a link in the first respective webpage corresponding to the tab that is in focus (e.g., a hyperlink included in the content of the first respective webpage), where the link is associated with (e.g., is a hyperlink to) a second respective webpage. In some embodiments, in response to activating the link in the first respective webpage corresponding to the tab that is in focus, the computer system displays, via the display generation component, content of the second respective webpage in the browser application user interface, wherein, after the link in the first respective webpage is activated, the second respective webpage corresponds to the tab that is in focus. For example, instead of loading a webpage with content related to cookie’s recipe in the blank tab 5050 in response to a user input entering a search query and/or a web address in field 5016, as described with reference to FIGS. 5Q-5R, the device 100 can load the webpage with content related to cookie’s recipe in response to a user input selecting a link in content of tab 5046 that is displayed in content area 5020.

In some embodiments, the tab-usage event includes closing a tab of the plurality of tabs (e.g., optionally, in response to a user input closing the tab). For example, if one of the tabs 5040, 5042, or 5044 in FIG. 5P is closed, the device 100 automatically updates the system-generated grouping of tabs in tab bar 5001 by dissolving tab group 5034. In some embodiments, dissolving tab group 5034 occurs because the remaining tabs in tab group 5034 do not meet the minimum threshold requirement, which requires that a minimum number of related tabs must be present for the grouping criteria to be satisfied.

In some embodiments, in response to detecting the occurrence of the tab-usage event associated with the plurality of tabs, and in accordance with a determination that the grouping criteria are met, the computer system automatically displays, via the display generation component, the plurality of tabs in a second arrangement, wherein, in the second arrangement, tabs in a respective system-generated group are grouped together (e.g., tabs in the respective system generated are positioned consecutively within the tab bar or otherwise clustered together). For example, as described with reference to FIGS. 5R-5U and 5J-5O, the automatic rearrangement of the tab bar 5001 is performed in response to loading a webpage in a tab (e.g., without other preconditions for triggering rearrangement of the tab bar 5001). In some embodiments, tabs in a respective system-generated group are grouped together when they are placed next to each other in a sequence without any other tabs interrupting the order. In some embodiments, tabs in a respective system-generated group are grouped in one cluster, such that the tabs in the respective system-generated group are represented by a container tab that. In some embodiments, the container tab can be displayed in an expanded or collapsed state. In some embodiments, the container tab, when in a collapsed state, is labeled with a system-generated category or system-generated topic. In some embodiments, displaying the visual indication of the system generating grouping includes automatically rearranging the tabs according to the system-generating grouping. In some embodiments, automatically rearranging the tabs according to the system-generating grouping is performed in response to detecting the occurrence of the tab-usage event (e.g., opening a new tab, opening a new webpage in an existing tab, closing an existing tab, editing the tabs in the tab bar, and/or switching from one tab to another). In some embodiments, if a first mode is active (e.g., active browsing mode or prompt rearrangement mode), the computer system automatically rearranges the tabs according to the system-generating grouping in response to detecting the occurrence of the tab-usage event. In some embodiments, the computer system determines the system-generated grouping in response to detecting the occurrence of the tab-usage event, but the tabs are rearranged according to the system-generating grouping at a later time. For example, if a second mode is active (e.g., a delayed rearrangement mode), the computer system automatically rearranges the tabs in the tab bar according to the system-generating grouping in accordance with a determination that the tabs in the tab bar have been idle for a threshold amount of time. In another example, if a third mode is active, the computer system automatically rearranges the tabs in the tab bar in response to an explicit user command to organize the tabs according to the (e.g., previously generated) system-generating grouping.

In some embodiments, automatically displaying the plurality of tabs in the second arrangement includes animating rearrangement of the plurality of tabs from the first arrangement to the second arrangement. For example, as described with reference to FIGS. 5J-5O, rearrangement of the tabs is animated. In some embodiments, animating the rearrangement of the plurality of tabs in the tab bar includes fading out a subset of tabs in the tab bar that are related to a currently active tab, shifting other tabs in the tab bar to make room for the subset of tabs next to the currently active tab, and fading back in the subset tabs next to a currently active tab, such that the currently active tab and the subset of tabs are clustered together, and, optionally, the computer system displays a visual indication of the new cluster (e.g., as described with refence to FIGS. 5J-5O). In some embodiments, moving the subset of tabs is animated, where the subset of tabs fly off from original positions in the tab bar to position(s) in the tab bar that opened in response to shifting the other tabs in the tab bar (e.g., as described with reference to FIGS. 5J-5O). In some embodiments, animating the rearrangement of the plurality of tabs in the tab bar includes one or more of: fading out a currently active tab (e.g., a new tab), collapsing an expanded cluster of tabs, expanding a collapsed cluster of tabs that include tabs related to the currently active tab, and fading the currently active tab back in next to the expanded cluster of tabs (e.g., after a last tab in the expanded cluster of tabs), where, optionally, the currently active tab is in focus after the rearrangement, and web content associated with the currently active tab is displayed in the browser application user interface (e.g., as described with reference to FIGS. 5Q-5U).

In some embodiments, in the second arrangement, tabs that are not included in a system-generated group are grouped together in the tab bar. For example, ungrouped tabs are displayed in a sequence without tab groups or grouped tabs interrupting the sequence. In some embodiments, ungrouped tabs are positioned consecutively within the tab bar or are clustered together in response to rearranging the tabs in the tab bar in the second arrangement. For example, a subset of tabs that corresponds to ungrouped tabs are positioned consecutively within the tab bar, where no other clusters or grouped tabs are displayed or positioned between tabs in the subset of tabs that corresponds to the ungrouped tabs). For example, as described with reference to FIG. 5W, ungrouped tabs 5046 and 5048 are positioned consecutively within the tab bar 5001. Similarly, ungrouped tabs 5006, 5008, 5010, and 5012 are positioned consecutively within the tab bar 5001 after rearrangement, as described with reference to FIGS. 5J-5O.

In some embodiments, in response to detecting that the subset of the plurality tabs have been inactive for a threshold amount of time after displaying the indication of the system-generated grouping, the computer system automatically displays, via the display generation component, the plurality of tabs in a second arrangement, wherein, in the second arrangement, tabs in a respective system-generated group are grouped together. In some embodiments, while computer system determines the system-generated grouping in response to detecting the occurrence of the tab-usage event, the tabs in the tab bar are rearranged according to the system-generating grouping later. In some embodiments, the computer system automatically rearranges the tabs in the tab bar according to the system-generating grouping in accordance with a determination that the tabs in the tab bar have been idle or inactive for a threshold amount of time. In some embodiments, instead of rearranging the tabs in the tab bar while a user is actively browsing, the computer system rearranges the tabs in the tab bar after a period of inactivity (e.g., optionally, in the background). For example, tabs are automatically rearranged in response to detecting that a user has not interacted with the browser application user interface for a threshold amount of time, in response to detecting that a tab-usage event has not occurred for the threshold amount of time, and/or that the tabs in the tab bar have been idle or inactive for the threshold amount of time.

In some embodiments, in accordance with a determination that a first mode is active at a time the occurrence of the tab-usage event is detected, the computer system automatically displays, via the display generation component, the plurality of tabs in a second arrangement in response to detecting the occurrence of the tab-usage event, wherein, in the second arrangement, tabs in a respective system-generated group are grouped together. In accordance with a determination that at least the subset of the plurality tabs have been inactive for a threshold amount of time after the tab-usage event while the second mode is active, in response to a predetermined browser event, the computer system automatically displays, via the display generation component, the plurality of tabs in the second arrangement. In some embodiments, if a first mode is active (e.g., automatic rearrangement mode), the computer system automatically rearranges the tabs according to the system-generating grouping in response to detecting the occurrence of the tab-usage event. For example, as described with reference to FIG. 5AG, menu option 5126, when selected, activates the first browsing mode (e.g., the active browsing mode or prompt rearrangement mode), where the device 100 promptly (e.g., without delay) rearranges the tabs according to the system-generating grouping in response to detecting the occurrence of the tab-usage event. In some embodiments, when the first mode is active, rearrangement of the plurality of tabs in the second arrangement is animated.

In some other embodiments, the computer system determines the system-generated grouping in response to detecting the occurrence of the tab-usage event, but the tabs are rearranged according to the system-generating grouping at a later time. For example, if a second mode is active (e.g., delayed rearrangement mode), the computer system automatically rearranges the tabs in the tab bar, in response to a triggering event (e.g., a browser event, such as closing a tab, switching focus from one tab to another, clicking on a link, or anything else that causes refreshing of the browser UI, etc.), according to the system-generating grouping in accordance with a determination that the tabs in the tab bar have been idle for a threshold amount of time. For example, the plurality of tabs in the tab bar are displayed in the second arrangement when the browser application user interface is opened or redisplayed after a period of inactivity (e.g., the browser application user interface has been minimized or otherwise not used for the threshold amount of time). For example, as described with reference to FIG. 5AG, menu option 5128, when selected, activates the second browsing mode is active (e.g., delayed rearrangement mode), where the device 100 rearranges the tabs according to the system-generating grouping with delay, in response to detecting a browser event and in accordance with a determination that the tabs in the tab bar have been idle for a threshold amount of time.

In some embodiments, the tab-usage event includes changing input focus from a first tab (e.g., a currently active tab) to a second tab (e.g., a previously inactive tab) of the plurality of tabs. For example, as described with reference to FIGS. 5V-5W, the device 100 automatically rearranges the tabs in the tab bar 5001 in response to detecting tap input 5059 selecting tab 5046 and switching focus from tab 5050 to tab 5046. In some embodiments, the computer system displays, via the display generation component, the plurality of tabs in a second arrangement, wherein, in the second arrangement, tabs in a respective system-generated group are grouped together. In some embodiments, instead of rearranging tabs according to the system-generated grouping as soon as a web page loads in a first tab that is active, the plurality of tabs are rearranged in the second arrangement in response to detecting that the input focus is changed to second tab (e.g., the second tab becomes the currently active tab when selected).

In some embodiments, displaying the indication of the system-generated grouping includes displaying a control in the browser application user interface. In some embodiments, the control is displayed within a currently active tab of the plurality of tabs in the tab bar. In some embodiments, the control is displayed elsewhere in the tab bar or outside the tab bar in the browser application user interface. In some embodiments, appearance and/or associated function of the control changes based on whether the first mode (e.g., automatic rearrangement mode) or the second mode (e.g., delayed rearrangement mode) is active. In some embodiments, the control includes an indication of a count of a total number of tabs included in the system-generated grouping. For example, as described with reference to FIG. 5Y, in response to determining that the tabs 5064, 5066, 5066 and the new tab 5070 meet the grouping criteria, the device 100 automatically displays grouping affordance 5075, which provides a visual indication of a system-detected (or system-generated) grouping of tabs. In another example, as described with reference to FIG. 5AC, in response to determining that the tabs 5064, 5066, 5066 and the new tab 5070 meet the grouping criteria, the device 100 automatically displays tab grouping menu affordance 5079, which provides a visual indication of a system-detected (or system-generated) grouping of tabs.

In some embodiments, the computer system detects a user input selecting the control. In response to the user input selecting the control, the computer system displays, via the display generation component, the plurality of tabs in a respective arrangement different from the first arrangement, wherein, in the respective arrangement, tabs in a respective system-generated group are grouped together. For example, as described with reference to FIGS. 5Y-5AB, in response to detecting tap input 5077 selecting grouping affordance 5075, the device 100 rearranges of tabs in the tab bar 5001 according to the system-generated grouping, as shown in FIG. 5AB.

In some embodiments, the computer system detects a user input selecting the control. In response to the user input selecting the control, the computer system displays, via the display generation component, a suggested system-generated grouping of the subset of the plurality of tabs without rearranging the plurality of tabs. In some embodiments, in response to a subsequent user input that corresponds to an explicit command to organize the plurality of tabs according to the suggested system-generated grouping, the computer system automatically rearranges the plurality of tabs according to the suggested system-generated grouping. For example, as described with reference to FIG. 5AC, in response to detecting tap input 5081 selecting tab grouping menu affordance 5079, the device 100 displays (e.g., as shown in FIG. 5AD) a suggested grouping of related tabs 5064, 5066, 5068, and 5070, and menu option 5082 for grouping the related tabs according to the suggested grouping.

In some embodiments, while a first tab of a first tab group (e.g., the first tab group is system-generated or user-generated group) is active, wherein the first tab group includes a first subset of related tabs displayed next to one another in the tab bar in a sequence, the computer system detects a user input requesting to open a new tab. In response to the user input requesting to open a new tab, the computer system displays a new tab at a first location in the tab bar, wherein the new tab is placed after a last tab in the sequence. For example, as described with reference to FIG. 5Q, in response to the user input requesting to open the new tab, the device 100 displays the new tab 5050 after a last tab of the active group of tabs 5034. In some embodiments, when a tab in a cluster of tabs (e.g., corresponding to a system-generated or user-generated tab group) is active, the cluster of tabs is in an expanded state, where individual tabs in the cluster are displayed. In some embodiments, when no tab in a cluster of tabs (e.g., corresponding to a system-generated or user-generated tab group) is active, the cluster of tabs is displayed in a collapsed state, where individual tabs in the cluster are not displayed (e.g., instead, a container tab representing the cluster of tabs is displayed). In some embodiments, the new tab, when opened, automatically becomes the active tab. In some embodiments, the new tab becomes the active tab when selected.

In some embodiments, after displaying the new tab in the first location in the tab bar, and in accordance with a determination that the new tab is related to a second subset of related tabs included in a second tab group different from the first tab group, the computer system automatically displays the new tab at a second location in the tab bar different from the first location, wherein the new tab is placed after a last tab in a sequence of the second subset of related tabs. In some embodiments, if the second tab group is in a collapsed state (e.g., represented by a container tab) when the user input requesting to open a new tab is detected, displaying the new tab in the second location includes displaying the second tab group in an expanded state (e.g., revealing individual tabs in the second subset of related tabs), where the second subset of related tabs are displayed in a sequence and the new tab is placed at the end of that sequence. For example, as described with reference to FIGS. 5R-5U, in accordance with a determination that the new tab 5050 is unrelated to adjacent tabs in the active tab group 5034 and that the new tab 5050 is related to non-adjacent tabs in the inactive tab group 5036, the device 100, device 100 rearranges the tab bar 5001 according to a system-generated grouping of tabs, such that the new tab 5050 is moved at position 5058 in the tab bar 5001, adjacent to the last tab in tab group 5036.

In some embodiments, after displaying the new tab at the first location in the tab bar, and in accordance with a determination that the new tab is related to the first subset of related tabs included in the first tab group, the computer system maintains display of the new tab at the first location and also displays a visual indication of a system-generated grouping of the first subset of related tabs and the new tab. For example, as described with reference to FIG. 5Q, if the webpage in the new tab 5050 relates to the same topic as adjacent tabs 5040, 5042, and 5044, the new tab 5050 maintains its original position and it merges with tabs 5040, 5042, and 5044 in tab group 5034.

In some embodiments, while a first tab group that includes a first subset of tabs is displayed in an expanded state, where, in the expanded state, the tabs in the first subset of tabs are concurrently displayed (e.g., in the expanded state, individual tabs in the first tab group are concurrently displayed), the computer system detects a user input directed to a location in the tab bar outside the first subset of tabs (e.g., directed toward a tab in a second tab group and/or directed toward a container tab representing a second tab group that is in a collapsed state). In response to detecting the user input directed to the location in the tab bar outside the first subset of tabs, the computer system collapses the first subset of tabs, including ceasing display of the first subset of tabs and displaying a first container tab representing the first tab group. For example, as described with reference to FIGS. 5D-5E, in response to switching focus from the tab 5014, which is included in the active tab group 5022, to the tab 5004, which is not included in the active tab group 5022, the tab group 5022 becomes inactive (e.g., because there is no active tab in the group) and device 100 (automatically) displays the tab group 5022 in a collapsed state. In some embodiments, when a tab group is active (e.g., when a tab in the tab group has input focus and/or is currently active), the tab group is displayed in an expanded state. In some embodiments, in the expanded state, tabs in a tab group are placed next to each other in a sequence without any other tabs interrupting the sequence and, optionally, the tabs in the tab group are concurrently displayed in one container tab, thereby separating tabs in the tab group from other tabs in the tab bar. In some embodiments, when a tab group is inactive (e.g., a tab outside the tab group has input focus and/or is currently active), the tab group is in a collapsed state. In some embodiments, in the collapsed state, tabs in the tab group are represented by a container tab, such that individual tabs in the tab group are not displayed.

In some embodiments, collapsing the first subset of tabs is animated. For example, in FIGS. 5D-5E, collapsing tab group 5022 can be animated. In some embodiments, animating the collapse of the first subset of tabs includes morphing the first subset of tabs into the first container tab. Morphing the first subset of tabs into the first container tab includes gradually reducing the size of tabs in the first subset of tabs and eventually merging the first subset of tabs into one container tab (e.g., after the size of tabs in the first subset of tabs is reduced below a respective threshold size), where merging the first subset of tabs into one container tab includes ceasing display of individual labels of tabs in the first subset of tabs and/or removing visual demarcation of tabs in the first subset of tabs.

In some embodiments, displaying the first container tab includes displaying a system-generated label in the first container tab, wherein the system-generated label is generated using a language model. In some embodiments, the system-generated label represents a topic associated with the first subset of tabs in the first tab group. For example, as described with reference to FIGS. 5D-5E, in conjunction with collapsing the tab group 5022, the device 100 automatically generates and displays a label 5022a that represents a system-generated name or topic of the tab group 5022.

In some embodiments, while displaying a second container tab representing a second tab group that includes a second subset of tabs, and the second subset of tabs are not displayed, the computer system detects a user input directed toward the container tab. In response to detecting the user input directed toward the second container tab, the computer system expands the second container tab, including ceasing to display the second container tab and concurrently displaying the tabs of the second subset of tabs. For example, as described with reference to FIGS. 5F-5I, in response to detecting the tap input 5029 selecting the group 5022, the device 100 expands the tab group 5022 to reveal tabs included in the tab group 5022. In some embodiments, the expansion of the tab group 5002 is animated, as illustrated in FIGS. 5G-5I.

In some embodiments, expanding the second container tab representing the second tab group is animated. For example, as described with reference to FIGS. 5G-5I, the expansion of the tab group 5022 is animated. In some embodiments, animating the expansion of the second container tab representing the second tab group includes morphing the second container tab into the second subset of tabs. Morphing the second container tab into the second subset of tabs includes gradually increasing the size of the container tab and eventually splitting the container tab into the second subset of tabs, where the second subset of tabs are displayed in place of the second container tab (e.g., after the size of the second container tab is increased above a respective threshold size). Splitting the second container tab into the second subset of tabs includes ceasing display of the second container tab and concurrently displaying individual labels of tabs in the second subset of tabs and displaying visual demarcation of tabs in the second subset of tabs from other tabs in the tab bar.

In some embodiments, the system-generated grouping of the subset of the plurality of tabs includes merging a first respective tab group and a second respective tab group into a respective system-generated tab group. For example, in some embodiments, the tab bar 5001 can include two tab groups with tabs that include webpage content related to hotels, where a first tab group includes tabs about hotels in one city, and a second tab group includes tabs about hotels in another city. In some embodiments, in response to closing or removing a tab in a respective tab group of the first tab group or the second tab group, the device 100 merges remaining tabs in the first tab group with tabs in the second tab group (e.g., instead of dissolving the respective tab group without merging tabs in the first tab group and the second tab group).

In some embodiments, the system-generated grouping of the subset of the plurality of tabs includes splitting a third respective tab group into a first system-generated tab group and a second system-generated tab group. In some embodiments, in accordance with a determination that the number of tabs in a tab group in the tab bar 5001 are above a maximum threshold requirement, the device 100 splits tabs in the tab group into two or more separate tabs groups.

Note that details of the processes described above with respect to process 600 (e.g., FIG. 6) are also applicable in an analogous manner to other processes described herein. For example, process 600 optionally includes one or more of the characteristics of the various processes described above with reference to process 800 (FIG. 8). For example, the system-generated grouping of process 600 can be the grouping of the first subset of the plurality of tabs of process 800. For brevity, these details are not repeated herein.

FIGS. 7A-7Y illustrate exemplary user interfaces for organizing tabs in a web browser in accordance with some embodiments. The user interfaces in these figures are used to illustrate the processes described below, including the processes in FIG. 8.

FIGS. 7A-7V illustrate portable multifunction device 100 (herein “device 100”) as a desktop computer. It should be recognized that device 100 can be other types of computer systems, such as a smart phone, a tablet, a smart watch, a laptop, an accessory, a personal gaming system, a fitness tracking device, a communal device, and/or a head-mounted display (HMD) device. In some embodiments, device 100 includes and/or is in communication with one or more input devices (e.g., a sensor, a camera, a lidar detector, a motion sensor, an infrared sensor, a touch-sensitive surface, a physical input mechanism, and/or a microphone). In some embodiments, device 100 includes and/or is in communication with one or more output devices (e.g., a display screen, a projector, a touch-sensitive display, and/or a speaker). In some embodiments, device 100 includes one or more components and/or features described above in relation to FIGS. 1A-1E.

FIGS. 7A-7V illustrate output of device 100. While FIGS. 7A-7V illustrate device 100 outputting particular content, it should be recognized that such content is merely for explanatory purposes and that such content can be in different forms, at different locations, at different sizes, include different content, and/or that more, fewer, and/or different content can be output in accordance with techniques described herein. While the examples in FIGS. 7A-7V include device 100 detecting one or more inputs, it should be recognized that such inputs are merely for explanatory purposes and that such inputs can be other types of inputs, such as voice inputs via one or more microphones, touch inputs via one or more touch-sensitive surfaces, physical inputs via one or more physical input mechanisms, and/or hand-gesture inputs via one or more cameras.

As illustrated in FIG. 7A, device 100 displays user interface 5000 (e.g., a browser application user interface) of a web browser application that is installed on device 100. In some embodiments, the web browser application is an application through which device 100 displays webpages corresponding to URLs or web addresses. As illustrated in FIG. 7A, user interface 5000 includes tennis webpage 704. For exemplary purposes, tennis webpage 704 is a webpage of a tennis website and includes a series of user interface elements corresponding to a tennis game. User interface 5000 also includes tab bar 5001, which can include representations of open webpages (each representation referred to as a tab herein) and/or representations of groups of webpages (each representation referred to as a group of tabs herein). In this example, tab bar 5001 includes forecast tab 706, radar tab 708, tennis tab 710, soccer tab 712, ranking tab 714, World Cup tab 716, US Open tab 718, social media tab 720, and law group 786. Also illustrated in FIG. 7A, user interface 5000 includes field 5016, which includes URL 700, the URL of tennis webpage 704 (e.g., “tennis.com”).

At FIG. 7A, tabs 706-720 are representations of different webpages. In order from left to right, forecast tab 706 corresponds to a weather forecast webpage, radar tab 708 corresponds to a weather radar webpage, tennis tab 710 corresponds to tennis webpage 704, soccer tab 712 corresponds to a soccer webpage, ranking tab 714 corresponds to a sports ranking webpage, World Cup tab 716 corresponds to a World Cup webpage, US Open tab 718 corresponds to a US Open webpage, and social media tab 720 corresponds to a social media webpage. As illustrated in FIG. 7A, each tab includes a heading and an icon for the tab and its corresponding webpage. For example, forecast tab 706 includes forecast icon 706a and “Foreca…”, radar tab 708 includes radar icon 708a and “Radar”, tennis tab 710 includes racket icon 710a and “Tenn…”, soccer tab 712 includes soccer ball icon 712a and “Soccer”, ranking tab 714 includes tennis ball icon 714a and “T. Rank…”, World Cup tab 716 includes trophy icon 716a and “World C…”, US Open tab 718 includes tennis balls icon 718a and “US Open”, and social media tab 720 includes smile icon 720a and “New Post.” Each heading provides textual representation of a corresponding webpage. Some such textual representations are truncated based on length and include “…” to represent that a textual representation is longer than would fit. Each icon is a graphical representation of a corresponding tab. It should be recognized that different representations of webpages can be included in a tab, such as more, less, and/or different content.

At FIG. 7A, law group 786 is an indication of grouped tabs that correspond to law-related webpages. As illustrated in FIG. 7A, tabs 706-720 are not included in law group 786 based on a determination that the corresponding webpages are not law-related and/or do not include law content. As illustrated in FIG. 7A, device 100 displays title 786a (e.g., “Law”) within law group 786 to indicate the category of grouped tabs. In some embodiments, device 100 displays a title of a group of tabs differently based on the determined content of the corresponding webpages. For example, device 100 can display a title of “Recipes” based on a determination that a group includes a series of tabs that correspond to cooking webpages.

Also illustrated in FIG. 7A, device 100 displays group number indicator 786b (e.g., “2”) to indicate the number of tabs (e.g., 2 tabs) grouped together in law group 786. In some embodiments, in response to detecting an input (e.g., a tap input or other type of selection input) directed to law group 786, device 100 displays law group 786 in an expanded view, including display of a representation for each tab in law group 786 similar to as described below with respect to sports group 724 and illustrated in FIG. 7C.

As illustrated in FIG. 7A, device 100 displays tennis tab 710 with a bolded border and a white appearance to indicate that tennis tab 710 is the active tab (e.g., tennis tab 710 corresponds to tennis webpage 704, the active webpage that is included in user interface 5000). As illustrated in FIG. 7A, forecast tab 706, radar tab 708, soccer tab 712, ranking tab 714, World Cup tab 716, US Open tab 718, and social media tab 720 have a shaded appearance to indicate that they are inactive tabs. As illustrated in FIG. 7A, law group 786 has a shaded appearance to indicate that law group 786 is a group of tabs. In some embodiments, groups of tabs such as law group 786 have the same shaded appearance as inactive tabs. It should be recognized that device 100 can display tennis tab 710 differently to indicate that tennis tab 710 is the active tab, such as with a shining appearance and/or a colorful border.

Before FIG. 7A, while tabs are not configured to be automatically grouped as further discussed below with respect to FIGS. 7B and 7L-7V, a determination is made that tennis tab 710 can be grouped with other tabs. In some embodiments, the determination that tennis tab 710 can be grouped with other tabs is made in response to detecting that tennis tab 710 is the active tab. It should be recognized that the determination can occur at other times, such as when device 100 initially displays user interface 5000, when device 100 displays any new webpage, and/or in response to device 100 detecting a user input requesting the determination. In some embodiments, the determination that tennis tab 710 can be grouped with other tabs is made based on detecting that other tabs correspond to webpages with related, similar, and/or associated content. For example, a determination is made that tennis tab 710, soccer tab 712, ranking tab 714, World Cup tab 716, and US Open tab 718 all correspond to sports-related webpages and therefore can reasonably be grouped together.

As illustrated in FIG. 7A, in response to the determination that tennis tab 710 can be grouped with other tabs, device 100 displays grouping indicator 710b within tennis tab 710. Grouping indicator 710b includes an indication of the number of other tabs that can be grouped with tennis tab 710 (e.g., “4”). In some embodiments, device 100 displays grouping indicator 710b with the appearance illustrated in FIG. 7A (e.g., with a surrounding circle) based on a determination that tennis tab 710 has not already been grouped with other related tabs. In such embodiments, device 100 displays grouping indicators differently if tabs have been grouped, such as discussed above with reference to law group 786 and as will be discussed below with reference to FIG. 7J.

In some embodiments, device 100 displays grouping indicator 710b while displaying tennis webpage 704. In some embodiments, device 100 displays grouping indicator 710b while displaying tennis webpage 704 after navigating from another webpage. In some embodiments, device 100 displays grouping indicator 710b in response to the determination that other tabs can be grouped with tennis tab 710. In such embodiments, the other tabs do not have to be viewed and/or displayed within user interface 5000 in order for device 100 to display grouping indicator 710b. For example, device 100 displays grouping indicator 710b based on a determination that tabs that are currently not being displayed by device 100 in tab bar 5001 (e.g., do not fit on the tab bar 5001 and/or are displayed in a different window of the web browser application) can be included in a group with tennis tab 710.

In some embodiments, device 100 moves tabs within tab bar 5001 in response to detecting an input. For example, device b can move tennis tab 710 in response to detecting a press-and-drag input, such as moving from the current position in between radar tab 708 and soccer tab 712 to the left of forecast tab 706. For another example, device 100 can move social media tab 720 in response to detecting a verbal input (e.g., “Move the social media tab to the right of the law group”). In some embodiments, device 100 moves groups within tab bar 5001 in response to detecting an input. For example, device 100 can move law group 786 in response to detecting a press-and-drag input and/or a verbal input (e.g., “Move the law group to the left of the forecast tab”). In such embodiments, moved tabs and/or groups remain in the position they were moved.

At FIG. 7A, device 100 detects input 705a on grouping indicator 710b. It should be recognized that input 705a is an example of a tap input (e.g., a selection input) but can be other inputs, such as a verbal input (e.g., “Show me the related tabs”) or a mouse click on grouping indicator 710b.

As illustrated in FIG. 7B, in response to detecting input 705a, device 100 displays related tabs overlay 722. As illustrated in FIG. 7B, related tabs overlay 722 includes a series of user interface elements for grouping tabs related to tennis tab 710, including title 722a, a preview of tabs related to tennis tab 710, organize button 722f, automatically organize button 722g, and not now button 722h.

As illustrated in FIG. 7B, device 100 displays title 722a as “Sports.” In some embodiments, device 100 displays title 722a as “Sports” based on a determination that the related tabs to tennis tab 710 all correspond to webpages that include sports content. As illustrated in FIG. 7B, device 100 displays soccer scores icon 722b, tennis ranking icon 722c, world cup icon 722d, and US open icon 722e as a preview of the webpages related to tennis webpage 704. At FIG. 7B, soccer scores icon 722b corresponds to soccer tab 712, tennis ranking icon 722c corresponds to ranking tab 714, world cup icon 722d corresponds to World Cup tab 716, and US open icon 722e corresponds to US Open tab 718. In some embodiments, device 100 displays soccer scores icon 722b, tennis ranking icon 722c, world cup icon 722d, and US open icon 722e differently. For example, device 100 can display soccer scores icon 722b, tennis ranking icon 722c, world cup icon 722d, and/or US open icon 722e smaller or at another size. For another example, device 100 can display soccer scores icon 722b, tennis ranking icon 722c, world cup icon 722d, and/or US open icon 722e with less detail (e.g., as simple icons similar to forecast icon 706a, radar icon 708a, and so on).

In some embodiments, in response to detecting an input (e.g., a tap input or a mouse click) directed to automatically organize button 722g, device 100 enters into an automatic grouping mode, as discussed below with reference to FIG. 7L. In some embodiments, in response to detecting an input (e.g., a tap input or a mouse click) directed to not now button 722h, device 100 ceases display of related tabs overlay 722.

At FIG. 7B, device 100 detects input 705b1 on organize button 722f. It should be recognized that input 705b1 is an example of a tap input (e.g., a selection input) but can be other inputs, such as a verbal input (e.g., “Group the related tabs”) or a mouse click on organize button 722f.

At FIG. 7B, as an alternative to detecting input 705b1, device 100 detects input 705b2 on automatically organize button 722g. It should be recognized that input 705b2 is an example of a tap input (e.g., a selection input) but can be other inputs, such as a verbal input (e.g., “Automatically group related tabs from now on”) or a mouse click on automatically organize button 722g.

At FIG. 7C, in response to detecting input 705b1, device 100 creates a group comprised of tennis tab 710 with tabs related to tennis tab 710 and not with tabs unrelated to tennis tab 710. In some embodiments, in response to detecting input 705b1, the group is the only group created and other groups are not created, such as groups related to other tabs as discussed further below with respect to what occurs in response to detecting input 705b2. As illustrated in FIG. 7C, device 100 displays sports group 724 (e.g., a group made of tennis tab 710 and tabs related to tennis tab 710). As also illustrated in FIG. 7C, device 100 displays sports group 724 in the position where tennis tab 710 was within tab bar 5001. In some embodiments, device 100 displays sports group 724 in the position where tennis tab 710 was based on a determination that device 100 is operating in a manual grouping mode. In such embodiments, the manual group mode can mean that a group of tabs is manually created without enabling other groups of tabs to be created and new tabs that relate to the group will automatically be added to the group of tabs as further discussed below. In some embodiments, device 100 displays sports group 724 in a different position than where tennis tab 710 was within tab bar 5001. For example, device 100 can display sports group 724 to the left of forecast tab 706 (e.g., at the far left end of tab bar 5001).

As illustrated in FIG. 7C, forecast tab 706, radar tab 708, and social media tab 720 are not included in sports group 724 based on a determination that the corresponding webpages are not sports-related and/or do not include sports content (e.g., or other content determined to be relevant to tennis tab 710). As illustrated in FIG. 7C, device 100 displays title 724a (e.g., “Sports”) within sports group 724 to indicate the category of grouped tabs. In some embodiments, device 100 displays a title of a group of tabs differently based on the determined content of the corresponding webpages. For example, device 100 can display a title of “Recipes” based on a determination that a group includes a series of tabs that correspond to recipe webpages.

At FIG. 7C, device 100 displays sports group 724 in an expanded view. While displaying sports group 724 in the expanded view, device 100 displays sports group 724 with tennis tab 710, the active tab, with a white appearance separate from the other tabs in sports group 724, which are displayed only with their respective icons. As illustrated in FIG. 7C, sports group 724 has a shaded appearance to indicate that sports group 724 is a group of tabs. As illustrated in FIG. 7C, soccer tab 712, ranking tab 714, World Cup tab 716, and US Open tab 718 have a shaded appearance to indicate that they are inactive tabs. In some embodiments, device 100 displays sports group 724 in a minimized view, as will be discussed further below with reference to FIG. 7H. In some embodiments, device 100 displays sports group 724 in the expanded view based on a determination that a tab within sports group 724 is the active tab. In some embodiments, device 100 displays sports group 724 in the expanded view in response to detecting an input (e.g., a tap input or a mouse click) directed to sports group 724 while in the minimized view.

As illustrated in FIG. 7C, as part of creating sports group 724, device 100 condenses tennis tab 710, soccer tab 712, ranking tab 714, World Cup tab 716, and US Open tab 718. As part of condensing tennis tab 710, soccer tab 712, ranking tab 714, World Cup tab 716, and US Open tab 718, device 100 creates more room within tab bar 5001 whereas before, the tabs filled tab bar 5001 entirely.

As illustrated in FIG. 7C, device 100 condenses tennis tab 710 to not include racket icon 710a while keeping a heading (e.g., “Tennis”). In some embodiments, device 100 condenses tennis tab 710 to not include racket icon 710a while keeping the heading based on a determination that tennis tab 710 is the active tab. In some embodiments, device 100 condenses tennis tab 710 to only include racket icon 710a and ceases display of a heading. It should be recognized that, in some embodiments, tennis tab 710 is not condensed in response to detecting input 705b1 and, instead, tennis tab 710 maintains racket icon 710a with the heading (“Tenn…”) or the heading (“Tennis”). Additionally, device 100 condenses soccer tab 712, ranking tab 714, World Cup tab 716, and US Open tab 718 to only include their respective icons (e.g., device 100 ceases display of their respective headings). In some embodiments, device 100 condenses soccer tab 712, ranking tab 714, World Cup tab 716, and US Open tab 718 based on a determination that they are not the active tab.

Also illustrated in FIG. 7C, device 100 displays group menu 726. In some embodiments, device 100 displays group menu 726 in response to detecting a secondary input (e.g., a context invocation input, an alternate selection input, a non-primary input, an auxiliary input, an input corresponding to a secondary function, a long press, and/or a right mouse click) on sports group 724. In other embodiments, device 100 displays group menu 726 in response to detecting a verbal input (e.g., “Open a menu for this sports group”). As illustrated in FIG. 7C, group menu 726 includes a series of user interface elements for interacting with tennis tab 710 and sports group 724, including share item 726a, copy item 726b, close tabs item 726c, move item 726d, mode item 726e, and ungroup item 726f.

In some embodiments, in response to detecting an input (e.g., a tap input or a mouse click) directed to share item 726a, device 100 displays a share user interface and/or overlay to allow a user to share tennis tab 710 and/or sports group 724 with another computer system. In some embodiments, in response to detecting an input (e.g., a tap input or a mouse click) directed to copy item 726b, device 100 copies (e.g., stores, saves, and/or stashes) tennis tab 710 and/or sports group 724 in order for tennis tab 710 and/or sports group 724 to be pasted in another destination. In some embodiments, in response to detecting an input (e.g., a tap input or a mouse click) directed to close tabs item 726c, device 100 closes all the tabs in sports group 724. In some embodiments, in response to detecting an input (e.g., a tap input or a mouse click) directed to move item 726d, device 100 selects sports group 724 to be moved to a different tab group. In other embodiments, move item 726d is optionally not able to be selected unless the secondary input is directed to a tab that is not already included in a group of tabs (e.g., in FIG. 7C, move item 726d is not available for selection because tennis tab 710 is already included in the sports group 724). In some embodiments, in response to detecting an input (e.g., a tap input or a mouse click) directed to ungroup item 726f, device 100 ungroups the tabs within sports group 724 and displays such tabs outside of any group of tabs.

At FIG. 7C, device 100 detects input 705c on mode item 726e. It should be recognized that input 705c is an example of a tap input (e.g., a selection input) but can be other inputs, such as a verbal input (e.g., “Show me organization modes”) or a mouse click on mode item 726e.

As illustrated in FIG. 7D, in response to detecting input 705c, device 100 displays mode overlay 728. Mode overlay 728 includes a series of user interface elements corresponding to the different grouping modes of device 100. As illustrated in FIG. 7D, mode overlay 728 includes automatic mode item 728a, manual mode item 728b, never mode item 728c, and selection indicator 728d. Device 100 displays selection indicator 728d next to manual button 728b to indicate that device 100 is operating in the manual grouping mode (e.g., with respect to all tabs or, specifically, sports group 724).

At FIG. 7D, device 100 detects input 705d1 on automatic mode item 728a. It should be recognized that input 705d1 is an example of a tap input (e.g., a selection input) but can be other inputs, such as a verbal input (e.g., “Enter the automatic grouping mode”) or a mouse click on automatic mode item 728a.

At FIG. 7D, as an alternative to detecting input 705d1, device 100 detects input 705d2 on never mode item 728c. It should be recognized that input 705d2 is an example of a tap input (e.g., a selection input) but can be other inputs, such as a verbal input (e.g., “Never group related tabs from now on”) or a mouse click on never mode item 728c. In some embodiments, in response to detecting input 705d2 on never mode item 728c, device 100 enters into a never grouping mode. While operating in the never grouping mode, device 100 will not automatically group related tabs and/or will not prompt that related tabs can be grouped (e.g., will not display grouping indicators like grouping indicator 710b). In some embodiments, in response to detecting input 705d2 directed to never mode item 728c while device 100 displays sports group 724, device 100 ungroups the tabs within sports group 724 and law group 786 and displays the tabs within tab bar 5001 outside of any group.

At FIG. 7D, as an alternative to detecting input 705d1, device 100 detects input 705d3 on tennis webpage 704. It should be recognized that input 705d3 is an example of a tap input (e.g., a selection input) but can be other inputs, such as a verbal input (e.g., “Automatically group related tabs from now on”) or a mouse click on tennis webpage 704. It will be understood that a user may switch between modes (e.g., automatic grouping mode, manual grouping mode, and/or never grouping mode) over time.

As illustrated in FIG. 7E, in response to detecting input 705d3, device 100 ceases display of group menu 726 and mode overlay 728. In some embodiments, in response to detecting input 705d3, device 100 ceases display of mode overlay 728 but optionally maintains display of group menu 726. In some embodiments, user interface elements illustrated in FIGS. 7C-7D are not displayed in response to detecting input 705d3 and device 100 instead displays user interface 5000 with the appearance illustrated in FIG. 7E.

At FIG. 7E, device 100 detects input 705e on add button 772. It should be recognized that input 705e is an example of a tap input (e.g., a selection input) but can be other inputs, such as a verbal input (e.g., “Open a new webpage”) or a mouse click on add button 772.

As illustrated in FIG. 7F, in response to detecting input 705e, device 100 displays start tab 5014 (e.g., a tab corresponding to a landing webpage). Start tab 5014 includes start icon 784, a representation of start tab 5014. As illustrated in FIG. 7F, device 100 displays start tab 5014 within sports group 724. In some embodiments, device 100 displays start tab 5014 within sports group 724 based on a determination that device 100 received a request to add a new webpage (e.g., input 705e) while a tab within sports group 724 was the active tab. In some embodiments, device 100 does not display start tab 5014 within sports group 724 and instead displays start tab 5014 outside of any group, such as next to sports group 724 or at a far right side of tab bar 5001.

As illustrated in FIG. 7F, in response to detecting input 705e, device 100 displays start webpage 730 (e.g., a landing page corresponding to user interface 5000). Start webpage 730 includes a series of user interface elements that correspond to favorited and/or previously visited webpages, including cookie recipe icon 730a. At FIG. 7F, cookie recipe icon 730a corresponds to a cookie recipe webpage that has been favorited on device 100 (e.g., saved, liked, and/or stored for later use). As illustrated in FIG. 7F, device 100 displays start tab 5014 with a bolded border and a white appearance to indicate that start tab 5014 is the active tab (e.g., start tab 5014 corresponds to start webpage 730, the active webpage). Also illustrated in FIG. 7F, as part of displaying start webpage 730, device 100 displays search indication 702 within field 5016, to indicate that start webpage 730 is a landing page and that a webpage can be searched for (e.g., “Search or enter website name”).

At FIG. 7F, a determination is made that tennis tab 710 is no longer the active tab. In some embodiments, the determination that tennis tab 710 is no longer the active tab is made in response to detecting a user input directed to another tab (e.g., a request to display the webpage of the other tab, such that the other tab becomes the active tab) or the user input 705e corresponding to a request to display a new webpage. As illustrated in FIG. 7F, in response to the determination is made that tennis tab 710 is no longer the active tab, device 100 condenses tennis tab 710 to only include racket icon 710a.

At FIG. 7F, device 100 detects input 705f on cookie recipe icon 730a. It should be recognized that input 705f is an example of a tap input (e.g., a selection input) but can be other inputs, such as a verbal input (e.g., “Open the cookie recipe”) or a mouse click on cookie recipe icon 730a.

As illustrated in FIG. 7G, in response to detecting input 705f, device 100 displays cookie recipe tab 736 (e.g., a tab corresponding to a cookie recipe webpage). As illustrated in FIG. 7G, device 100 displays cookie recipe tab 736 within sports group 724. In some embodiments, device 100 displays cookie recipe tab 736 within sports group 724 based on a determination that start tab 5014 was within sports group 724. In some embodiments, device 100 does not display cookie recipe tab 736 within sports group 724.

As illustrated in FIG. 7G, in response to detecting input 705f, device 100 displays cookie recipe webpage 734 (e.g., a webpage corresponding to a cookie recipe website). Cookie recipe webpage 734 includes a series of user interface elements that correspond to a chocolate chip cookie recipe.

As illustrated in FIG. 7G, device 100 displays cookie recipe tab 736 with a bolded border and a white appearance to indicate that cookie recipe tab 736 is the active tab (e.g., cookie recipe tab 736 corresponds to cookie recipe webpage 734, the active webpage). Also illustrated in FIG. 7G, as part of displaying cookie recipe webpage 734, device 100 displays URL 774 within field 5016, which is the URL of cookie recipe webpage 734 (e.g., “recipes.com”). At FIG. 7G, a determination is made that cookie recipe tab 736 does not relate to the tabs within sports group 724 (e.g., the content included in cookie recipe webpage 734 is not sports content).

As illustrated in FIG. 7H, based on the determination that cookie recipe tab 736 does not relate to the tabs within sports group 724, device 100 displays cookie recipe tab 736 outside of sports group 724, to the right of social media tab 720 (e.g., or in another portion of the tab bar 5001 separate from sports group 724). In some embodiments, device 100 displays cookie recipe tab 736 to the right of social media tab 720 based on a determination that cookie recipe tab 736 is the most recently created tab. In some embodiments, device 100 displays cookie recipe tab 736 to the right of social media tab 720 based on a determination that cookie recipe tab 736 is a tab that was removed from sports group 724. As illustrated in FIG. 7H, device 100 displays cookie icon 736a within cookie recipe tab 736, which is a representation of cookie recipe tab 736. In some embodiments, device 100 does not display cookie recipe tab 736 within sports group 724 based on a determination that cookie recipe tab 736 does not relate to tabs within sports group 724. In such embodiments, device 100 skips the process illustrated in FIG. 7G. In some embodiments, while device 100 is in the manual grouping mode, device 100 displays cookie recipe tab 736 as a tab to the right of social media tab 720 even when a determination is made cookie recipe tab 736 relates to other tabs in tab bar 5001. In such embodiments, device 100 does not group cookie recipe tab 736 with other recipe tabs because a recipe group has not been created by the user.

As illustrated in FIG. 7H, device 100 displays cookie recipe tab 736 with a bolded border, a white appearance, and a larger size to indicate that cookie recipe tab 736 is the active tab (e.g., cookie recipe tab 736 corresponds to cookie recipe webpage 734, the active webpage). Additionally, device 100 displays cookie recipe tab 736 with cookie icon 736a, a representation of cookie recipe tab 736.

At FIG. 7H, a determination is made that no tabs within sports group 724 are the active tab (e.g., and/or a determination is made that cookie recipe tab 736 is the active tab within the user interface 5000). As illustrated in FIG. 7H, based on the determination that no tabs within sports group 724 are the active tab, device 100 displays sports group 724 in the minimized view. While displaying sports group 724 in the minimized view, device 100 displays title 724a (e.g., “Sports”) and group number indicator 724b (e.g., “5”). Device 100 displays group number indicator 724b to indicate that there are five tabs grouped together in sports group 724. In some embodiments, in response to detecting an input (e.g., a tap input or a mouse click) directed to sports group 724, device 100 displays sports group 724 in the expanded view, including the tabs included in sports group 724.

At FIG. 7H, device 100 detects input 705h on field 5016. It should be recognized that input 705h is an example of a tap input (e.g., a selection input) but can be other inputs, such as a verbal input (e.g., “I want to go to a new website”) or a mouse click on field 5016.

At FIG. 7I, a user is typing a URL (e.g., as indicated by URL 776) into field 5016. It should be recognized that, as illustrated in FIG. 7I, URL 776 is incomplete.

In between FIGS. 7I-7J, the user has completed typing URL 776 and has directed an input to device 100 to view the webpage corresponding to URL 776, such as a tap input, a mouse click input, a keyboard input (e.g., selecting a “return” or “enter” key) and/or a verbal input (e.g., “Open gear.com”). As illustrated in FIG. 7J, device 100 displays football gear tab 738 (e.g., a tab corresponding to a football gear webpage). Football gear tab 738 includes goalpost icon 738a, a representation of football gear tab 738. Additionally illustrated in FIG. 7J, device 100 displays football gear webpage 740 (e.g., a webpage corresponding to a football gear website). Football gear webpage 740 includes a series of user interface elements that correspond to purchasing football gear.

As illustrated in FIG. 7J, device 100 does not display football gear tab 738 within sports group 724 despite football gear webpage 740 including sports content. In some embodiments, device 100 does not display football gear tab 738 within sports group 724 to illustrate to a user that football gear tab 738 is being moved or when a determination that football gear tab 738 corresponds to sports group 724 has not been made yet (e.g., there has not been enough time for a determination to be made that football gear webpage 740 includes sports content). In some embodiments, device 100 displays football gear tab 738 within sports group 724 upon navigation to football gear webpage 740.

As illustrated in FIG. 7J, device 100 displays football gear tab 738 with a bolded border, a white appearance, and a larger size to indicate that football gear tab 738 is the active tab (e.g., football gear tab 738 corresponds to football gear webpage 740, the active webpage). Also illustrated in FIG. 7J, as part of displaying football gear webpage 740, device 100 displays URL 776 in its entirety within field 5016. At FIG. 7J, a determination is made that football gear tab 738 relates to the tabs within sports group 724 (e.g., the content included in football gear webpage 740 is sports-related content).

As illustrated in FIG. 7K, in response to the determination that football gear tab 738 relates to the tabs within sports group 724, device 100 automatically, without additional user input, displays football gear tab 738 within sports group 724. As part of displaying football gear tab 738 within sports group 724, device 100 displays sports group 724 in the expanded view based on a determination that football gear tab 738, the active tab, is displayed in sports group 724. As illustrated in FIG. 7K, device 100 condenses football gear tab 738 to not include goalpost icon 738a. Also illustrated in FIG. 7K, device 100 maintains display of football gear tab 738 with a bolded border, a white appearance, and a larger size to indicate that football gear tab 738 is the active tab.

FIGS. 7L-7V illustrate device 100 organizing tabs while operating in an automatic grouping mode. At FIG. 7L, in response to detecting input 705b2 at FIG. 7B or input 705d1 at FIG. 7D, device 100 enters into the automatic grouping mode. As illustrated in FIG. 7L, in response to entering into the automatic grouping mode, device 100 displays weather group 742 and sports group 724. It should be recognized that, in response to detecting input 705b2, device 100 creates weather group 742 and sports group 724 while operating in the automatic grouping mode. It should also be recognized that, in response to detecting input 705d1, device 100 creates weather group 742 while operating in the automatic grouping mode, but sports group 724 had already been created in the manual mode as illustrated in FIG. 7C. For the purposes of the discussion below, sports group 724 will be discussed as created in the automatic grouping mode unless otherwise clarified.

At FIG. 7L, device 100 creates weather group 742 based on a determination that forecast tab 706 and radar tab 708 correspond to webpages that include weather content and/or weather-related content. Additionally, device 100 creates sports group 724 based on a determination that tennis tab 710, soccer tab 712, ranking tab 714, World Cup tab 716, and US Open tab 718 correspond to webpages that include sports content and/or sports-related content. As illustrated in FIG. 7L, device 100 maintains display of law group 786 (e.g., while operating in the automatic grouping mode, device 100 does not alter created groups). In some embodiments, groups created outside of the automatic grouping mode are not carried into the automatic grouping mode and tabs in such groups are redistributed and/or put outside of any group when it is determined that such tabs should not be grouped. It should be recognized that a difference between operating in the manual grouping mode and operating in the automatic grouping mode is that device 100 creates one grouping of tabs at a time based on the selected tabs to be grouped while operating in the manual grouping mode whereas device 100 can create more than one grouping of tabs at a time and/or continues to create groups while operating in the automatic grouping mode.

As illustrated in FIG. 7L, the prior position of law group 786 did not affect the grouping of forecast tab 706 and radar tab 708 into weather group 742. As illustrated in FIG. 7L, device 100 moves law group 786 to the right of sports group 724 when creating weather group 742 and sports group 724. In some embodiments, device 100 moves law group 786 to the right of sports group 724 because the grouped tabs are organized by reverse alphabetical order or based on user preference. In some embodiments, the grouped tabs are organized in a different order such as by relative location of the corresponding tabs, which would preserve law group 786 in its original position to the left of sports group 724.

As illustrated in FIG. 7L, device 100 displays weather group 742 in the position where forecast tab 706 was within tab bar 5001. As illustrated in FIG. 7L, sports group 724 has a shaded appearance similar to weather group 742 and law group 786. As illustrated in FIG. 7L, device 100 displays weather group 742 (e.g., a group made of forecast tab 706 and radar tab 708) in the minimized view. In some embodiments, device 100 displays weather group 742 in the minimized view based on a determination that a tab in another group is the active tab (e.g., tennis tab 710). As illustrated in FIG. 7L, device 100 displays title 742a (e.g., “Weather”) within weather group 742 to indicate the category of grouped tabs. Additionally, device 100 displays group number indicator 742b (e.g., “2”) to indicate that there are two tabs grouped together in weather group 742. As illustrated in FIG. 7L, social media tab 720 is not grouped with another tab and/or tabs because there are no other tabs that include related content to social media tab 720. As illustrated in FIG. 7C, social media tab 720 is not included in weather group 742 or sports group 724 based on a determination that the corresponding webpages are not weather or sports-related and/or do not include weather or sports content.

As illustrated in FIG. 7L, device 100 displays sports group 724 in the expanded view based on a determination that tennis tab 710 is the active tab. As illustrated in FIG. 7L, device 100 displays weather group 742, sports group 724, and law group 786 at the left end of tab bar 5001 and social media tab 720 to the right of law group 786. In some embodiments, device 100 displays weather group 742, sports group 724, and law group 786 at the left end of tab bar 5001 based on entering into the automatic grouping mode (e.g., while operating in the automatic grouping mode, device 100 displays groups at the left end of tab bar 5001). In some embodiments, while operating in the automatic grouping mode, device 100 maintains display of law group 786 in the original placement of to the right of social media tab 720.

At FIG. 7L, device 100 detects input 705l on add button 772. It should be recognized that input 705l is an example of a tap input (e.g., a selection input) but can be other inputs, such as a verbal input (e.g., “Open a new webpage”) or a mouse click on add button 772.

As illustrated in FIG. 7M, in response to detecting input 705l, device 100 displays start tab 5014 within sports group 724. Also illustrated in FIG. 7M, in response to detecting input 705e, device 100 displays start webpage 730. Start webpage 730 includes a series of user interface elements that correspond to favorited and/or previously visited webpages, including outlook website icon 730b. At FIG. 7M, outlook website icon 730b corresponds to a weather outlook webpage that has been frequently visited on device 100. As illustrated in FIG. 7M, device 100 displays start tab 5014 with a bolded border and a white appearance to indicate that start tab 5014 is the active tab. Also illustrated in FIG. 7M, as part of displaying start webpage 730, device 100 displays search indication 702 within field 5016. At FIG. 7M, a determination is made that tennis tab 710 is no longer the active tab. As illustrated in FIG. 7M, in response to the determination that tennis tab 710 is no longer the active tab, device 100 condenses tennis tab 710 to only include racket icon 710a. Additionally, device 100 maintains display of sports group 724 in the expanded view based on a determination that start tab 5014 is the active tab.

At FIG. 7M, device 100 detects input 705m on outlook website icon 730b. It should be recognized that input 705m is an example of a tap input (e.g., a selection input) but can be other inputs, such as a verbal input (e.g., “Open the seven day outlook”) or a mouse click on outlook website icon 730b.

As illustrated in FIG. 7N, in response to detecting input 705m, device 100 displays outlook tab 746 (e.g., a tab corresponding to a seven day forecast webpage). As illustrated in FIG. 7N, device 100 displays outlook tab 746 within sports group 724. In some embodiments, device 100 displays outlook tab 746 within sports group 724 based on a determination that start tab 5014 was within sports group 724, as described with respect to FIG. 7M. In some embodiments, device 100 does not display outlook tab 746 within sports group 724.

As illustrated in FIG. 7N, also in response to detecting input 705m, device 100 displays outlook webpage 744 (e.g., a webpage corresponding to a weather outlook website). Outlook webpage 744 includes a series of user interface elements that correspond to a seven day forecast for Dallas, Texas.

As illustrated in FIG. 7N, device 100 displays outlook tab 746 with a bolded border and a white appearance to indicate that outlook tab 746 is the active tab (e.g., outlook tab 746 corresponds to outlook webpage 744, the active webpage). Also illustrated in FIG. 7N, as part of displaying outlook webpage 744, device 100 displays URL 778 within field 5016, which is the URL of outlook webpage 744 (e.g., “weeklyoutlook.com”). Additionally, device 100 maintains display of sports group 724 in the expanded view based on a determination that outlook tab 746 is the active tab. At FIG. 7N, a determination is made that outlook tab 746 does not relate to the tabs within sports group 724 (e.g., the content included in outlook webpage 744 is not sports content) but does relate to the tabs within weather group 742 (e.g., the content included in outlook webpage 744 is weather content).

As illustrated in FIG. 7O, based on the determination that outlook tab 746 relates to the tabs within weather group 742, device 100 displays outlook tab 746 within weather group 742. As part of displaying outlook tab 746 within weather group 742, device 100 displays weather group 742 in the expanded view. While displaying weather group 742 in the expanded view, device 100 condenses forecast tab 706 and radar tab 708 to only include their respective icons. Additionally, device 100 maintains display of outlook tab 746 with a bolded border and a white appearance to indicate that outlook tab 746 is the active tab.

As illustrated in FIG. 7O, as part of displaying outlook tab 746 within weather group 742, device 100 displays sports group 724 in the minimized view. In some embodiments, as part of displaying outlook tab 746 within weather group 742, device 100 maintains display of sports group 724 in the expanded view.

In some embodiments, based on the determination that outlook tab 746 does not relate to the tabs within sports group 724, device 100 displays outlook tab 746 to the right of social media tab 720. In such embodiments, based on the determination that outlook tab 746 does not relate to the tabs within sports group 724 but does relate to the tabs within weather group 742, after displaying outlook tab 746 to the right of social media tab 720, device 100 then displays outlook tab 746 within weather group 742.

At FIG. 7O, device 100 detects input 705o on add button 772. It should be recognized that input 705o is an example of a tap input (e.g., a selection input) but can be other inputs, such as a verbal input (e.g., “Open a new webpage”) or a mouse click on add button 772.

As illustrated in FIG. 7P, in response to detecting input 705o, device 100 displays start tab 5014 within weather group 742. Additionally, device 100 displays start tab 5014 with a bolded border and a white appearance to indicate that start tab 5014 is the active tab (e.g., start tab 5014 corresponds to start webpage 730, the active webpage). Also illustrated in FIG. 7P, as part of displaying start tab 5014, device 100 condenses outlook tab 746 to only include sun icon 746a, a representation of outlook tab 746. In some embodiments, device 100 condenses outlook tab 746 based on a determination that outlook tab 746 is not the active tab. As illustrated in FIG. 7P, device 100 maintains display of weather group 742 based on a determination that start tab 5014 is the active tab.

At FIG. 7P, device 100 detects input 705p on field 5016. It should be recognized that input 705p is an example of a tap input (e.g., a selection input) but can be other inputs, such as a verbal input (e.g., “I want to go to a new website”) or a mouse click on field 5016.

In between FIGS. 7P-7Q, a user completed typing URL 780 (e.g., “footballranking.com”) and has directed an input to device 100 to view the webpage corresponding to URL 780, such as a tap input, a mouse click input, and/or a verbal input (e.g., “Open footballranking.com”). As illustrated in FIG. 7Q, device 100 displays football ranking tab 750 (e.g., a tab corresponding to a football ranking webpage) within weather group 742. Additionally, device 100 displays football ranking tab 750 with a bolded border, a white appearance, and a larger size to indicate that football ranking tab 750 is the active tab.

As illustrated in FIG. 7Q, device 100 displays football ranking webpage 748 (e.g., a webpage corresponding to a football ranking website). Football ranking webpage 748 includes a series of user interface elements that correspond to ranking football teams and/or viewing football statistics. Additionally, device 100 maintains display of weather group 742 in the expanded view based on a determination that football ranking tab 750 is the active tab. At FIG. 7Q, a determination is made that football ranking tab 750 does not relate to the tabs within weather group 742 (e.g., the content included in football ranking webpage 748 is not weather content) but does relate to the tabs within sports group 724 (e.g., the content included in football ranking webpage 748 is sports content).

As illustrated in FIG. 7R, based on the determination that football ranking tab 750 does not relate to the tabs within weather group 742 but does relate to the tabs within sports group 724, device 100 displays football ranking tab 750 within sports group 724. It should be recognized that device 100 displays football ranking tab 750 within sports group 724 based on the determination that football ranking tab 750 relates to the tabs within sports group 724.

As illustrated in FIG. 7R, as part of displaying football ranking tab within sports group 724, device 100 displays sports group 724 in the expanded view. Additionally, device 100 maintains display of football ranking tab 750 with a bolded border, a white appearance, and a larger size to indicate that football ranking tab 750 is the active tab. As illustrated in FIG. 7R, as part of displaying football ranking tab 750 within sports group 724, device 100 displays weather group 742 in the minimized view. As illustrated in FIG. 7R, device 100 group number indicator 742b (e.g., “3”) to indicate that there are now three tabs grouped together in weather group 742. As such, the group number indicator 742b is updated over time to display an indication of a current number of tabs in the group.

At FIG. 7R, device 100 detects input 705r on social media tab 720. It should be recognized that input 705r is an example of a tap input (e.g., a selection input) but can be other inputs, such as a verbal input (e.g., “Open my social media”) or a mouse click on social media tab 720.

As illustrated in FIG. 7S, in response to detecting input 705r, device 100 displays social media webpage 752 (e.g., a webpage corresponding to a social media website). Social media webpage 752 includes a series of user interface elements that correspond to a social media platform. As illustrated in FIG. 7S, device 100 displays social media tab 720 with a bolded border, a white appearance, and an increased size to indicate that social media tab 720 is the active tab. Also illustrated in FIG. 7S, as part of displaying social media webpage 752, device 100 displays URL 782 within field 5016, which is the URL of social media webpage 752 (e.g., “socialmedia.com”).

As illustrated in FIG. 7S, in response to detecting input 705r, device 100 displays sports group 724 in the tab view. As part of displaying sports group 724 in the tab view, device 100 displays title 724a and football ranking tab 750 within sports group 724. While displaying sports group 724 in the tab view, device 100 displays football ranking tab 750 with a heading (e.g., “FB Ra…”). Additionally, while displaying sports group 724 in the tab display, device 100 optionally ceases display of racket icon 710a, soccer ball icon 712a, tennis ball icon 714a, trophy tab 716a, and tennis balls icon 718a. In some embodiments, device 100 displays sports group 724 in the tab display based on a determination that input 705r was directed to social media tab 720 (e.g., a tab outside of sports group 724) while football ranking tab 750 was the active tab. In some embodiments, in response to a determination that input 705r was directed to social media tab 720 while football ranking tab 750 was the active tab, device 100 displays sports group 724 in the minimized view, similarly to sports group 724 as illustrated in FIG. 7O.

At FIG. 7S, device 100 detects input 705s1 on title 724a. It should be recognized that input 705s1 is an example of a tap input (e.g., a selection input) but can be other inputs, such as a verbal input (e.g., “Condense this group”) or a mouse click on title 724a.

At FIG. 7S, device 100 detects input 705s2 on football ranking tab 750. It should be recognized that input 705s2 is an example of a tap input (e.g., a selection input) but can be other inputs, such as a verbal input (e.g., “Show me the tabs in this group”) or a mouse click on football ranking tab 750.

As illustrated in FIG. 7T, in response to detecting input 705s2, device 100 displays football ranking tab 750 with a bolded border, a white appearance, and a larger size to indicate that football ranking tab 750 is the active tab. Also illustrated in FIG. 7T, in response to detecting input 705s2, device 100 displays football ranking webpage 748.

As illustrated in FIG. 7U, in response to detecting input 705s1, device 100 displays sports group 724 in the minimized view. While displaying sports group 724 in the minimized view, device 100 maintains display of title 724a (e.g., “Sports”) and displays group number indicator 724b within sports group 724 (e.g., device 100 ceases display of all headings and icons corresponding to tabs within sports group 724). As illustrated in FIG. 7U, device 100 displays group number indicator 724b as “6” to indicate that there are six tabs grouped together in sports group 724. In some embodiments, in response to detecting input 705s1, device 100 displays sports group 724 in the expanded view. In some embodiments, device 100 detects an input on title 724a. It should be recognized that the input on title 724a in FIG. 7U is an example of a tap input (e.g., a selection input) but can be other inputs, such as a verbal input (e.g., “Open this group”) or a mouse click on title 724a. In some embodiments, in response to detecting the input on title 724a in FIG. 7U, device 100 displays sports group 724 in the expanded view such as described above with reference to FIG. 7R.

FIG. 7V presents an alternative figure to FIG. 7L. At FIG. 7V, in response to detecting 705d1, device 100 enters into the automatic grouping mode. As illustrated in FIG. 7V in response to entering into the automatic grouping mode, device 100 displays weather group 742, tennis group 754, soccer group 756, and social media tab 720. As illustrated in FIG. 7V, device 100 displays tennis group 754 and soccer group 756 as separate groups, derived from sports group 724. In some embodiments, device 100 displays tennis group 754 and soccer group 756 as separate groups derived from sports group 724 based on a determination that the tabs in tennis group and the tabs in soccer group 756 are both sports-related content but can be grouped with further specificity. For example, tennis tab 710, ranking tab 714, and US Open tab 718 are all tennis-related content and can therefore be grouped, and soccer tab 712 and World Cup tab 716 are soccer-related tabs and can therefore be grouped. In some embodiments, device 100 groups tabs with further specificity based on settings, user preference, and/or history. As illustrated in FIG. 7V, as part of grouping tabs with further specificity, device 100 breaks up sports group 724 to display tennis group 754 and soccer group 756.

As illustrated in FIG. 7V, device 100 displays tennis group 754 with title 754a (e.g., “Tennis”) and group number indicator 754b (e.g., “3”). Device 100 displays group number indicator 754b to indicate that there are three tabs grouped together in tennis group 754. As illustrated in FIG. 7V, device 100 displays tennis group 754 with a bolded appearance to indicate a tab within tennis group 754 is the active tab.

As illustrated in FIG. 7V, device 100 displays soccer group 756 with title 756a (e.g., “Soccer”) and group number indicator 756b (e.g., “2”). Device 100 displays group number indicator 756b to indicate that there are two tabs grouped together in soccer group 756. As illustrated in FIG. 7V, social media tab 720 is not grouped with another tab and/or tabs because there are no other tabs that include related content to social media tab 720.

FIGS. 7W-7Y illustrate a grouping process on a different device than device 100. FIGS. 7W-7Y illustrate computer system 760 as a smart phone. It should be recognized that computer system 760 can be other types of computer systems such as a tablet, a smart watch, a laptop, an accessory, a desktop computer, a personal gaming system, a fitness tracking device, a communal device, and/or a head-mounted display (HMD) device. In some embodiments, computer system 760 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 760 includes and/or is in communication with one or more output devices (e.g., a display screen, a projector, a touch-sensitive display, and/or a speaker). In some embodiments, device 100 includes one or more components and/or features described above in relation to FIGS. 1A-1E.

FIGS. 7W-7Y illustrate output of computer system 760. While FIGS. 7W-7Y illustrate computer system 760 outputting particular content, it should be recognized that such content is merely for explanatory purposes and that such content can be in different forms, at different locations, at different sizes, include different content, and/or that more, fewer, and/or different content can be output in accordance with techniques described herein. While the examples in FIGS. 7W-7Y include computer system 760 detecting one or more inputs, it should be recognized that such inputs are merely for explanatory purposes and that such inputs can be other types of inputs, such as voice inputs via one or more microphones, touch inputs via one or more touch-sensitive surfaces, physical inputs via one or more physical input mechanisms, and/or hand-gesture inputs via one or more cameras.

As illustrated in FIG. 7W, computer system 760 displays user interface 762 (e.g., a browser application user interface) of a web browser application that is installed on computer system 760. User interface 762 includes a series of tabs corresponding to different webpages and filter button 764.

At FIG. 7W, device 100 detects input 705w on filter button 764. It should be recognized that input 705w is an example of a tap input (e.g., a selection input) but can be other inputs, such as a verbal input (e.g., “Show me what can be filtered”) or a mouse click on filter button 764.

As illustrated in FIG. 7X, in response to detecting input 705w, computer system 760 displays filter overlay 766. Filter overlay 766 includes a series of grouping options based on open tabs within user interface 762, including lamp filter 766a. In some embodiments, the grouping options included in filter overlay 766 are computer-generated. For example, computer system 760 generates (e.g., creates, develops, and/or produces) the filtering options included in filter overlay 766 free of input based on open tabs within user interface 762.

At FIG. 7X, computer system 760 displays lamp filter 766a within filter overlay 766 to indicate a group that can be created based on tabs corresponding to webpages that include lamp-related content. Additionally, computer system 760 displays amount indicator 766b to indicate that there are ten tabs corresponding to webpages that include lamp-related content. As illustrated in FIG. 7X, computer system 760 also displays automatically organize button 766c within filter overlay 766. In some embodiments, in response to detecting an input directed to automatically organize button 766c, computer system 760 enters into the automatic grouping mode and automatically groups tabs within user interface 762 based on a determination of related content.

At FIG. 7X, device 100 detects input 705x on lamp filter 766a. It should be recognized that input 705x is an example of a tap input (e.g., a selection input) but can be other inputs, such as a verbal input (e.g., “Filter by lamp tabs”) or a mouse click on lamp filter 766a.

At FIG. 7Y, in response to detecting input 705x, computer system 760 filters tabs based on a determination of lamp-related content. As part of filtering tabs based on a determination of lamp-related content, computer system 760 displays lamp filter user interface 768. Lamp filter user interface 768 includes a series of tabs corresponding to webpages that include lamp-related content. As illustrated in FIG. 7Y, as part of displaying lamp filter user interface 768, computer system 760 displays filter indicator 764a (e.g., “Filtered by 10 brands”) to indicate that computer system 760 is filtering tabs based on lamp-related content within the corresponding webpages and that there are ten total tabs included in lamp filter user interface 768.

At FIG. 7Y, device 100 detects input 705y on filter button 764. It should be recognized that input 705y is an example of a tap input (e.g., a selection input) but can be other inputs, such as a verbal input (e.g., “Can you undo the filter?”) or a mouse click on filter button 764.

In some embodiments, in response to detecting input 705y, computer system 760 ceases filtering tabs based on a determination of lamp-related content and ceases display of lamp filter user interface 768 and displays user interface 762. As part of displaying user interface 762, computer system 760 displays the tabs with the appearance illustrated in FIGS. 7W-7X. It should be recognized that input 705y is an alternate input and the results are not illustrated.

FIG. 8 is a flow diagram illustrating a process (e.g., process 800) for organizing tabs in accordance with some embodiments. Some operations in process 800 are, optionally, combined, the orders of some operations are, optionally, changed, and some operations are, optionally, omitted.

As described below, process 800 provides an intuitive way for organizing tabs in accordance with some embodiments. Process 800 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently.

In some embodiments, process 800 is performed at a computer system (e.g., 100) (e.g., as described above with respect to FIGS. 1A-1B and 3A) that is in communication (e.g., wired and/or wireless communication) with (and/or includes) one or more display generation components (e.g., as described above with respect to FIGS. 1A-1B and 3A) and one or more input devices (e.g., as described above with respect to FIGS. 1A-1B and 3A).

While displaying, via the one or more display generation components, a browser application user interface (e.g., 5000) that includes a tab bar (e.g., 5001) (e.g., a platter with tabs, a region of the browser corresponding to indications of different webpages, and/or a navigation bar of webpages) with a plurality of tabs, the computer system detects (802), via the one or more input devices, a set of one or more inputs (e.g., a tap input and/or a voice input) including an input (e.g., 705a) (e.g., a tap input and/or a voice input) corresponding to a tab (e.g., 710) of the plurality of tabs and an input (e.g., 705b1 and/or 705b2) (e.g., a tap input and/or a voice input) corresponding to a request to organize tabs in a respective mode. In some embodiments, a single input includes the input corresponding to the tab of the plurality of tabs and the input corresponding to the request to organize tabs in the respective mode. In some embodiments, the input corresponding to the tab of the plurality of tabs is separate and/or different from the input corresponding to the request to organize tabs in the respective mode. In some embodiments, the input corresponding to the tab of the plurality of tabs is before or after the input corresponding to the request to organize tabs in the respective mode. In some embodiments, the input, corresponding to the tab of the plurality of tabs, (1) is directed to the tab of the plurality of tabs, (2) includes an indication and/or an identification of the tab of the plurality of tabs, and/or corresponds to a request to navigate to a webpage, such as entering a URL, tapping on a back or forward button, and/or a swipe input on an address bar or a part of a webpage currently being displayed. In some embodiments, the input, corresponding to the request to organize tabs in the respective mode, (1) is directed to a user interface element (e.g., 728a, 728b, and/or 728c) representing the respective mode and/or (2) includes an indication and/or an identification of the respective mode.

In response to (804) detecting the set of one or more inputs, in accordance with a determination that the respective mode is a first mode (e.g., an automatic mode and/or a configuration to automatically create and/or group tabs into one/or more system-generated grouping of tabs), the computer system displays (806), via the one or more display generation components, an indication (e.g., 742) of a grouping of a first subset of the plurality of tabs (e.g., the computer system automatically, without additional user input, groups tabs based on various characteristics of the plurality of tabs, including topics associated with corresponding webpages of the plurality of tabs, domains of the webpages; sources of the webpages, topics of user-defined groups, topics of system-generated groups, and/or other information about the plurality of tabs and/or group of tabs in the tab bar), wherein the first subset of the plurality of tabs does not include the tab of the plurality of tabs (e.g., such as described above with reference to FIG. 7L). In some embodiments, displaying the indication of the grouping of the first subset of the plurality of tabs includes displaying a visual demarcation of tabs in the grouping relative to other tabs in the tab bar that are not included in the grouping.

In response to (804) detecting the set of one or more inputs, in accordance with a determination that the respective mode is a second mode (e.g., a manual mode, an automatic mode that is limited to groups manually identified by a user, and/or a configuration that groups tabs into one or more manually-created groupings of tabs), the computer system displays (808), via the one or more display generation components, an indication (e.g., 724) of a grouping of a second subset of the plurality of tabs (e.g., the computer system automatically identifies tabs in the second subset based on one or more characteristics of the plurality of tabs, including a topic associated with corresponding webpages of the plurality of tabs, a domain of the webpages, one or more sources of the webpage, a topic of user-defined groups, a topic of system-generated groups, and/or other information about the plurality of tabs and/or group of tabs in the tab bar) without displaying the indication of the grouping of the first subset of the plurality of tabs, wherein the second subset of the plurality of tabs includes the tab of the plurality of tabs, wherein the second mode is different from the first mode, and wherein the first subset of the plurality of tabs is different from the second subset of the plurality of tabs (e.g., such as described above with reference to FIG. 7C). In some embodiments, displaying the indication of the grouping of the second subset of the plurality of tabs includes displaying a visual demarcation of tabs in the grouping relative to other tabs in the tab bar that are not included in the grouping. In some embodiments, ungrouped tabs in the tab bar are split from tabs in groupings or tabs in manually-generated groups (e.g., where optionally tab groups are displayed in expanded and/or collapsed state), and tabs in a grouping are split from tabs in other groups (e.g., system-generated or manually created).

In some embodiments, in response to detecting the set of one or more inputs and in accordance with the determination that the respective mode is in the first mode, the computer system displays, via the one or more display generation components, the indication of the grouping of the second subset of the plurality of tabs (e.g., such as described above with reference to FIG. 7L) (e.g., concurrently with the indication of the grouping of the first subset of the plurality of tabs). In some embodiments, in conjunction with (e.g., as part of, while, or after) displaying the indication of the grouping of the second subset of the plurality of tabs and the indication of the grouping of the first subset of the plurality of tabs, the computer system displays a visual demarcation of tabs in the grouping of the first subset of the plurality of tabs relative to the grouping of the second subset of the plurality of tabs.

In some embodiments, after displaying the indication of the grouping of the first subset of the plurality of tabs, the computer system detects, via the one or more input devices, a first input (e.g., 705m and/or 705p) (e.g., a tap input and/or a voice input) corresponding to a request to navigate to a webpage (and/or to navigate the tab to the webpage). In some embodiments, the first input corresponding to the request to navigate to the webpage is separate and/or different from the input corresponding to the request to organize tabs in the respective mode. In some embodiments, the set of one or more inputs is a first set of one or more inputs. In some embodiments, the tab is a first tab. In some embodiments, after displaying the indication of the grouping of the first subset of the plurality of tabs, the computer system detects, via the one or more input devices, a second set of one or more inputs (e.g., a tap input and/or a voice input) including (1) an input (e.g., 705l and/or 705o) (e.g., a tap input and/or a voice input) corresponding to a request to open a second tab of the plurality of tabs in the grouping of the second subset of the plurality of tabs and (2) an input (e.g., 705m and/or 705p) (e.g., a tap input and/or a voice input) corresponding to a request to navigate the second tab to the webpage. In some embodiments, the input corresponding to the request to navigate to the webpage includes entering a URL, tapping on a back or forward button, and/or a swipe input on an address bar or a part of a webpage currently being displayed. In some embodiments, in response to (and/or after) detecting the first input corresponding to the request to navigate to the webpage (and/or while displaying the indication of the grouping of the first subset of the plurality of tabs), in accordance with a determination that the webpage (e.g., content of the webpage, sources of the webpage, and/or other properties of the webpage) corresponds to the grouping of the first subset of the plurality of tabs (and/or that the computer system or a browser of the computer system is configured to organize tabs in the first mode), the computer system displays, via the one or more display generation components, an indication of the webpage in the indication of the grouping of the first subset of the plurality of tabs (e.g., such as described above with reference to FIG. 7O). In some embodiments, displaying the indication of the webpage in the indication of the grouping of the first subset of the plurality of tabs includes adding (e.g., including and/or displaying with an additional element) the indication of the webpage to the indication of the grouping of the first subset of the plurality of tabs. In some embodiments, the determination that the webpage corresponds to the grouping of the first subset of the plurality of tabs includes a determination that the webpage shares a characteristic (e.g., topic associated with corresponding webpages of the plurality of tabs, domains of the webpages sources of the webpages, topics of user-defined groups, topics of system-generated groups, and/or other information about the plurality of tabs and/or group of tabs in the tab bar) with the first subset of the plurality of tabs. In some embodiments, in response to detecting the first input corresponding to the request to navigate to the webpage, in accordance with a determination that the webpage corresponds to the grouping of the second subset of the plurality of tabs (and/or that the computer system or a browser of the computer system is configured to organize tabs in the first mode or the second mode), the computer system displays, via the one or more display generation components, the indication of the webpage in the indication of the grouping of the second subset of the plurality of tabs (e.g., such as described above with reference to FIG. 7R). In some embodiments, displaying the indication of the webpage in the indication of the grouping of the second subset of the plurality of tabs includes adding (e.g., including and/or displaying with an additional element) the indication of the webpage to the indication of the grouping of the second subset of the plurality of tabs. In some embodiments, the determination that the webpage corresponds to the grouping of the second subset of the plurality of tabs includes a determination that the webpage shares a characteristic (e.g., topic associated with corresponding webpages of the plurality of tabs, domains of the webpages sources of the webpages, topics of user-defined groups, topics of system-generated groups, and/or other information about the plurality of tabs and/or group of tabs in the tab bar) with the second subset of the plurality of tabs.

In some embodiments, the set of one or more inputs is a first set of one or more inputs. In some embodiments, after displaying the indication of the grouping of the first subset of the plurality of tabs, the computer system detects, via the one or more input devices, a second input (e.g., 705m and/or 705p) (e.g., a tap input and/or a voice input) corresponding to a request to navigate to a webpage (and/or to navigate the tab to the webpage). In some embodiments, the second input corresponding to the request to navigate to the webpage is separate and/or different from the input corresponding to the request to organize tabs in the respective mode. In some embodiments, the set of one or more inputs is a first set of one or more inputs. In some embodiments, the tab is a first tab. In some embodiments, after displaying the indication of the grouping of the first subset of the plurality of tabs, the computer system detects, via the one or more input devices, a second set of one or more inputs (e.g., a tap input and/or a voice input) including (1) an input (e.g., 705l and/or 705o) (e.g., a tap input and/or a voice input) corresponding to a request to open a second tab of the plurality of tabs in the grouping of the second subset of the plurality of tabs and (2) an input (e.g., 705m and/or 705p) (e.g., a tap input and/or a voice input) corresponding to a request to navigate the second tab to the webpage. In some embodiments, the second input corresponding to the request to navigate to the webpage includes entering a URL, tapping on a back or forward button, and/or a swipe input on an address bar or a part of a webpage currently being displayed. In some embodiments, in response to (and/or after) detecting the second input corresponding to the request to navigate to the webpage (and/or while displaying the indication of the grouping of the first subset of the plurality of tabs), in accordance with a determination that the computer system is configured to organize tabs in a third mode (e.g., “never” selected, such as described above with reference to FIG. 7D) (e.g., a never mode and/or a configuration to not automatically group tabs into one or more system-generated groupings of tabs and/or one or more manually-created groupings of tabs), the computer system forgoes display of, via the one or more display generation components, an indication of the webpage in an indication of a grouping of a third subset of the plurality of tabs (e.g., the indication of the grouping of the first subset of the plurality of tabs, the indication of the grouping of the second subset of the plurality of tabs, and/or a different indication of the grouping of a different subset of the plurality of tabs). In some embodiments, displaying the indication of the webpage in the indication of the grouping of the third subset of the plurality of tabs includes adding (e.g., including and/or displaying with an additional element) the indication of the webpage to the indication of the grouping of the third subset of the plurality of tabs. In some embodiments, in response to detecting the second input corresponding to the request to navigate to the webpage, in accordance with a determination that the computer system is configured to not organize tabs in the third mode (e.g., the computer system is configured to organize tabs in the first mode, the second mode, or another mode different from the first mode, the second mode, and the third mode), the computer system displays, via the one or more display generation components, the indication of the webpage in the indication of the grouping of the third subset of the plurality of tabs (e.g., such as described above with reference to FIG. 7D) (and/or displays, via the one or more display generation components, a tab corresponding to the webpage in the tab bar separate from the indication of the grouping of the first subset of the plurality of tabs, the indication of the grouping of the second subset of the plurality of tabs, and/or the different grouping of the different subset of the plurality of tabs).

In some embodiments, while (and/or after) displaying the indication of the grouping of the second subset of the plurality of tabs (and/or while the computer system is configured to organize tabs in the second mode and/or while forgoing display of or not displaying the indication of the grouping of the first subset of the plurality of tabs), the computer system detects, via the one or more input devices, an input (e.g., 705d1) (e.g., a tap input and/or a voice input) corresponding to a request to organize tabs in the first mode. In some embodiments, the input corresponding to the request to organize tabs in the first mode includes an input corresponding to a request to switch from the second mode to the first mode and/or a tap on a user interface element to “automatically” group tabs. In some embodiments, in response to detecting the input corresponding to the request to organize tabs in the first mode, the computer system concurrently displays, via the one or more display generation components, the indication of the grouping of the first subset of the plurality of tabs and the indication of the grouping of the second subset of the plurality of tabs (e.g., such as described above with reference to FIG. 7L).

In some embodiments, the set of one or more inputs is a first set of one or more inputs. In some embodiments, the plurality of tabs is a first plurality of tabs. In some embodiments, after (and/or while) displaying the indication of the grouping of the first subset of the plurality of tabs, the computer system displays, via the one or more display generation components, a tab overview user interface (e.g., 762) including (1) previews of a plurality of webpages (e.g., such as described above with reference to FIG. 7W) and (2) a filter user interface element (e.g., 764), wherein the previews of the plurality of webpages include: a preview of a first webpage; and a preview of a second webpage separate from the preview of the first webpage. In some embodiments, the preview of the first webpage includes a portion of the first webpage. In some embodiments, the preview of the first webpage includes a last-displayed portion of the first webpage. In some embodiments, the preview of the first webpage includes the top portion of the first webpage, the top portion being the first webpage without being scrolled. In some embodiments, the second webpage is the same as the first webpage. In some embodiments, the second webpage is different from the first webpage. In some embodiments, the preview of the second webpage is the same as the preview of the first webpage. In some embodiments, the preview of the second webpage is different from the preview of the first webpage. In some embodiments, the preview of the second webpage includes a portion of the second webpage. In some embodiments, the preview of the second webpage includes a last-displayed portion of the second webpage. In some embodiments, the preview of the second webpage includes the top portion of the second webpage, the top portion being the second webpage without being scrolled. In some embodiments, the computer system detects, via the one or more input devices, a second set of one or more inputs including: an input (e.g., 705w) (e.g., a tap input and/or a voice input) corresponding to (e.g., selecting or otherwise directed to) the filter user interface element; and an input (e.g., 705x) (e.g., a tap input and/or a voice input) corresponding to (e.g., selecting or otherwise directed to) a respective group, wherein the respective group is automatically generated (e.g., by a browser of the computer system without requiring user input) based on webpages included in the plurality of webpages. In some embodiments, the input corresponding to the filter user interface element is detected while displaying the tab overview user interface. In some embodiments, the input corresponding to the filter user interface element is detected while displaying the previews of the plurality of webpages. In some embodiments, the input corresponding to the respective group is detected while displaying the tab overview user interface. In some embodiments, the input corresponding to the respective group is detected while displaying the previews of the plurality of webpages. In some embodiments, the input corresponding to the respective group is detected while displaying an overlay on top of the tab overview user interface. In some embodiments, the overlay is displayed in response to detecting the input corresponding to the filter user interface element. In some embodiments, the input corresponding to the respective group is detected after the input corresponding to the filter user interface element. In some embodiments, a single input includes the input corresponding to the respective group and the input corresponding to the filter user interface element. In some embodiments, the overlay includes representations of the different groups including the respective group. In some embodiments, in response to detecting the second set of one or more inputs, in accordance with a determination that the respective group is a first group, the computer system displays, via the one or more display generation components, the tab overview user interface including a first set of one or more previews of the plurality of webpages (e.g., such as described above with reference to FIG. 7Y) (and/or the filter user interface element, such as with a different appearance than before detecting the set of one or more inputs). In some embodiments, the first set of one or more previews of the plurality of webpages includes previews of webpages that are included in the first group. In some embodiments, the first set of one or more previews of the plurality of webpages includes the preview of the first webpage. In some embodiments, in response to detecting the second set of one or more inputs, in accordance with a determination that the respective group is a second group, the computer system displays, via the one or more display generation components, the tab overview user interface including a second set of one or more previews of the plurality of webpages (and/or the filter user interface element, such as with a different appearance than before detecting the set of one or more inputs) without including the first set of one or more previews, wherein the second set is different from the first set, and wherein the second group is different from the first group (e.g., such as described above with reference to FIG. 7Y). In some embodiments, the second set of one or more previews of the plurality of webpages includes previews of webpages that are included in the second group. In some embodiments, the second set of one or more previews of the plurality of webpages includes the preview of the second webpage and does not include the preview of the first webpage.

In some embodiments, the tab is a first tab of the plurality of tabs. In some embodiments, while displaying the indication of the grouping of the first subset of the plurality of tabs, the computer system detects, via the one or more input devices, an input (e.g., 705p) (e.g., a tap input and/or a voice input) corresponding to a request to navigate a second tab (e.g., 5014 before input 705p and 750 after) of the plurality of tabs to a webpage (e.g., 748), wherein the indication of the grouping of the first subset of the plurality of tabs includes the second tab while detecting the input corresponding to the request to navigate the second tab to the webpage. In some embodiments, the input corresponding to a request to navigate the second tab to the webpage is separate and/or different from the input corresponding to the request to organize tabs in the respective mode. In some embodiments, the input corresponding to the request to navigate the second tab to the webpage includes a tap input to navigate the second tab to a new webpage or enter a URL, tap on a search bar, and/or swipe left to right to navigate back to the webpage. In some embodiments, the second tab is different from the first tab. In some embodiments, the second tab is the first tab. In some embodiments, the second tab corresponds to the same webpage as the first tab. In some embodiments, in response to detecting the input corresponding to the request to navigate the second tab to the webpage, in accordance with a determination that the webpage does not share a characteristic (e.g., topic associated with corresponding webpages of the plurality of tabs, domains of the webpages sources of the webpages, topics of user-defined groups, topics of system-generated groups, and/or other information about the plurality of tabs and/or group of tabs in the tab bar) with the first subset of the plurality of tabs, the computer system displays, via the one or more display generation components, the second tab at a location (e.g., coordinate and/or relative position) outside of the indication of the grouping of the first subset of the plurality of tabs (e.g., in 724, such as described above with reference to FIG. 7R). In some embodiments, in response to detecting the input corresponding to the request to navigate the second tab to the webpage, in accordance with a determination that the webpage shares the characteristic with the first subset of the plurality of tabs, the computer system maintains display of, via the one or more display generation components, the second tab in (and/or within) the indication of the grouping of the first subset of the plurality of tabs (e.g., such as described above with reference to FIGS. 7G and 7R).

In some embodiments, the location outside of the indication of the grouping of the first subset of the plurality of tabs is a location inside of an indication of a grouping of a fourth subset of the plurality of tabs (e.g., 724) (e.g., the computer system automatically, without additional user input, groups tabs based on various characteristics of the plurality of tabs, including topics associated with corresponding webpages of the plurality of tabs, domains of the webpages; sources of the webpages, topics of user-defined groups, topics of system-generated groups, and/or other information about the plurality of tabs and/or group of tabs in the tab bar) different from the indication of the group of the first subset of the plurality of tabs. For example, the computer system groups tabs for webpages that share a first set of characteristics into the first subset of the plurality of tabs and groups tabs for webpages that share a second set of characteristics, different from the first set of characteristics, into the fourth subset of the plurality of tabs.

In some embodiments, the location outside of the indication of the group of the first subset of the plurality of tabs is a location separate from an indication of a grouping of a subset of the plurality of tabs (e.g., such as described above with reference to FIG. 7G) (e.g., the indication of the grouping of the first subset of the plurality of tabs, the indication of the second subset of the plurality of tabs, and/or an indication of the grouping of any subset of the plurality of tabs). In some embodiments, the second tab is visually distinguished from the indication of grouping of the first subset of the plurality of tabs and from the indication of the group.

In some embodiments, the tab is a first tab of the plurality of tabs. In some embodiments, while displaying (1) a webpage corresponding to a third tab (e.g., 720) and (2) the indication of the grouping of the first subset of the plurality of tabs including the third tab and a fourth tab separate from the third tab, the computer system detects, via the one or more input devices, an input (e.g., 705r) (e.g., a tap input and/or a voice input) corresponding to a request to select a fifth tab separate from the third tab and the fourth tab, wherein the indication of the grouping of the first subset of the plurality of tabs does not include the fifth tab while detecting the input corresponding to the request to select the fifth tab. In some embodiments, the input corresponding to the request to select the fifth tab includes a tap input to select the fifth tab and/or a voice input to select the fifth tab. In some embodiments, the fifth tab is different from the first tab. In some embodiments, the fifth tab is the first tab. In some embodiments, the fifth tab corresponds to the same webpage as the first tab. In some embodiments, in response to detecting the input corresponding to the request to select the fifth tab, the computer system ceases display of, via the one or more display generation components, the webpage corresponding to the third tab. In some embodiments, in response to detecting the input corresponding to the request to select the fifth tab, the computer system displays, via the one or more display generation components, the tab bar including: the indication of the grouping of the first subset of the plurality of tabs with the third tab and without the fourth tab (and/or ceases display of tabs in the grouping of the first subset of the plurality of tabs different from the fourth tab in the grouping of the first subset of the plurality of tabs); and the fifth tab separate from the grouping of the first subset of the plurality of tabs (e.g., such as described above with reference to FIG. 7S). In some embodiments, after detecting the set of one or more inputs (and/or while displaying the browser application user interface that includes the tab bar with the plurality of tabs), the computer system displays the fourth tab including a title (e.g., a name and/or text description) and an icon. In some embodiments, in response to detecting the input corresponding to the request to select the fifth tab, the computer system displays the fifth tab including the title (e.g., with or without the icon). In some embodiments, in response to detecting the input corresponding to the request to select the fifth tab, the computer system displays, via the one or more display generation components, a webpage (e.g., 752) corresponding to the fifth tab. In some embodiments, the fifth tab includes an indication of an icon and an indication of a title.

In some embodiments, while displaying the tab bar including the indication of the grouping of the first subset of the plurality of tabs with the third tab and without the fourth tab, the computer system detects, via the one or more input devices, an input (e.g., 705s2) (e.g., a tap input and/or a voice input) corresponding to the indication of the grouping of the first subset of the plurality of tabs. In some embodiments, the input corresponding to the grouping of the first subset of the plurality of tabs includes an input corresponding to a request to expand the grouping of the first subset of the plurality of tabs and/or a tap on the third tab. In some embodiments, in response to detecting the input corresponding to the indication of the grouping of the first subset of the plurality of tabs, the computer system displays, via the one or more display generation components, the tab bar including the indication of the grouping of the first subset of the plurality of tabs with the third tab and the fourth tab (e.g., such as described above with reference to FIG. 7T).

In some embodiments, the indication of the grouping of the first subset of the plurality of tabs includes a title (e.g., 724a) (e.g., a name and/or text description) of the grouping of the first subset of the plurality of tabs. In some embodiments, the title includes a caret indicating the number of tabs of the grouping of the first subset of the plurality of tabs. In some embodiments, while displaying the indication of the grouping of the first subset of the plurality of tabs including (1) the title and (2) the third tab, the computer system detects, via the one or more input devices, an input (e.g., 705s1) (e.g., a tap input and/or a voice input) corresponding to the title. In some embodiments, the input corresponding to the title includes an input corresponding to a request to minimize the grouping of the first subset of the plurality of tabs and/or a tap on the title for the grouping of the first subset of the plurality of tabs. In some embodiments, in response to detecting the input corresponding to the title, the computer system displays, via the one or more display generation components, the indication of the grouping of the first subset of the plurality of tabs (1) including the title and (2) not including the third tab (e.g., such as described above with reference to FIG. 7U) (and/or not including any tabs in the indication of the grouping of the first subset of the plurality of tabs).

In some embodiments, the input corresponding to the title is a first input corresponding to the title. In some embodiments, while displaying the indication of the grouping of the first subset of the plurality of tabs including the title and not including the third tab, the computer system detects, via the one or more input devices, a second input (e.g., a tap input and/or a voice input) corresponding to the title, wherein the second input corresponding to the title is separate from the first input corresponding to the title. In some embodiments, the second input corresponding to the title includes an input corresponding to a request to maximize the grouping of the first subset of the plurality of tabs and/or a tap on the title for the grouping of the first subset of the plurality of tabs. In some embodiments, the second input corresponding to the title is the same as and separate from the first input corresponding to the title. In some embodiments, the second input corresponding to the title is different from the first input corresponding to the title. In some embodiments, in response to detecting the second input corresponding to the title, the computer system displays, via the one or more display generation components, the indication of the grouping of the first subset of the plurality of tabs including (1) the title and (2) the third tab (and/or the title and/or the icon) (and/or icons and/or titles of any tab of the group of the first subset of the plurality of tabs) (e.g., such as described above with reference to FIG. 7U).

In some embodiments, the third tab includes a title (e.g., “FB Rank…” such as described above with reference to FIG. 7R) (e.g., a name and/or text description) while detecting the input corresponding to the request to select the fifth tab. In some embodiments, in response to detecting the input corresponding to the request to select the fifth tab, the computer system maintains display of, via the one or more display generation components, the title.

In some embodiments, while displaying the browser application user interface that includes the tab bar with the plurality of tabs and before (and/or while) detecting the set of one or more inputs including the input corresponding to the tab of the plurality of tabs and the input corresponding to the request to organize tabs in the respective mode, the computer system displays, via the one or more display generation components, an indication (e.g., 710b) that that the tab shares a characteristic with (and/or is related to) one or more tabs of the plurality of tabs, wherein the set of one or more inputs includes an input corresponding to the indication that the tab shares the characteristic with the one or more tabs of the plurality of tabs. In some embodiments, the characteristic includes a topic associated with corresponding webpages of the plurality of tabs, a domain of the webpages, a source of webpages, a topic of a user-defined group, a topic of a system-generated group, and/or other information about the plurality of tabs and/or group of tabs in the tab bar. In some embodiments, the input corresponding to the indication that the tab shares the characteristic with the one or more tabs of the plurality of tabs is different and/or separate from the input corresponding to the request to organize tabs in the respective mode. In some embodiments, the input corresponding to the indication that the tab shares the characteristic with the one or more tabs of the plurality of tabs is different and/or separate from the input corresponding to the tab of the plurality of tabs. In some embodiments, a single input includes the input corresponding to the indication that the tab shares the characteristic with the one or more tabs of the plurality of tabs and the input corresponding to the tab of the plurality of tabs.

In some embodiments, the indication that the tab shares the characteristic with the one or more tabs of the plurality of tabs includes an identification (e.g., “4” such as described above with reference to FIG. 7A) of the number of one or more tabs the tab is related to of the plurality of tabs (e.g., the quantity of tabs in the second subset of the plurality of tabs).

Note that details of the processes described above with respect to process 800 (e.g., FIG. 8) are also applicable in an analogous manner to other processes described herein. For example, process 800 optionally includes one or more of the characteristics of the various processes described above with reference to process 600 (FIG. 6). For example, the tab usage event of process b can be an input of the set of one or more inputs of process 800. For brevity, these details are not repeated herein.

It should be understood that the particular order in which the operations in FIGS. 6 and 8 have been described is merely an example and is not intended to indicate that the described order is the only order in which the operations could be performed. One of ordinary skill in the art would recognize various ways to reorder the operations described herein.

The operations described above with reference to FIGS. 6 and 8 are, optionally, implemented by components depicted in FIGS. 1A-1B. For example, tap input 5027, tap input 5029, tap input 5059, tap input 5077, tap input 5081, tap input 5085 and tap input 5091 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a computer system that is in communication with a display generation component and with one or more input devices:
displaying, via the display generation component, a browser application user interface that includes a tab bar with a plurality of tabs, wherein the plurality of tabs are displayed in a first arrangement;
detecting an occurrence of a tab-usage event associated with the plurality of tabs; and
in response to detecting the occurrence of the tab-usage event associated with the plurality of tabs and in accordance with a determination that grouping criteria are met, automatically displaying, via the display generation component, an indication of a system-generated grouping, in one or more system-generated tab groups, of a subset of the plurality of tabs.

2. The method of claim 1, wherein the tab-usage event includes editing one or more of the plurality of tabs in the tab bar.

3. The method of claim 1, wherein the tab-usage event excludes selecting a tab operation from a menu of available tab operations.

4. The method of claim 1, wherein the tab-usage event includes opening a new tab in the tab bar.

5. The method of claim 1, wherein:
displaying, in the browser application user interface, content of a first respective webpage that corresponds to a tab that is in focus;
the tab-usage event includes activating a link in the first respective webpage corresponding to the tab that is in focus, where the link is associated with a second respective webpage; and
the method further comprises:
in response to activating the link in the first respective webpage corresponding to the tab that is in focus, displaying, via the display generation component, content of the second respective webpage in the browser application user interface, wherein, after the link in the first respective webpage is activated, the second respective webpage corresponds to the tab that is in focus.

6. The method of claim 1, wherein the tab-usage event includes closing a tab of the plurality of tabs.

7. The method of claim 1, further comprising:
in response to detecting the occurrence of the tab-usage event associated with the plurality of tabs and in accordance with a determination that the grouping criteria are met, automatically displaying, via the display generation component, the plurality of tabs in a second arrangement, wherein, in the second arrangement, tabs in a respective system-generated group are grouped together.

8. The method of claim 7, wherein automatically displaying the plurality of tabs in the second arrangement includes animating rearrangement of the plurality of tabs from the first arrangement to the second arrangement.

9. The method of claim 7, wherein, in the second arrangement, tabs that are not included in a system-generated group are grouped together in the tab bar.

10. The method of claim 1, further comprising:
in response to detecting that the subset of the plurality tabs have been inactive for a threshold amount of time after displaying the indication of the system-generated grouping, automatically displaying, via the display generation component, the plurality of tabs in a second arrangement, wherein, in the second arrangement, tabs in a respective system-generated group are grouped together.

11. The method of claim 1, further comprising:
in accordance with a determination that a first mode is active at a time the occurrence of the tab-usage event is detected, automatically displaying, via the display generation component, the plurality of tabs in a second arrangement in response to detecting the occurrence of the tab-usage event, wherein, in the second arrangement, tabs in a respective system-generated group are grouped together; and
in accordance with a determination that at least the subset of the plurality tabs have been inactive for a threshold amount of time after the tab-usage event while a second mode is active, in response to a predetermined browser event, automatically displaying, via the display generation component, the plurality of tabs in the second arrangement.

12. The method of claim 1, wherein,
the tab-usage event includes changing input focus from a first tab to a second tab of the plurality of tabs; and
the method further comprises:
displaying, via the display generation component, the plurality of tabs in a second arrangement, wherein, in the second arrangement, tabs in a respective system-generated group are grouped together.

13. The method of claim 1, wherein displaying the indication of the system-generated grouping includes displaying a control in the browser application user interface.

14. The method of claim 13, further comprising:
detecting a user input selecting the control; and
in response to the user input selecting the control, displaying, via the display generation component, the plurality of tabs in a respective arrangement different from the first arrangement, wherein, in the respective arrangement, tabs in a respective system-generated group are grouped together.

15. The method of claim 13, further comprising:
detecting a user input selecting the control; and
in response to the user input selecting the control, displaying, via the display generation component, a suggested system-generated grouping of the subset of the plurality of tabs without rearranging the plurality of tabs.

16. The method of claim 1, further comprising:
while a first tab of a first tab group is active, wherein the first tab group includes a first subset of related tabs displayed next to one another in the tab bar in a sequence, detecting a user input requesting to open a new tab; and
in response to the user input requesting to open a new tab, displaying a new tab at a first location in the tab bar, wherein the new tab is placed after a last tab in the sequence.

17. The method of claim 16, further comprising:
after displaying the new tab in the first location in the tab bar:
in accordance with a determination that the new tab is related to a second subset of related tabs included in a second tab group different from the first tab group, automatically displaying the new tab at a second location in the tab bar different from the first location, wherein the new tab is placed after a last tab in a sequence of the second subset of related tabs.

18. The method of claim 16, further comprising:
after displaying the new tab at the first location in the tab bar and in accordance with a determination that the new tab is related to the first subset of related tabs included in the first tab group, maintaining display of the new tab at the first location and displaying a visual indication of a system-generated grouping of the first subset of related tabs and the new tab.

19. The method of claim 1, further comprising:
while a first tab group that includes a first subset of tabs is displayed in an expanded state, where, in the expanded state, the tabs in the first subset of tabs are concurrently displayed, detecting a user input directed to a location in the tab bar outside the first subset of tabs; and
in response to detecting the user input directed to the location in the tab bar outside the first subset of tabs, collapsing the first subset of tabs, including ceasing display of the first subset of tabs and displaying a first container tab representing the first tab group.

20. The method of claim 19, wherein collapsing the first subset of tabs is animated.

21. The method of claim 19, further comprising:
displaying a system-generated label in the first container tab, wherein the system-generated label is generated using a language model.

22. The method of claim 1, further comprising:
while displaying a second container tab representing a second tab group that includes a second subset of tabs, and the second subset of tabs are not displayed, detecting a user input directed toward the second container tab; and
in response to detecting the user input directed toward the second container tab, expanding the second container tab, including ceasing to display the second container tab and concurrently displaying the tabs of the second subset of tabs.

23. The method of claim 22, wherein expanding the second container tab representing the second tab group is animated.

24. The method of claim 1, wherein the system-generated grouping of the subset of the plurality of tabs includes merging a first respective tab group and a second respective tab group into a respective system-generated tab group.

25. A computer system, comprising:
a display generation component;
one or more input devices;
one or more processors; and
memory storing one or more programs, wherein the one or more programs are configured to be executed by the one or more processors, the one or more programs including instructions for:
displaying, via the display generation component, a browser application user interface that includes a tab bar with a plurality of tabs, wherein the plurality of tabs are displayed in a first arrangement;
detecting an occurrence of a tab-usage event associated with the plurality of tabs; and
in response to detecting the occurrence of the tab-usage event associated with the plurality of tabs and in accordance with a determination that grouping criteria are met, automatically displaying, via the display generation component, an indication of a system-generated grouping, in one or more system-generated tab groups, of a subset of the plurality of tabs.

26. A computer readable storage medium storing one or more programs, the one or more programs comprising instructions that, when executed by a computer system that is in communication with a display generation component and one or more input devices, cause the computer system to:
display, via the display generation component, a browser application user interface that includes a tab bar with a plurality of tabs, wherein the plurality of tabs are displayed in a first arrangement;
detect an occurrence of a tab-usage event associated with the plurality of tabs; and
in response to detecting the occurrence of the tab-usage event associated with the plurality of tabs and in accordance with a determination that grouping criteria are met, automatically display, via the display generation component, an indication of a system-generated grouping, in one or more system-generated tab groups, of a subset of the plurality of tabs.
